(19) United States
(12) Patent Application Publication
(10) Pub. No.: US 2025/0139446 A1
(43) Pub. Date: May 1, 2025

(54) SYSTEMS AND METHODS FOR AUTOMATIC DATA ANNOTATION AND SELF-LEARNING FOR ADAPTIVE MACHINE LEARNING

(71) Applicant: The Regents of The University of California, Oakland, CA (US)

(72) Inventors: Guann Pyng Li, Irvine, CA (US); Yutian Ren, Irvine, CA (US)

(73) Assignee: The Regents of The University of California, Oakland, CA (US)

(21) Appl. No.: 18/925,783

(22) Filed: Oct. 24, 2024

Related U.S. Application Data
(60) Provisional application No. 63/545,737, filed on Oct. 25, 2023.

(51) Int. Cl. G06N 3/088

(52) U.S. Cl. CPC G06N 3/088

(57) ABSTRACT

A system for automatically self-labeling a digital dataset includes a first sensor for generating a first data stream, a second sensor for collecting information to generate a second data stream, and a causal model manager (CMM). The CMM is configured to determine a first causal event from a first data segment of the first data stream, and a causal relation between the first causal event and a second data segment selected from the second data stream. The system further includes (a) an interactive time model for determining an interaction time between the first and second data segments, and (b) a self-labeling subsystem configured to derive a label from the second data segment, associate the first data segment with the derived label, form a self-labeled data pair from the associated first data segment and the derived label, and automatically annotate the self-labeled data pair with the interaction time.

### PRIORITY DATA

This application claims the benefit of and priority to U.S. Provisional Patent Application Ser. No. 63/545,737, filed Oct. 25, 2023, titled “Automatic Data Annotation and Self-Learning for Adaptive Machine Learning,” the entirety of which is incorporated herein by reference in its entirety.

### FIELD OF THE TECHNOLOGY DISCLOSED

The technology disclosed generally relates to artificial intelligence (AI) and machine learning (ML) and more specifically to devices, methods, and systems for automatic data annotation and self-learning for adaptive ML applications.

### BACKGROUND

Machine learning may be used as a term to describe problem solving where development of algorithms by human programmers would be cost-prohibitive, and instead the problems are solved by machines utilizing models without needing to be explicitly told what to do by any human-developed algorithms. Machine-learning approaches have been applied to various application such as, but not limited to, large language models, computer vision, speech recognition, email filtering, agriculture and medicine.

Machine learning approaches are traditionally divided into three broad categories: (1) supervised learning, (2) unsupervised learning, and (3) reinforcement learning. In supervised learning, a computer is presented with example inputs and their desired outputs with the goal to learn a general rule that maps inputs to outputs. In unsupervised learning, no labels are given to the learning algorithm, leaving it on its own to find structure in its input (e.g., clustering). Unsupervised learning may have various goals such as, but not limited to, discovering patterns in data or feature learning. In reinforcement learning, a computer program (e.g., a ML application) interacts with a dynamic environment in which it must perform a certain goal (e.g., driving a vehicle, playing chess, etc.). The program may be provided feedback (i.e., rewards) and the program may try to maximize for the rewards.

### SUMMARY

In an implementation, a system for automatically self-labeling a digital dataset includes a first sensor configured to generate a first digital data stream, a second sensor configured to collect information for generating a second digital data stream different from the first digital data stream, and a causal model manager (CMM). The CMM is configured to determine a first causal event from a first data segment of the first digital data stream, and a causal relation between the first causal event and a second data segment selected from the second digital data stream. The system further includes an interactive time model (ITM) unit configured to determine a time lag between the first and second data segments, and a self-labeling subsystem. The self-labeling subsystem is configured to derive a label from the second data segment, associate the first data segment with the derived label, form a self-labeled data pair from the associated first data segment and the derived label, and automatically annotate the self-labeled data pair with an interaction time value based on the determined time lag.

In an implementation, a method is provided for automatic data annotation and self-learning for adaptive machine learning (ML) applications. The method includes steps of (a) formulating an ML problem and a preliminary dataset having a plurality of data attributes, (b) searching a knowledge base for potential causal events related to the formulated ML problem, (c) identifying, from the preliminary dataset, causal event data from data attributes of the preliminary dataset that correspond with potential causal events from the step of searching; (d) validating the identified causal event data using a statistical causal model, (e) selecting, from the validated causal event data, a set of validated causal events exhibiting highest levels of confidence, and (f) marking the selected high-confidence causal events to enable an effect recognizer to derive an effect label for each selected high-confidence causal event.

In an implementation, an apparatus is provided for automatically self-labeling a digital dataset. The apparatus includes a processor configured to receive a first data stream and a second data stream different from the first data stream, and a memory device in operable communication with the processor. The memory device is configured to store computer-executable instructions therein. When executed by the processor, the computer-executable instructions cause the apparatus to generate, using the first and second data streams, (a) a causal interactive task model, and (b) an interaction time model (ITM). The instructions further cause the apparatus to determine (a) a first causal event from a first data segment of the first data stream, and (b) a causal relation between the first causal event and a second data segment selected from the second data stream. The instructions further cause the apparatus to recognize a first effect event for the second data segment based on the determined causal relation and an interaction time, inferred by the ITM, between the first cause event and the first effect event. The instructions further cause the apparatus to self-label a dataset from an accumulated plurality of associated cause and effect events, and automatically update the causal interactive task model using the self-labeled dataset.

### BRIEF DESCRIPTION OF THE DRAWINGS

The various implementations of the present automatic data annotation and self-learning for adaptive ML applications are discussed in detail with an emphasis on highlighting the advantageous features. These implementations depict the novel and non-obvious devices, methods, and systems for automatically annotating data (e.g., training data) and/or self-learning (may be referred to collectively as “automatic data annotation and self-learning”) for adaptive ML applications shown in the accompanying drawings, which are for illustrative purposes only. These and other features, aspects, and advantages of the present disclosure will become better understood when the following detailed description is read with reference to the following accompanying drawings, in which like characters represent like parts throughout the drawings.

FIG. 1 is a schematic illustration depicting an exemplary data stream management system.

FIG. 2 is a flow diagram depicting an exemplary self-labeling logical architecture for the system depicted in FIG. 1.

FIG. 3 is a schematic illustration depicting an exemplary architecture 300 for a causal model manager.

FIG. 4 is a schematic illustration depicting an exemplary knowledge graph for a plurality of nodes.

FIG. 5 is a flow diagram depicting an exemplary first stage pre-deployment process.

FIG. 6 is a flow diagram depicting an exemplary second stage pre-deployment process.

FIG. 7 is a flow diagram depicting an exemplary post-deployment process.

FIG. 8 is a schematic diagram depicting an exemplary edge computing system.

FIG. 9 is a schematic illustration depicting an exemplary edge node architecture.

FIG. 10 is a flow diagram depicting a conventional machine learning process.

FIG. 11 is a flow diagram depicting an exemplary machine learning process.

FIG. 12 is a flow diagram depicting a conventional post-deployment adaptation process.

FIG. 13 is a flow diagram depicting an exemplary post-deployment adaptation process.

FIG. 14 is a schematic diagram depicting an exemplary operating principle for an object interaction scenario.

FIG. 15A is a flow diagram depicting an exemplary pre-deployment self-labeling workflow.

FIG. 15B is a flow diagram depicting an exemplary mid-deployment self-labeling workflow.

FIG. 16 is a graphical illustration depicting exemplary interacting dynamical system plots.

FIG. 17 illustrates an exemplary landscape simulation scenario.

FIG. 18A is a graphical illustration depicting an exemplary input-output label plot generated with perturbation.

FIG. 18B is a graphical illustration depicting an exemplary input-output label plot generated without perturbation.

FIG. 19 is a graphical illustration depicting exemplary test result plots for the implementations described herein.

FIG. 20 is a graphical illustration depicting exemplary test result plots for the implementations described herein.

FIG. 21 is a schematic illustration depicting a logical diagram for standard operating procedure cause and effect states.

FIG. 22 depicts an exemplary data table for a simplified implementation of the logical diagram depicted in FIG. 21.

FIG. 23 depicts an operating principle for an exemplary worker-machine interaction scenario.

FIG. 24 is a flow diagram depicting an exemplary real-time data processing pipeline.

FIG. 25 is a flow diagram depicting an exemplary energy disaggregation process for the data processing pipeline depicted in FIG. 24.

FIG. 26 is a graphical illustration depicting exemplary test result plots obtained with respect to the energy disaggregation process depicted in FIG. 25.

FIG. 27 illustrates an operating principle of causality for an exemplary case study.

FIG. 28 illustrates a perspective view of an exemplary environmental setup to demonstrate the operating principle of FIG. 27.

FIG. 29 illustrates an exemplary frame sequence captured for an implementation of the environmental setup depicted in FIG. 28.

FIG. 30 is a graphical illustration depicting an exemplary comparative weighting plot for the environmental set up depicted in FIG. 28.

FIG. 31 is a flow diagram depicting an exemplary data processing pipeline for the frame sequence depicted in FIG. 29 and the weighting plot depicted in FIG. 30.

FIGS. 32, 33, 34, 35, 36, 37, 38, 39, 40, 41, 42, 43, 44, 45, 46, 47, 48, and 49 shows various implementations of the disclosed multivariate causal graph analysis.

Unless otherwise indicated, the drawings provided herein are meant to illustrate features of implementations of this disclosure. These features are believed to be applicable in a wide variety of systems including one or more implementations of this disclosure. As such, the drawings are not meant to include all conventional features known by those of ordinary skill in the art to be required for the practice of the implementations disclosed herein.

### DETAILED DESCRIPTION

The following detailed description describes the present implementations with reference to the drawings. In the drawings, reference numbers label elements of the present implementations. These reference numbers are reproduced below in connection with the discussion of the corresponding drawing features. In the following specification and the claims, reference will be made to a number of terms, which shall be defined to have the following meanings.

The singular forms “a,” “an,” and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise.

As used herein, the term “database” may refer to either a body of data, a relational database management system (RDBMS), or to both, and may include a collection of data including hierarchical databases, relational databases, flat file databases, object-relational databases, object oriented databases, and/or another structured collection of records or data that is stored in a computer system.

As used herein, the terms “processor” and “computer” and related terms, e.g., “processing device”, “computing device”, and “controller” are not limited to just those integrated circuits referred to in the art as a computer, but broadly refers to a microcontroller, a microcomputer, a programmable logic controller (PLC), an application specific integrated circuit (ASIC), and other programmable circuits, and these terms are used interchangeably herein. In the implementations described herein, memory may include, but is not limited to, a computer-readable medium, such as a random-access memory (RAM), and a computer-readable non-volatile medium, such as flash memory. Alternatively, a floppy disk, a compact disc-read only memory (CD-ROM), a magneto-optical disk (MOD), and/or a digital versatile disc (DVD) may also be used. Also, in the implementations described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary implementation, additional output channels may include, but not be limited to, an operator interface monitor.

Further, as used herein, the terms “software” and “firmware” are interchangeable and include any computer program storage in memory for execution by personal computers, workstations, clients, servers, and respective processing elements thereof.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

Furthermore, as used herein, the term “real-time” refers to at least one of the time of occurrence of the associated events, the time of measurement and collection of predetermined data, the time for a computing device (e.g., a processor) to process the data, and the time of a system response to the events and the environment. In the implementations described herein, these activities and events may be considered to occur substantially instantaneously.

### Automatic Data Labeling

Some conventional techniques for automatic labeling include self-supervised learning, pseudo labels, delayed labels, and domain knowledge. Conceptually, “pseudo labels” and variants thereof are known to use trained ML models or clustering algorithms to generate labels for unlabeled data that is then used to retrain models or jointly optimize the target learning and label generation. As with other semi-supervised methods, conventional pseudo labels rely heavily on feature similarity between labeled and unlabeled data and the distinctiveness of features across different classes (e.g., equipartition constraint to maximize mutual information between data indices and labels for pseudo labels generation). Some pseudo-labels are known to ensemble predicted probabilities of multiple randomly augmented versions of the same sample for source-free unsupervised domain adaptation.

In contrast, “delayed labels” refer to cases where label feedback comes after the input data in data streams, resulting in label latency that coincides with the causal time interval (e.g., described further below with respect to the following implementations). Conventional techniques have recognized such delays and attempted to mitigate such; however, these conventional solutions have failed to recognize the physical meaning of the delay itself. This lack of understanding in the art is addressed and solved according to the following implementations.

“Domain knowledge,” on the other hand, refers to logical relations of data, ontology, and knowledge bases. Data knowledge is conventionally converted to constraints applied during model training, for example, in the case of automatically labeled drivers/vehicles, the yield intentions of the driver/vehicle may be automatically labeled by using the car position data from changing-lane behaviors to infer preceding driving actions. The implementations herein are advantageously configured to determine causality based on domain knowledge. That is, according to the systems and methods described herein, the causal relation of interactive objects, and particularly causal directions, are extracted from knowledge obtained according to the following implementations.

### Causality Inspired ML

Progress in statistical causality, such as Granger Causality (GC) and Structural Causal Models (SCM), have formalized causality testing, representation, and analysis with mathematical tools. Some recent ML algorithms have been used, together with statistical causal representations, to perform causal analysis for multi-domain causal structural learning, causal imitation learning, causal discovery, and causal inference by graphical models. One alternative conventional approach conversely considered causality with respect to ML and semi-supervised learning to enhance ML robustness by leveraging cross-domain invariant causal mechanisms. However, all of these conventional approaches are based on the assumption that the generation of causal data and the causal mechanism (P(effect|cause)) are independent; such conventional assumptions therefore overlook the temporality of causal relationships. The present systems and methods though, by accounting for the temporality of causal relationships, achieve significant advantages over these conventional techniques.

More particularly, implementations for improved automatic data annotation and self-learning for adaptive ML applications are described below with reference to the figures. These figures, and their written descriptions, may indicate that certain components of the apparatus are formed integrally, whereas other components may be formed as separate physical and/or logical units. Those of ordinary skill in the art will appreciate that components shown and described herein as being formed integrally may, in alternative implementations, be formed as separate pieces. Those of ordinary skill in the art will further appreciate that components shown and described herein as being formed as separate pieces may, in alternative implementations, be formed integrally. Further, as used herein the term integral describes a single unitary piece.

One aspect of the present implementations includes the realization that in most cases, an ML model may utilize manual data annotation during the training stage. The present automatic data annotation and self-learning for adaptive ML provides for devices, methods, and systems that automatically annotate training data for ML models after ML models are deployed in field applications. For example, the present implementations may automatically collect and annotate data in real time, after deployment, to allow self-adaptation of ML models.

Another aspect of the present implementations includes the realization that ML has demonstrated a significant potential in many applications by its enhanced data-driven intelligence. There are different categories of ML algorithms including, but not limited to, unsupervised learning, supervised learning, semi-supervised learning, and reinforcement learning. For supervised learning that is usually characterized with greater prediction performance and applicability, ML models may be trained using labeled datasets during an offline training stage in order to enhance the performance thereof. Particularly, the quality of datasets, such as data quantity and coverage, may significantly impact the models' accuracy. In conventional methods, training datasets are manually annotated by humans and are typically pre-allocated with static data, which increases labor cost and makes it difficult to adapt trained ML models to unseen data samples without human intervention. Furthermore, the data distribution difference between training dataset and actual data collected in deployment environments may constrain ML performance. Therefore, the post-deployment automatic data annotation techniques provided herein are of particular beneficial utility to addressing and mitigate such conventional problems.

Another aspect of the present implementations addresses and provides solutions for a critical problem in AI applications, namely, where the training and deployment of ML models in many application fields requires significant time-consuming and resource-intensive efforts at preliminary stages to collect and label datasets for AI training. The present implementations enable significant reductions to the time cost and labor efforts needed for data collection and annotation, thereby advantageously reducing the technical barriers for companies to apply AI with their own data and environments. Additionally, the present implementations reduce the cost needed to maintain deployed AI models to counter data distribution shifts and achieve continual and adaptive learning. Compared with conventional techniques that require manual data re-collection and re-annotation to alleviate data distribution shifts, the present implementations enable systems and methods that may automatically collect and annotate data for retraining and adapting AI models to dynamic environments. According to the innovative solutions described herein, considerably smaller sets of manually-labeled data are used for pretraining stage, in comparison with conventional techniques.

In an exemplary implementation, systems and methods according to the present techniques are further capable of readily achieving convergence of causal interactive task models during adaptive learning stages. Such capabilities are not realized using conventional techniques.

Turning now to the drawings, automatic data annotation and self-learning for adaptive ML applications in accordance with implementations of the technology disclosed are described. Conventionally, ML model training involves a dataset where each data sample is associated with a label. In contrast, the present implementations provide devices, systems, and methods for automatically generating training datasets, such that the ML model accuracy and ML model adaptation to unseen situations is significantly improved.

In an implementation, automatic data annotation and self-learning focuses on ML problems involving interactive objects, persons, or domains. For example, the present implementations may utilize causal relationships between interactions where one side of an interaction (i.e., the “cause side”) may cause the state change of the other side (i.e., the “effect side”), considered as effects. In some implementations, systems and methods are provided for designing and training a computational model, for inference of interaction time from the effect side, to automatically select and label data samples from data streams at the cause side. In other implementations, automatic selection and labeling of data samples at the cause side may be executed in real-time, or near-real time, after deployment.

In an implementation, automatically collected and labeled dataset(s) may be used to retrain deployed ML models for various objectives including, but not limited to, objectives for accuracy improvement. The present implementations thus provide solutions to the critical problem of data annotation and domain adaptation in ML utilization. The various methods described herein may be utilized to develop integrated software and hardware platforms for adding continual learning capability to ML models in many fields.

The present implementations therefore demonstrate advantageous techniques for automating data labeling processes for developing ML applications. In an exemplary implementation, data labeling processes may include steps of: (1) selecting which segment of data needs to be labeled; and (2) generating a label for the selected data segment, and then associating the label and data sample. In this manner, a labeled dataset with many data-label pairs may be derived for ML training. In an exemplary implementation, both of steps (1) and (2) are automated during real-time ML deployment. In at least one implementation, automation of steps (1) and (2) is achieved through implementation of an innovative causality-enhanced self-labeling subprocess.

These and other exemplary implementations for automatic data annotation and self-learning are described below in greater detail.

### Automatic Data Annotation and Self-Learning Systems

As described herein, the concept of causality may refer to the cause-and-effect relationships among objects. For example, an event, process, or state change of a first object may contribute to another event, process, or state change of a second object. Additionally, causality may be direct or indirect. Indirect causality refers to a scenario where the impact from the cause side may reverberate through one or more intermediaries until reaching, and thus affecting, the effect side. As referred to herein, the term “interaction” may refer to interactive activities between at least two objects, subjects, or sides, where one of the objects/sides impacts the other object/side to cause some level of state change to that other side. In some cases, interaction may be associated with causality, such as in the case where one side serves as a cause variable affecting the other side as an effect variable.

Some of the implementations described herein may implement one or more types of computational models. For example, a computational “task model” may represent an ML model type that addresses ML problems, including without limitation, pattern recognition problems and other various user needs. A “causal interactive task model” is therefore defined herein as a task model that is assisted by the innovative automatic data labeling and self-learning (referred to collectively herein as a “self-labeling”) solutions described herein. According to this enhanced causal interactive task model, a task model may be dynamically and adaptively retrained and updated after deployment with automatically collected and automatically labeled data samples.

According to the innovative causal interactive task model described herein, the present automatic self-labeling systems and methods advantageously may additionally account for the interaction time between objects and events. That is, as used herein, the term “interaction time” may refer to the time interval(s) between a cause event and a related effect event. The present self-labeling systems and methods may also be applied to causal scenarios having respective cause and effect events. For example, when a cause event occurs, there will naturally be a necessary amount of time (i.e., a time period) for the information and/or energy from the cause event to transmit such that the resultant effect thereof may reach a defined observable strength. In an exemplary implementation, this time period may be considered to be the interaction time. It may be noted though, that the interaction time may vary for different cause-and-effect states, for different objects, and for different domains.

As described herein, the term “interaction time model,” or “ITM,” may refer to one or more computational models configured to infer the interaction time based on data obtained from cause or effect sides, the term “effect recognizer” may represent one or more processors or computational models configured to recognize states of effect events, and the term “data stream” may refer to a series of data samples indexed by timestamps, such as, but not limited to, sensor data and software user logs.

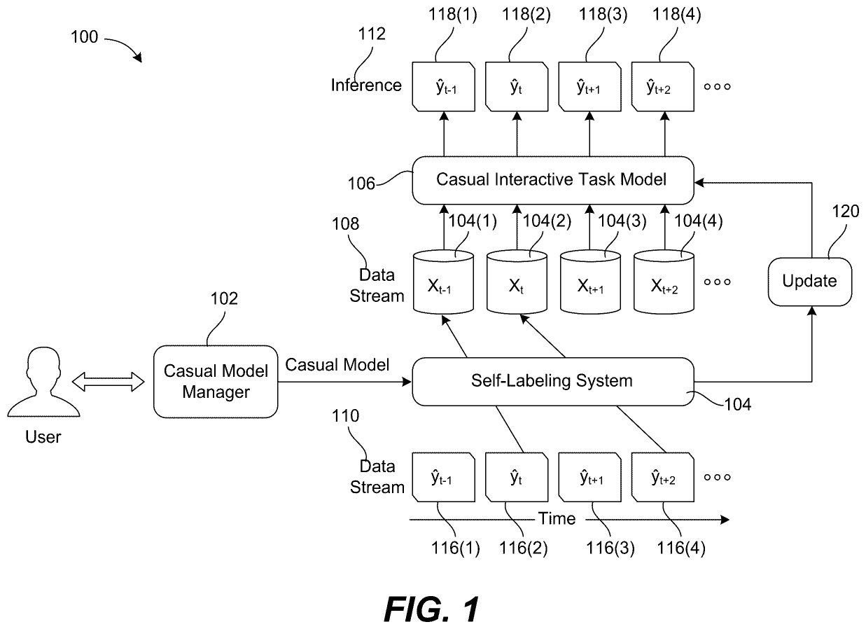

FIG. 1 is a schematic illustration depicting an exemplary data stream management system 100. In an exemplary implementation, system 100 includes a Causal Model Manager (CMM) 102, a self-labeling subsystem 104, and a causal interactive task model 106. In an implementation, one or both of CMM 102 and self-labeling subsystem 104 may be implemented as dedicated hardware units, software modules, and/or a combination of hardware and software. Similarly, causal interactive task model may constitute a dedicated software module, one or more algorithms, or a dedicated processor and accompanying memory configured to generate, manage, and/or implement a causal interactive task model.

In the exemplary implementation depicted in FIG. 1, system 100 illustrates a real-time implementation of post-deployment inference and self-labeling for a first data stream 108, and a second data stream 110. In this exemplary scenario, first data stream 108 is represented as an input data stream x, and second data stream 110 is represented as an available data stream y that may function directly or indirectly as a label stream. In an implementation, a third data stream 112 is represented as a predicted label stream y, generated from causal interactive task model 106 after ingestion of first and second data streams 108, 110 by system 100. As depicted in FIG. 1, first data stream 108 includes a plurality of sequential data 114 (i.e., 1-N data xᵢ), second data stream 110 includes a plurality of sequential data 116 (i.e., 1-N data yᵢ), and third data stream 112 includes a plurality of sequential data 118 (i.e., 1-N data ŷᵢ).

In exemplary operation of system 100, namely, for real-time inference during deployment, causal interactive task model 106 may receive a first data stream 108 as intake x data 114, and therefrom predict. In an exemplary implementation, ŷ data 118 for third data stream 112 is predicted from intake x data 114 after x data 114 is causally associated with respective y data 116 by self-labeling system 104. Self-labeling subsystem 104 may, for example, be configured with a causal state transition model (e.g., from CMM 102) for corresponding x and y states to causally associate x and y states to perform automatic data annotation. In an implementation, such automatic data annotation is performed in real-time, and self-labeling subsystem 104 may be further configured with an update mechanism 120 configured to automatically update causal interactive task model 106. In an exemplary implementation, CMM 102 may be further configured to derive a causal state transition model from one or more user queries, such as from a pre-established knowledge database (not shown in FIG. 1), prior to deployment of system 100 (e.g., in a pre-deployment stage, described further below).

Accordingly, in further exemplary operation of system 100, self-labeling subsystem 104 may, during deployment, intake a data segment of y data 116 from second data stream 110 (i.e., y data 116(1-4), and this example) to detect the y state (namely, the “label” used in this self-labeling scenario), the y state transition, and the corresponding interaction time. In this manner, self-labeling subsystem 104 may be advantageously configured to perform a traceback of the derived interaction time over the temporal dimension to find a corresponding data segment of x data 114 (i.e., x data 114(1-4), in this example) from first data stream 108 that may be identified as the cause of the respective y state transition. From this traceback operation, self-labeling subsystem 104 is thereby enabled to associate the selected x data segment and its corresponding derived y label to form an (x|y) pair of data+label (e.g., x data 114(1)+y label 116(2), x data 114(2)+y label 116(4), etc.). Thus, for the exemplary scenario depicted in FIG. 1, label yₜ₊₁ and data xₜ₋₁ are shown to be causally related, and label yₜ₊₂ and data xₜ are shown to be causally related.

In an exemplary implementation, self-labeling subsystem 104 may be further configured to be executed multiple times when new y data 114 is received. Therefrom, and incremental dataset of self-labeled data samples may be derived for ŷ data 118, which in turn may be advantageously used to further update causal interactive task model 106 by retraining and/or fine-tuning adjustments. In this manner, causal interactive task model 106 may be still further updated after deployment which thereby mitigates the conventional pre-deployment need for manual data annotation, as well as the potential post-deployment data distribution shifts experienced according to conventional techniques.

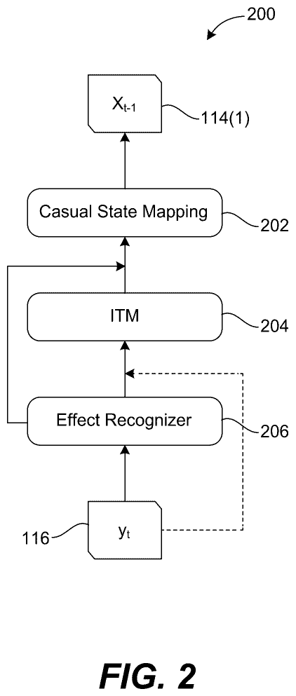

FIG. 2 is a flow diagram depicting an exemplary self-labeling logical architecture 200 for system 100, FIG. 1. In the exemplary implementation depicted in FIG. 1, architecture 200 includes one or more of a causal state mapping module 202, an interaction time model (ITM) 204, and an effect recognizer 206. In an implementation, effect recognizer 206 may be executed as a computational model configured to classify effect data streams into corresponding states, which computational model may include one or more of a signal processing model, and a data-driven model based on mathematical data, physical data, statistical data, machine learning data, etc. In some implementations, effect recognizer 206 functions in a supervised manner; in other implementations, effect recognizer 206 may function in an unsupervised manner. In at least one implementation, effect recognizer 206 is further configured to ingest and process y label data 116, FIG. 1, from second data stream 110 to derive the respective y label therefor.

In an implementation, ITM 204 may include a computational model or processing module configured to execute classification or regression tasks. For example, ITM 204 may receive (a) the derived y states from effect recognizer 206, and/or (b) raw y data 116 from second data stream 110, to then infer the interaction time of the respective y state transitions. In an implementation, causal state mapping module 200 may receive the inferred interaction time from ITM 204, as well as the derived label from effect recognizer 206, to backtrack one iteration step size of the inferred interaction time t in order to select an appropriate x data segment from x data 114, and then annotate the selected x data segment (e.g., xₜ₋₁ data 114(1), in the example depicted in FIG. 2) with the derived y label at time t (e.g., yₜ data 116(2), in this example).

In an implementation, such in the case of a multi-variable scenario, causal state mapping module 202 may further configured to associate effect variables with causal variables based on established causal state transition models to achieve correct self-labeling among causal data streams. The person of ordinary skill in the art will understand that the order of execution described with respect to architecture 200 is provided by way of illustration and is not intended to be limiting. For example, in some implementations, ITM 204 and effect recognizer 206 may be configured to function in parallel (e.g., in relative simultaneity), or may be executed in reverse order than that described above.

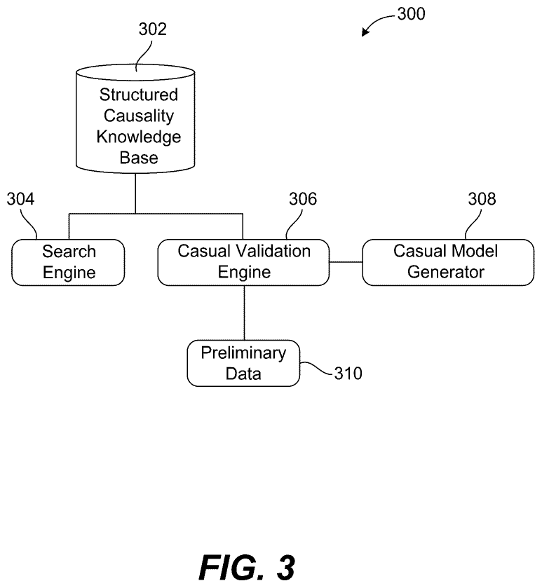

FIG. 3 is a schematic illustration depicting an exemplary CMM architecture 300. In an exemplary implementation, CMM architecture 300 may be implemented with respect to CMM 102, FIG. 1. In the exemplary implementation depicted in FIG. 3, architecture 300 includes one or more of a structured causality knowledge graph (KG) database 302, a search engine 304, a causal validation engine 306, and a causal model generator 308. In some implementations, causal validation engine 306 may utilize preliminary dataset 310, which may represent a database or memory device configured with predetermined and/or collected data from respective users. CMM architecture 300 thus functions to assist users in determining whether an ML question may be enhanced, after deployment, using the causality-based self-labeling techniques and automatic model accuracy improvements described herein.

In an implementation, structured causality KG database 302 is configured to represent causal relationships among events or variables. In some implementations, structured causality KG database may be used among multiple users, and the corresponding user-related information from such multiple users may be desensitized to mask the identifiable information of one user from another user.

In exemplary operation, a user may query CMM architecture 300 with an ML question/query to obtain information about associated interactive objects, causal relationships among interactive events, sensor options, and potential observing channels for the particular ML question. The particular ML query may, for example, be formulated according to an event- or variable-based form by an individual user. Search engine 304 may then receive such user-formulated ML queries from structured causality KG database 302, and subsequently perform a search over the knowledge base to return a list of search results.

In an implementation, preliminary dataset 310 is collected from user information based on suggested events and sensor modalities from the particular ML query, and causal validation engine 306 may therefore be configured to obtain such collected information from preliminary dataset 310, and then execute one or both of a causality test or modeling (e.g., Granger causality test) on the obtained information from preliminary dataset 310 to confirm the causal relationships between events in the relevant user environments. In at least one implementation, preliminary data set 310 may be based on the proposed (e.g., user-proposed) ideas of causal events and sensor modalities for a particular ML query, and the information contained within preliminary data set 310 may, in such cases, be based on proposed events and sensors for causality validation. In an exemplary implementation, causal validation engine 306 is further configured to edit structured causality KG database 302.

In an implementation, causal model generator 306 may be configured to generate a causal state transition model based on the returned list from search engine 304, e.g., based on user queries or user proposals and/or validation results from causal validation engine 306. In some implementations, the causal state transition model generated by causal model generator 308 may include one or more of a deterministic and probabilistic model, which may include two or more variables, states of each variable, and/or state transition relationships of corresponding cause and effect variables.

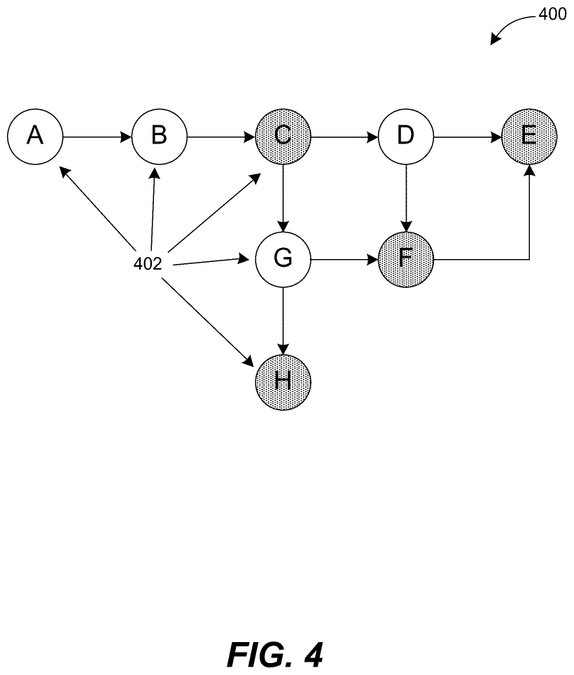

FIG. 4 is a schematic illustration depicting an exemplary KG 400 for a plurality of nodes 402. In the exemplary implementation depicted in FIG. 4, KG 400 illustrates an exemplary knowledge graph representing events, as well as their respective causal relationships, among multiple variables, e.g., a plurality of directly or indirectly interactive nodes 402 (i.e., nodes A-H, in the exemplary scenario depicted in FIG. 4). In an exemplary implementation, KG 400 may be generated and implemented within a structured causality knowledge base of a CMM (e.g., structured causality KG database 302 of CMM architecture 300, FIG. 3) to provide suggestions to user queries about causal event selection for self-labeling.

As described further below, KG 400 may be particularly useful with respect to the self-labeling systems and methods described herein. For example, each node 402 of KG 400 may represent a specific event, sensor, and/or classifier configured to recognize a particular event. In the exemplary implementation depicted in FIG. 4, nodes C, E, F, H are illustrated to represent events with readily available classifiers (i.e., effect recognizers configured to identify events of nodes C, E, F, H are readily available for use or may be easily configured). According this exemplary scenario, (a) node C may thus function as an effect recognizer (e.g., effect recognizer 206, FIG. 2) for nodes A and B, (b) nodes E and F may jointly serve as the relevant effect recognizer(s) for node D, and (c) nodes E, F, H may jointly serve as effect recognizers for nodes A, B, C.

The person of ordinary skill in the art will understand that the preceding example is provided by way of illustration and is not intended to be limiting. For example, successor nodes 402 may individually or jointly serve as respective effect recognizers for their predecessor nodes. In exemplary operation of KG 400, once a causal interactive task model (e.g., causal interactive task model 106, FIG. 1) is sufficiently adapted, the corresponding node 402 may be marked as available, and this corresponding node may then serve as an effect recognizer for its predecessor(s). In some implementations, KG 400 may include one or more causal sub-structures, for example, as depicted with respect to nodes G, F, H, indicating a G-F-H fork sub-structure. For this particular sub-structure, in the case where only node H is readily available, node H may still be able to partially self-label node G. In this context, “partial self-labeling” refers to the granularity of self-labeled predecessor states that depend on the labels provided by successor effects. For example, in the case of two effect variables, but only one effect recognizer being readily available, the self-labeling of nodes may be dependent on the recognizable effect and self-labeled states of predecessor nodes, and therefore limited to such recognizable effect states.

Although particular systems and methods for automatic data annotation and self-learning are described above with respect to FIGS. 1-4, any of a variety of systems as appropriate to the requirements of a specific application can be utilized in accordance with implementations of the technology disclosed. Stages of automatic data annotation and self-learning in accordance with implementations of the technology disclosed are discussed further below.

### Automatic Data Annotation and Self-Learning Stages

In an exemplary implementation, the present systems and methods may be considered within the context of various deployment stages. For example, automatic data annotation and self-learning techniques may include two pre-deployment stages (i.e., executed before deployment of system 100, FIG. 1) and a post-deployment stage (i.e., executed after or during system deployment). In an exemplary implementation, a first pre-deployment stage may include processing and/or algorithms for identifying causal relationships among participating entities of interactive activities that are involved in the data generation process of specified ML questions, such as by querying a pre-built knowledge base (e.g., preliminary data set 310, FIG. 3). Additionally, a second pre-deployment stage may include processing and/or algorithms for designing and training computational models prior to deployment, for determining the interaction time between corresponding cause and effect states, and/or training a computational model to infer this interaction time (such as for an ITM (e.g., ITM 204, FIG. 2) of a post-deployment stage for automatic data annotation processing).

In some implementations, the present self-labeling systems and methods, as well as their associated computational models, may be implemented for various field applications after execution of the two pre-deployment stages. In an exemplary implementation, a post-deployment stage is additionally executed and may include additional processing and/or algorithms for jointly utilizing the determined temporal relationships from causality and effect recognizers to automate data self-labeling. In at least one implementation, the post-deployment stage may further include processing and/or algorithms configured to obtain a dataset for retraining and adapting causal interactive task models (e.g., causal interactive task model 106, FIG. 1).

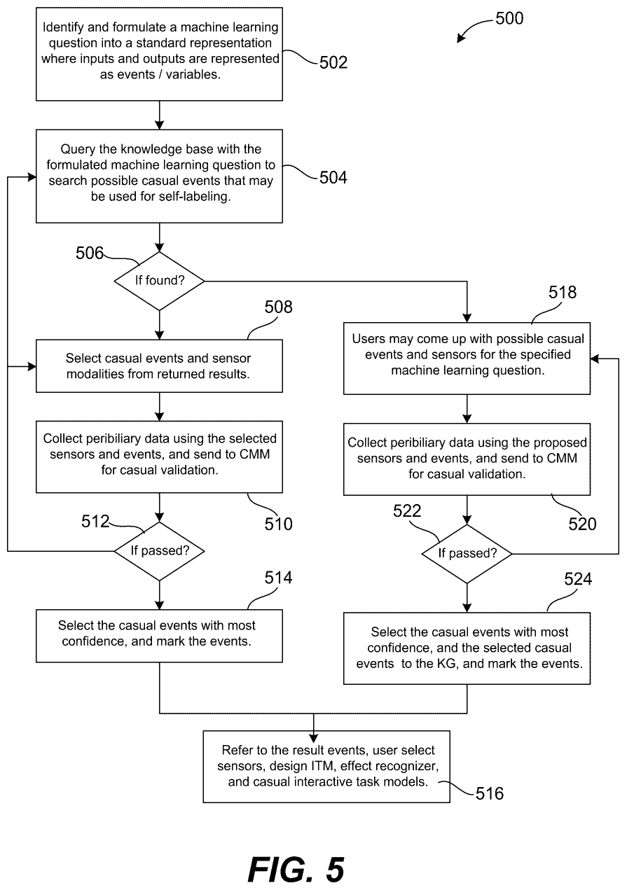

FIG. 5 is a flow diagram depicting an exemplary first stage pre-deployment process 500. In an exemplary implementation, first stage pre-deployment process 500 may be implemented by one or more processors or processing modules of the systems and methods described herein (e.g., of system 100, FIG. 1). Unless described otherwise to the contrary, some steps of first stage pre-deployment process 500 may be performed in a different order than described herein, and/or one or more steps of first stage pre-deployment process 500 may be performed simultaneously. Additionally, first stage pre-deployment process 500 may include more or fewer steps without departing from the scope herein.

In an exemplary implementation, first stage pre-deployment process 500 is configured to derive causal events for ML questions/queries and begins at step 502, in which a user-specified ML problem is formulated into standard input-output relations and standard input and output variables. In an exemplary implementation of step 502, such formulated ML problems may refer include defined input-output relations where the input and output of ML models are abstracted into events or variables representations. In at least one implementation of step 502, the ML models may directly ingest inputs and generate outputs. For example, prediction of changing lane behaviors in driving given current and historical driving data may be formulated to an ML problem where the input events of an automobile, together with the behaviors of neighboring automobiles, may predict an output event of the lane-changing behavior. In this example, the participating entities may include both the drivers and their automobiles, interacting to generate data for this particular ML problem.

In step 504, a knowledge base (e.g., structured causality KG database 302, FIG. 3) is queried with the ML question formulated in step 502. In an exemplary implementation of step 504, a CMM (e.g., CMM 102, FIG. 1) receives one or more user-formulated ML questions to query for potential causally-linked events for self-labeling, and the queried knowledge base may include pre-built causal relationships represented as graph models in a format, such as OWL, ontology, and/or KG. Step 506 is a decision step. If, in step 506, satisfactory and feasible search results are obtained for users, process 500 proceeds to step 508, in which causal events and sensor modalities are selected from the returned results. In an exemplary implementation of step 508, process 500 may prompt one or more users to select the causal events and corresponding sensor modalities from the returned query results.

In step 510, preliminary data (e.g., preliminary dataset 310, FIG. 3) for the selected causal events and sensor modalities, for example, using selected sensors, and this preliminary dataset may then be sent to the CMM for further causality validation. In an exemplary implementation of step 510, such further causal validation may be performed with respect to particular user environments based on statistical causal modeling and test techniques, such as Granger Causality (GC) and variants thereof. Step 512 is a decision step. In step 512, if the preliminary dataset is causally validated (i.e., passes validation criteria), process 500 proceeds to step 514, in which process 500 may further select the causal events exhibiting the highest levels of confidence. In an exemplary implementation of step 514, process 500 marks the selected high-confidence events for implementation with respect to one or more of the modeling techniques described herein.

If, however, in step 512, the preliminary dataset is not causally validated, process 500 returns to step 508, to select more or different causal events and/or sensor modalities. Alternatively, process 500 may return to step 504, to re-query the knowledge base with different or additional ML learning questions. In step 516, process 500 utilizes the selected/marked high-confidence events to enable sensor and/or effect recognizer (e.g., effect recognizer 206, FIG. 2) selection, ITM design (e.g., ITM 204, FIG. 2), and generation or selection of one or more causal interactive task models (e.g., causal interactive task model 106, FIG. 1). In an exemplary implementation of step 516, one or more of the causal events and/or associated sensor modalities are determined from the CMM. In at least one implementation of step 516, the determined events and/or modalities may be based on a user proposal. In an implementation, one or more sensor modalities may be selected for each object to capture streaming data (e.g., data streams 108, 110, FIG. 1).

Referring back to step 506, in the case where feasible causal events are not found from the query posed in step 504, process 500 proceeds to step 518, in which one or more users may be prompted to input possible causal events and/or sensors for a particular ML question. In an exemplary implementation of step 518, user-based criteria may utilize causality underlying interactive objects or events during data generation for specified ML questions to identify possible causal events. In at least one implementation of step 518, one or more users may be prompted to input criteria based on user-observed effects, user experience, and/or existing documented knowledge.

In step 520, the CMM may collect user-input preliminary data of the proposed causal relations using proposed sensors and apply statistical causal modeling techniques to this collected preliminary data to validate the proposed causal relations. Step 522 is a decision step. In step 522, if the collected preliminary data is causally validated, process 500 proceeds to step 524, in which process 500 may further select the causal events exhibiting the highest levels of confidence, and then add the selected user-proposed causal relations to the knowledge base. In an exemplary implementation of step 524, the user-proposed causal relations that are added to the knowledge base may be marked as validated within the knowledge base. Process 500 may then proceed to step 516, after which process 500 may end.

If, however, in step 522, the collected user-proposed causal events cannot be validated, process 500 returns to step 518. In this case, steps 518 through 522 may be repeated until user-proposed events may be validated, or until in an iteration threshold (e.g., a predetermined number of iterations) is reached. In an implementation of step 522, in the case where an iteration threshold limit has been reached, process 500 may prompt one or more users to edit the associated knowledge base to add one or more user-proposed causal events that have not been causality validated. In this scenario, such user-proposed causal events may be included in the knowledge base, but with a marking indicating that that these events are unvalidated. For example, it may be desirable, in some scenarios, to be able to share unvalidated causal events with other users for use in the respective environments of such other users.

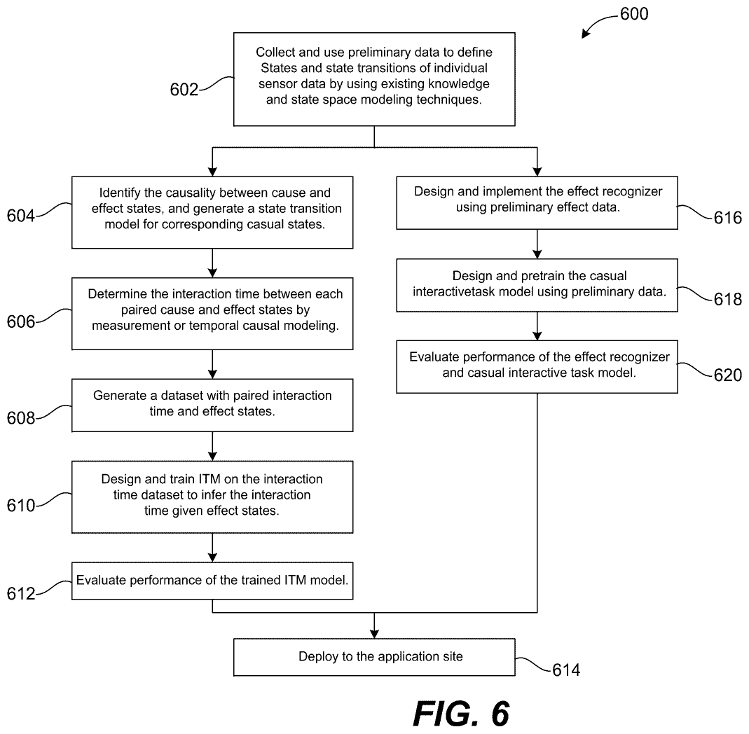

FIG. 6 is a flow diagram depicting an exemplary second stage pre-deployment process 600. In an exemplary implementation, second stage pre-deployment process 600 may be implemented by one or more processors or processing modules of the systems and methods described herein (e.g., of system 100, FIG. 1). Unless described otherwise to the contrary, some steps of second stage pre-deployment process 600 may be performed in a different order than described herein, and/or one or more steps of second stage pre-deployment process 600 may be performed simultaneously. Additionally, second stage pre-deployment process 600 may include more or fewer steps without departing from the scope herein.

In an implementation, second stage pre-deployment process 600 is configured to facilitate and enable the design, generation, and training of models used for the self-labeling systems (e.g., self-labeling subsystem 104, at FIG. 1) and causal interactive task models (e.g., causal interactive task model 106, at FIG. 1). In an exemplary implementation, second stage pre-deployment process 600 may be configured for execution after the determination of causal events and sensor modalities (e.g., step 516 of first stage pre-deployment process 500, FIG. 5).

In the exemplary implementation depicted in FIG. 6, second stage pre-deployment process 600 begins at step 602, in which preliminary data is collected to define states and state transitions of individual sensor data. In an exemplary implementation of step 602, the preliminary data may be collected directly from user input or may be based on a preliminary dataset used by a CMM (e.g., preliminary dataset 310 of CMM architecture 300, FIG. 3). In at least one implementation of step 602, the collected preliminary data is implemented to define finite states of involved data streams (e.g., data streams 108, 110, FIG. 1) and define state transitions of an individual data stream based on existing knowledge and state space modeling techniques, such as finite state machines. In some implementations, such existing knowledge may include without limitation documented knowledge, ontology, CMM, known relationships of interactive objects, physical relationships, and the defined machine learning tasks.

In step 604, process 600 is configured to identify the causality between cause-and-effect states, and then generate a state transition model for corresponding causal states. In an exemplary implementation of step 604, derived states of individual data streams may be causally related to define deterministic or probabilistic causal transitions. In at least one implementation of step 604, the generated state transition model is a causal state transition model, and is based on the corresponding cause and effect state transitions. In some scenarios, a cause state and its corresponding effect state may be asynchronous in the case where the temporal resolution is sufficiently fine.

In step 606, process 600 determines the interaction time between each cause-and-effect states. In an exemplary implementation of step 606, the interaction time is determined by measurement and/or temporal causal modeling. In at least one implementation of step 606, the interaction time for each cause-and-effect state pair is determined for selected causal events (e.g., steps 514, 524, at FIG. 5) according to a measurement, a time study, temporal causal modeling techniques, and/or a signal alignment. In step 608, process 600 is configured to generate and/or collect at least one dataset with paired interaction time and effect states. In step 610, process 600 is configured to design and/or train an ITM (e.g., ITM 204, FIG. 2), based on the collected dataset, to infer interaction time by intaking effect data. In an exemplary implementation of step 610, the ITM is configured as a computational model, including without limitation, one or more of an ML model, a mathematical model, a physical model, and a look-up table.

In step 612, upon completion of ITM training (e.g., from one or more iterations of step 610), process 600 evaluates the ITM for its inference performance. In an exemplary implementation of step 612, the ITM may be evaluated based on a regression mode or a classification mode, e.g., depending on the discreteness of the defined interaction time. For example, a regression mode ITM may be used for a continuous interaction time, whereas a classification mode ITM may be used for a discrete interaction time. In step 614, process 600 is completed and the self-labeling system is deemed ready for deployment to an application site.

Referring back to step 602, in parallel with steps 604 through 612, process 600 is further configured, in step 616, to design and implement an effect recognizer (e.g., effect recognizer 206, at FIG. 2) using preliminary effect data (e.g., preliminary dataset 310, FIG. 3). In step 618, process 600 may design in pre-train a causal interactive task model (e.g., causal interactive task model 106, FIG. 1) using the preliminary data. In step 620, process 600 is configured to evaluate the performance of the effect recognizer and the causal interactive task model. Once so evaluated, process 600 again proceeds to step 614, indicating that the self-labeling system (i.e., including the effect recognizer and the causal interactive task model) is to the application site.

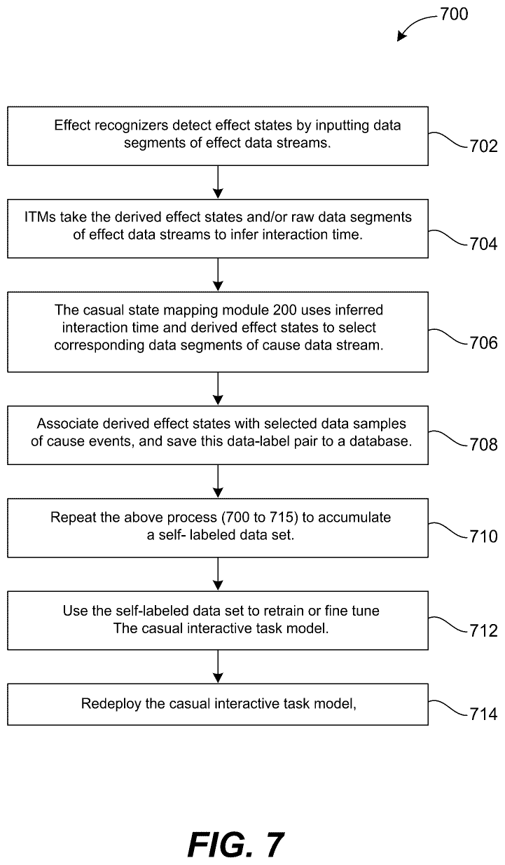

FIG. 7 is a flow diagram depicting an exemplary post-deployment process 700. In an exemplary implementation, post-deployment process 700 may be implemented by one or more processors or processing modules of the systems and methods described herein, and particularly with respect to a self-labeling system (e.g., self-labeling subsystem 104, FIG. 1). Unless described otherwise to the contrary, some steps of post-deployment process 700 may be performed in a different order than described herein, and/or one or more steps of post-deployment process 700 may be performed simultaneously. Additionally, post-deployment process 700 may include more or fewer steps without departing from the scope herein.

In an implementation, post-deployment process 700 is configured to facilitate self-labeling in a deployment/post-deployment stage for the automatic collection and labeling of data, for example, to dynamically improve and refine one or more causal interactive task models (e.g., causal interactive task model 106, at FIG. 1). In an exemplary implementation, post-deployment process 700 may be configured for execution after execution of first stage pre-deployment process 500, FIG. 5, and second stage pre-deployment process 600, FIG. 6. For example, during deployment, multiple data streams (e.g., data streams 108, 110, FIG. 1) from respective cause events and effect events may be available for use by a self-labeling system (e.g., self-labeling subsystem 104, FIG. 1) and the data thereof (e.g., data 114, 116, respectively, FIG. 1) may be ingested by a causal interactive task model (e.g. causal interactive task model 106, FIG. 1) to infer effect states to enable prompt decision-making prior to receiving actual (i.e., ground truth) effect state information from processing effect data streams as designated. According to the advantageous self-labeling techniques described below with respect to process 700, the causal interactive task model may be adaptively retrained to achieve better performance using self-labeled data.

In the exemplary implementation depicted in FIG. 7, post-deployment process 700 begins at step 702, in which one or more effect recognizers (e.g., effect recognizer 206, FIG. 2) may intake segments (e.g., data 116, FIGS. 1-2) of effect data streams (e.g., second data stream 110, FIG. 1) to derive an effect state for an individual respective effect event. In step 704, an ITM (e.g., ITM 204, FIG. 2) may intake raw or processed segments of the effect data stream, and/or the effect states derived in step 702, to infer the corresponding interaction time of each cause-effect relationship. In step 706, a CMM (e.g., CMM 102, FIG. 1) may receive the interaction time information inferred in step 704, and then select corresponding segments of the cause data stream (e.g., first data stream 108, FIG. 1) based on this received information. In an exemplary implementation of step 706, the CMM may be additionally configured to receive the effect states derived in step 702 and use this additional information to select the corresponding cause data segments.

In at least one implementation of step 706, the CMM may further function to map one or more of the ingested effect events to respective corresponding cause events, and then derive a label for these two mapped events from the respective effect states. For such mapping, the CMM may further determine the final interaction time used for backtracking, and then may backtrack a period or index of the final interaction time to select the relevant data segments from the cause data streams. In an implementation, such a backtracking technique may be configured to select segments of a cause data stream captured at timestamps/indexes Tₑ-T_{infer}, where Tₑ indicates a timestamp for capturing data segments of effect data streams that are used to derive the label, and where T_{infer} indicates the inferred final interaction time.

In step 708, the derived label(s) and selected cause data segment(s) are associated as a labeled data instance (e.g., x|y paired data, FIG. 1). In step 710, steps 702 through 710 are iterated a plurality of times (e.g., a predetermined iteration index) to accumulate a complete self-labeled dataset. In step 712, upon accumulation of the complete self-labeled the dataset, the causal interactive task model is retrained with the accumulated dataset to improve and refine detection accuracy during deployment. In an exemplary implementation of step 712, retraining of the causal interactive task model may be executed a plurality of times, such as according to a predetermined number of iterations, or by a determination that the causal interactive task model has been sufficiently tuned for the particular deployment purposes.

Although processes 500-700, FIGS. 5-7, respectively, are described in regard to exemplary pre- and post-deployment stages for automatic data annotation and self-learning, the person of ordinary skill in the art will understand that such staging examples are provided by way of illustration and are not intended to be limiting. More or fewer processing techniques may be implemented with respect to a variety of stages and processes without departing from the scope herein.

### Edge Computing Platforms and Edge Nodes

In an exemplary implementation, the several innovative techniques described above for automatic data annotation, self-learning, and self-labeling may be of particular utility with respect to edge computing platforms and edge nodes. That is, according to the present implementations, various computing systems/devices, including without limitation edge nodes, local hubs, cloud computing devices, virtual devices, client devices (e.g., smartphones, laptops, tablet computer, desktops, vehicles, etc.), and sensors, may be advantageously configured to perform one or more of the automatic data annotation and self-learning functions described herein for adaptive ML applications. In some implementations, such automatic data annotation and self-learning functionality may be executed by one or more systems/devices individually, or cooperatively by multiple such systems and/or devices in network communication.

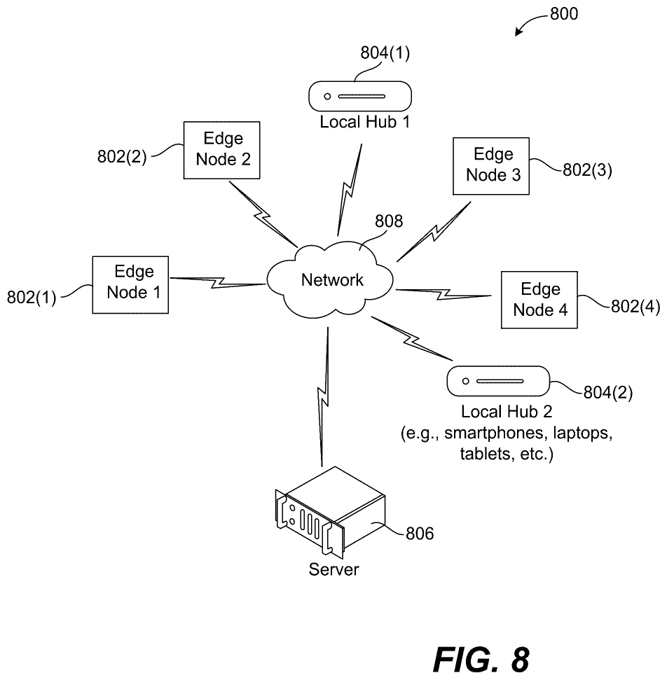

FIG. 8 is a schematic diagram depicting an exemplary edge computing system 800. For illustrative purposes, and not in a limiting sense, system 800 is shown to represent a simplified architectural topology for an edge computing platform that may be configured to implement one or more of the implementations described herein. In the exemplary implementation depicted in FIG. 8, system 800 includes a plurality of edge nodes 802, a plurality of local hubs 804, a server 806, and an electronic communication network 808 (e.g., the Internet) in operable communication with each of edge nodes 802, local hubs 804, and server 806.

In exemplary operation of system 800, an edge node 802 may capture and process data proximate sensing targets (not shown in FIG. 8). In an exemplary scenario, a particular edge node 802 may run a causal interactive task model (e.g., causal interactive task model 106, FIG. 1), whereas a different edge node 802 may run an effect recognizer (e.g., effect recognizer 206, FIG. 2). In this exemplary scenario, each respective edge node 802 may send its respective raw sensor data, with relevant timestamps and detection results, through the electronic communication network 808 to one or both of a server 806 and a particular local hub 804. In an exemplary implementation, one or both of an ITM (e.g., ITM 204, FIG. 2) and a causal state mapping module (e.g., causal state mapping module 202, FIG. 2) for a group of causal events may reside within the particular local hub 804.

In a more specific example, a pair of causal events may reside on a first edge node 802(1) and a second edge node 802(2), and first edge node 802(1) is configured run a causal interactive task model and second edge node 802(2) is configured to run the corresponding edge recognizer. According to this example, when the edge recognizer of second edge node 802(2) detects a state transition, a trigger signal from second edge node 802(2) may be sent to a first local hub 804(1). In this exemplary scenario, first local hub 804(1) is advantageously configured to then self-label the sensor stream of first edge node 802(1). In an implementation, the self-labeled data from first local hub 804(1) is stored at first edge node 802(1), thereby enabling first edge node 802(1) to advantageously fine-tune the causal interactive task model using the self-labeled dataset. In some implementations, the self-labeled data may be stored at the local hub. In an exemplary implementation, first local hub 804(1) is further configured to perform fine-tuning of the causal interactive task model using the self-labeled dataset. In at least one implementation, first local hub 804(1) is further configured to orchestrate available and/or spare nodes 802 in the edge computing platform to perform fine-tuning of the causal interactive task model using a federated learning strategy.

In some exemplary scenarios of system 800, the particular causal relationship used for self-labeling may involve multiple variables for the relevant causes and effects. In this case, one or more causal interactive task models and/or one effect recognizers may be implemented by a single edge node 802, or among multiple edge nodes 802 connected through electronic communication network 808. Alternatively, or additionally, for such exemplary scenarios involving multiple cause and/or effect variables, one or more of local hubs 804 may be configured to receive detection results of each such variable from a corresponding edge node 802. In this case, the particular local hub 804 may be further configured to run a group of causal interactive task models or effect recognizers to fuse the collected information thereof, such that the relevant cause and/or effect states may be recognized.

In an exemplary implementation, a local hub 804 may be configured to utilize detected effect states to self-label one or more cause data streams. In some implementations, the self-labeled data of each relevant cause event may be stored at individual edge nodes 802, and the respective local hub 804 may then orchestrate the relevant edge nodes 802 to train an individual causal interactive task model at that individual edge node using the corresponding self-labeled cause variable in a federated learning way. In at least one implementation, a group of self-labeled datasets, including every relevant cause event as a data feature, may be stored at a local hub 804, and this local hub may thus be still further configured to perform fine-tuning of the group of causal interactive task models (e.g., at respective edge nodes 802).

In an implementation, server 806 may be configured as a server node, and thereby perform one or more post-deployment functions in a manner similar to those performed by a local hub 804, i.e., depending on the network topology when many edge nodes 802 are connected (e.g., and also depending on the arrangement of computing power and throughout the topology). In this exemplary implementation, server 806 may be further configured to run a CMM, and additionally interface with users to perform one or more pre-deployment functions.

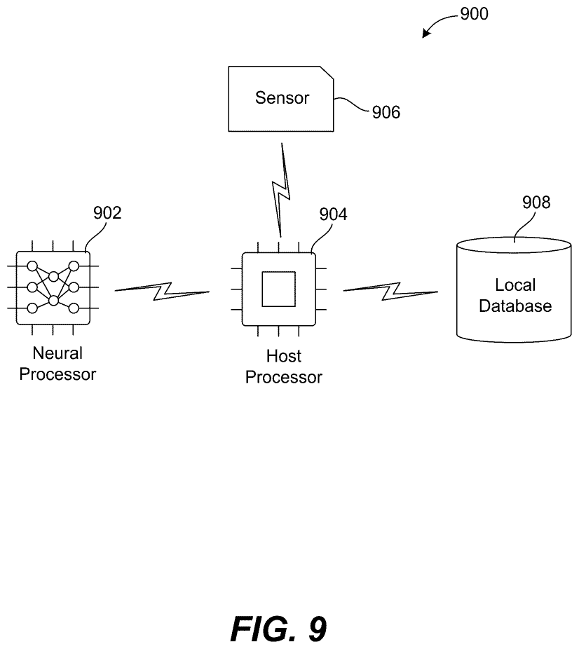

FIG. 9 is a schematic illustration depicting an exemplary edge node architecture 900. Architecture 900 represents an exemplary logical topology for an edge node (e.g., edge node 802, FIG. 8) used to collect and process data (e.g., by a neural network accelerator). In the exemplary implementation depicted in FIG. 9, architecture 900 includes a neural processor 902, a host processor 904, at least one sensor 906, and a local database 908 (e.g., a memory device). As described above with respect to FIG. 8, an edge node may include any of a number of different computing devices and/or systems.

In exemplary operation of architecture 900, sensor 906 is configured to capture signals of physical properties of a target object or environment (not shown in a FIG. 9) as broad data, and then send this captured data to host processor 904. Sensor 906 may, for example, be configured to capture one or more of visual images, images at different optical frequencies, acoustic signals, moisture data, temperature data, electrical currents and/or voltages, accelerations and/or angular velocities, magnetic fields, etc. Host processor may be accordingly configured to receive a sensor signal from sensor 906 (e.g., captured data), and may be further configured to apply pre-processing to such received sensor signals. Host processor is in operable communication with neural processor 902 and is further configured to transmit one or both of the pre-processed signals and the received sensor signals to neural processor 902 for computational model processing.

In an exemplary implementation, neural processor 902 is configured to both receive sensor signals from host processor 904, and also to run an ML model to process and classify its received sensor signals for recognizing one or more object states of the sensed target object. In an alternative implementation, host processor 904 may itself be configured to run computational models to process and classify its own received sensor signals to recognize the objects state(s). In at least one implementation, host processor 904 is configured to receive detection results from neural processor 902. In an exemplary implementation, host processor 904 is configured to transmit timestamped sensor data and detection results to local hubs (e.g., local hubs 804, FIG. 8) through network communication (e.g., electronic communication network, FIG. 8). In some implementations, host processor 904 is further configured to additionally transmit the timestamped sensor data and detection results to local database 908 for data storage.

In an exemplary implementation, host processor 904 is configured to receive signals from a local hub to fine-tune the computational model run by host processor 904, or alternatively, executed by neural processor 902. In an implementation, derived model parameters may be shared by host processor 904 to one or more other local hubs, servers, or edge nodes. In the exemplary implementation, host processor 904 may be further configured to both receive updated parameters of the computational model and update the parameters thereof.

The particular platforms and nodes described above with respect to FIGS. 8-9 are provided by way of illustration and are not intended to be limiting. The person of ordinary skill in the art will understand that a variety of platforms and devices, including without limitation, a variety of edge computing platforms and edge nodes, may be configured to execute one or more of the present innovative systems and methods without departing from the scope herein.

### Automatic Data Annotation and Self-Learning Processes

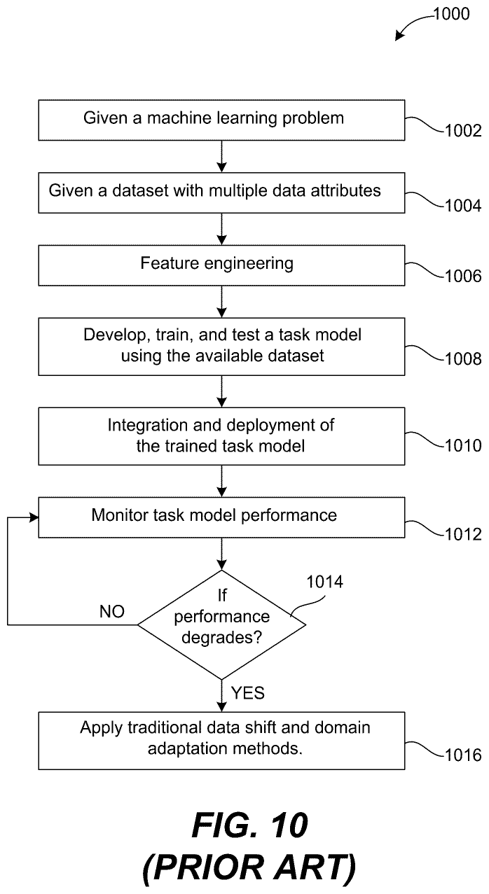

FIG. 10 is a flow diagram depicting a conventional ML process 1000. In the implementation depicted in FIG. 10, conventional ML process 1000 begins at step 1002, in which an ML problem is provided or formulated for a particular application scenario. In step 1004, based on the formatted ML problem, a dataset (i.e., including multiple data attributes) is made available for the particular ML problem. In step 1006, featured engineering techniques, such as data augmentation, are applied on the dataset to select and enhance data features for data preprocessing. In step 1008, an ML task model is developed, trained, and tested using the available dataset. In step 1010, the task model is integrated into a software system and deployed to an application environment. In step 1012, performance of the deployed task model is monitored (i.e., tracked by a monitoring system). In step 1014, conventional ML process 1000 determines whether the performance of the deployed task model meets accuracy requirements. If the task model meets accuracy requirements, conventional ML process 1000 proceeds to step 1016, in which conventional domain and data shift adaptation techniques for the task models are conducted. If, however, in step 1014, it is determined that the performance of the deployed task model has degraded (i.e., below a defined threshold), conventional ML process 1000 instead returns to step 1012, the task model is retrained until the performance degradation (e.g., from data distribution shifts) is sufficiently mitigated.

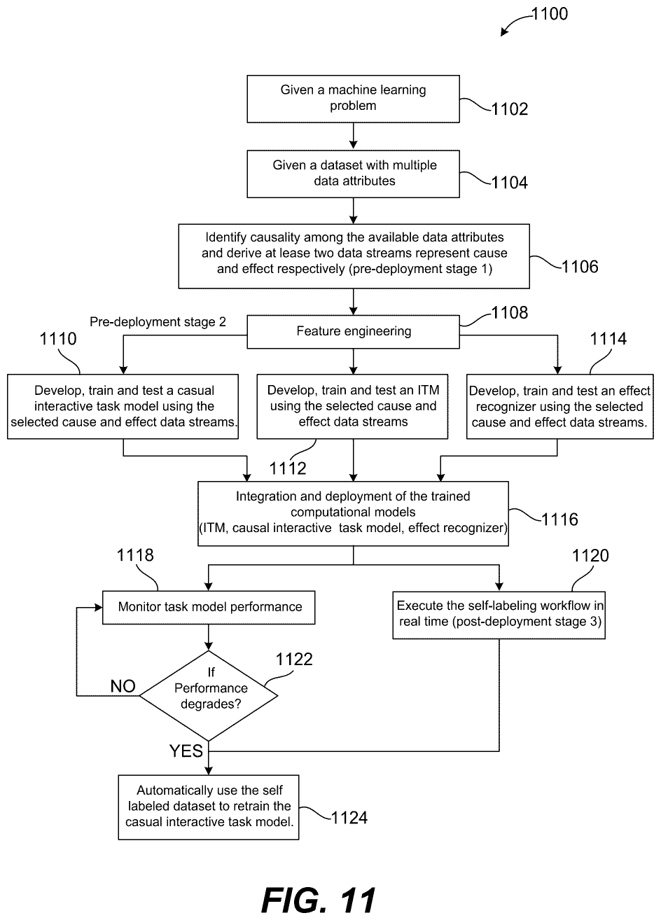

FIG. 11 is a flow diagram depicting an exemplary ML process 1100. In an exemplary implementation, ML process 1100 may be implemented by one or more processors or processing modules of the systems and methods described herein. Additionally, unless described otherwise to the contrary, some steps of ML process 1100 may be performed in a different order than described herein, and/or one or more steps of ML process 1100 may be performed simultaneously. Additionally, ML process 1100 may include more or fewer steps without departing from the scope herein.

In some aspects, ML process 1100 may be similar to one or more functional steps of conventional ML process 1000, FIG. 10, in some aspects, and when considered at a high level, ML process 1100 may include some similar structure, processing steps, and/or functionalities when described as using similar labels analogous to one or more steps described above with respect to conventional ML process 1000. ML process 1100 differs though, from conventional process 1000, in that ML process 1100 includes both first- and second-stage pre-deployment functionality that is not contemplated by conventional techniques, which innovative functionality serves to enable an automatic data labeling and self-learning processing during pre-deployment, as described above in greater detail.

For example, ML process 1100 begins at step 1102, in which an ML problem is provided or formulated for a particular application scenario (e.g., similar to step 1002, FIG. 10). In step 1104, based on the formatted ML problem, a dataset (i.e., including multiple data attributes) is made available for the particular ML problem (e.g., similar to step 1004, FIG. 10). Step 1106, however, significantly differs from the conventional functionality of conventional ML process 1000, FIG. 10. For example, in step 1106, a first pre-deployment stage is executed after completion of step 1104. In an exemplary implementation of step 1106, the first pre-deployment stage is configured to identify causality among the available data attributes, and then derive at least two data streams representative of cause and effect, respectively (e.g., data streams 108, 110, FIG. 1). In step 1108, featured engineering techniques are applied to the two data streams, (e.g., in a manner similar to step 1006 of conventional ML process 1000, FIG. 10).

Steps 1110, 1112, and 1114 depart and further from conventional ML process 1000, FIG. 10. For example, whereas conventional ML process 1000, after the featured engineering is applied, develops trains and tests a single task model (e.g., step 1008, FIG. 10), ML process 1100 instead implements a second pre-deployment stage that may be substituted for step 1008, FIG. 10. More particularly, this second pre-deployment stage of ML process 1100 includes three separate steps for developing, training, and testing using selected cause and effect data streams (e.g., described above): (1) in step 1110, a causal interactive task model (e.g., causal interactive task model 106, FIG. 1); (2) in step 1112, an ITM (e.g., ITM, 204 FIG. 2) is developed, trained, and tested using the selected cause and effect data streams; and (3) in step 1114, an effect recognizer (e.g., effect recognizer 206, FIG. 2) is developed, trained, and tested using the selected data streams. In an exemplary implementation, all of steps 1110, 1112, 1114 are executed in parallel; in at least one implementation, one or all of steps 1110, 1112, 1114 are executed simultaneously, or at relatively near simultaneity.

In step 1116, all three of the trained computational models (i.e., causal interactive task model from step 1110, ITM model from step 1112, and effect recognizer from step 1114 are together aggregated for integration and deployment to one or more of the particular application environments described above, and further herein. In step 1118, performance of the deployed aggregated task models is monitored (i.e., tracked by a monitoring system). In an implementation of step 1118, performance monitoring according to conventional techniques (e.g., similar to that implemented for step 1012, FIG. 10). Further different, however, from conventional ML process 1000, ML process 1100 is further configured to implement, in step 1120, a post-deployment stage. In an exemplary implementation of step 1120, ML process 1100 is further configured to execute a self-labeling workflow in real-time. In at least one implementation, step 1120 may be executed in parallel with step 1118, or simultaneously therewith.

Step 1122 is a decision step, and substantially similar to step 1014, FIG. 10. For example, in step 1122, ML process 1100 is also configured to determine whether the performance of the deployed task model/computation models meets accuracy requirements. If, in step 1122, it is determined that performance has degraded, process 1100 will return to step 1118 for one or more iterations, until process 1100 is able to determine that the task/computational models the desired accuracy requirements, or until a predetermined iteration value threshold has been reached. Once ML process 1100 is able to determine that the accuracy requirements have been met, ML process 1100 proceeds to step 1124, in which the self-labeled data set may be used to retrain the causal interactive task model (e.g., based on one or both of successful monitoring of the task/computational models from step 1122, and the execution of the self-labeling workflow executed in real-time at step 1120).

The person of ordinary skill in the art may thus see, from a simple comparison of the present ML process 1100 against that of conventional ML process 1100, FIG. 10, that several key innovations are provided according to the present systems and methods, and which represent significant improvements over the conventional techniques.

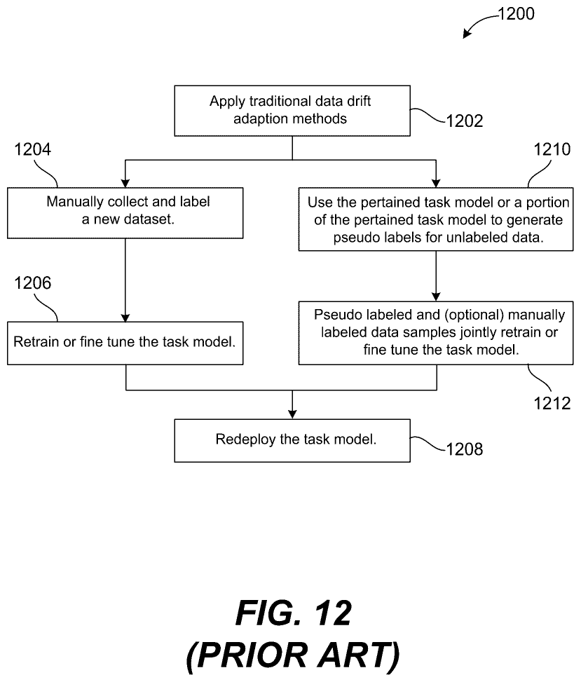

FIG. 12 is a flow diagram depicting a conventional post-deployment adaptation process 1200. In the implementation depicted in FIG. 12, conventional process 1200 illustrates a post-deployment domain adaptation technique for conventional task models, and begins at step 1202, in which conventional data drift adaptation techniques are applied to an initial dataset. In step 1204, a new dataset is manually collected and annotated from shifted domains, such as the new data set may be labeled. In step 1206, the conventional task model is retrained or fine-tuned using the manually collected and labeled new dataset. After retraining/fine-tuning, conventional post-deployment adaptation process 1200 proceeds to step 1208, in which the particular task model is readied for redeployment.

Referring back to step 1202, additional steps are also executed in parallel, or in near simultaneity, with steps 1204 and 1206. For example, in step 1210, post-deployment adaptation process 1200 may utilize a pre-trained task model, or portion thereof, to generate pseudo labels for unlabeled data. In step 1212, either or both of data containing pseudo labels and manually labeled data samples may be utilized to jointly retrain or fine-tune the pre-trained task model. Upon sufficient retraining/fine-tuning of the task model, post-deployment adaptation process 1200 additionally proceeds to step 1208 from the parallel track of steps 1210 and 1212, and re-deploys the task model based on the retraining/fine-tuning from the parallel tracks.

Thus, according to this conventional technique, new datasets are manually collected and annotated from shifted domains along one track, and the newly collected/labeled data is then used to retrain task models for domain adaptation, after which the particular conventional task model may be redeployed. Along the other track, pretrained task models/task model portions are used to generate pseudo labels for unlabeled data samples, resulting in a new dataset containing pseudo-labeled data samples and, optionally, a portion of manually labeled samples to retrain the task model for redeployment.

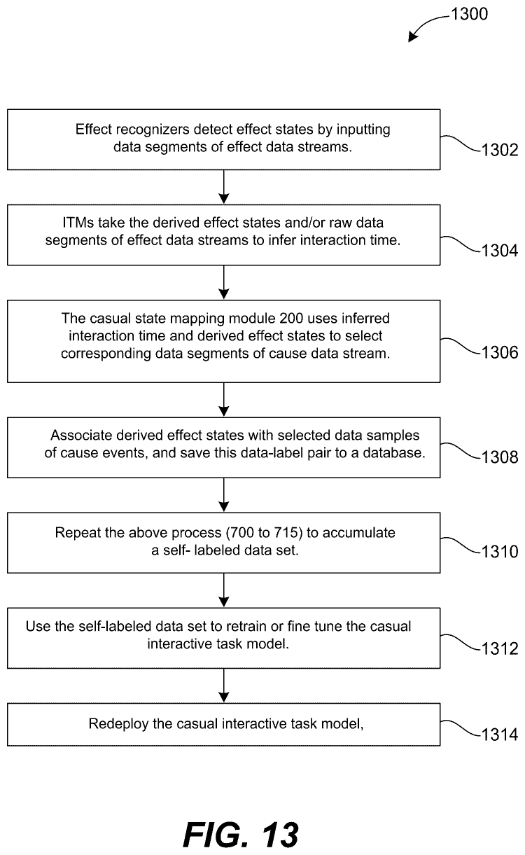

As described further below with respect to FIG. 13, these conventional techniques may be significantly improved through the implementation, or the integration therein, of one or more of the present systems and methods for automatic data labeling and self-learning in the post-deployment scenario using causal interactive task models.

FIG. 13 is a flow diagram depicting an exemplary post-deployment adaptation process 1300. In an exemplary implementation, post-deployment adaptation process 1300 may be implemented by one or more processors or processing modules of the systems and methods described herein, and particularly with respect to a self-labeling system (e.g., self-labeling subsystem 104, FIG. 1). Unless described otherwise to the contrary, some steps of post-deployment adaptation process 1300 may be performed in a different order than described herein, and/or one or more steps of post-deployment adaptation process 1300 may be performed simultaneously. Additionally, post-deployment adaptation process 1300 may include more or fewer steps without departing from the scope herein.

In an implementation, post-deployment adaptation process 1300 is configured to facilitate post-deployment automatic data labeling and self-learning in a causal interactive task model (e.g., causal interactive task model 106, at FIG. 1). Post-deployment adaptation process 1300 may, for example, be executed independently of, after, or simultaneously with, post-deployment process 700, FIG. 7, and post-deployment adaptation process 1300 may contain one or more functional features similar to respective functional self-labeling features of post-deployment process 700.

In the exemplary implementation depicted in FIG. 13, post-deployment adaptation process 1300 begins at step 1302, in which one or more effect recognizers (e.g., effect recognizer 206, FIG. 2) detect effect states by inputting data segments of effect data streams. In step 1304, respective ITMs (e.g., ITM 204, FIG. 2) infer the interaction time(s) using the derived effect states and/or raw data segments of effect data streams. In step 1306, the CMM (e.g., CMM 102, FIG. 1) selects corresponding data segments (e.g., data 114, FIG. 1) of the cause data stream (e.g., first data stream 108, FIG. 1) based on the inferred interaction time(s) and derived effect states. In step 1308, post-deployment adaptation process 1300 associates the derived effect states with the selected data samples of cause events, and then saves the resulting data-label pairs (e.g., x|y pair, FIG. 1) to a database or associated memory. In step 1310, post-deployment adaptation process 1300 repeats/iterates steps 1302 through 1308 a plurality of times until either of a predetermined iteration threshold is reached or a self-labeled dataset of sufficient size is accumulated.

In step 1312, post-deployment adaptation process 1300 utilizes the accumulated self-labeled dataset obtained in step 1310 to retrain or fine-tune the causal interactive task model (e.g., causal interactive task model 106, at FIG. 1). In step 1314, post-deployment adaptation process 1300 is configured to redeploy the retrained/fine-tuned causal interactive task model. According to these advantageous automatic data labeling and self-learning techniques, the person of ordinary skill in the art may see that systems and methods according to post-deployment adaptation process 1300 demonstrate the significant self-labeling advantages that may be achieved for causal interactive task models, namely, in comparison with the conventional task model training techniques described above with respect to FIG. 12.

### Methodology And Theory

According to the innovative systems and methods described herein, data annotation may, at a high level, include (a) selection of data samples to be labeled, and (b) generation of labels for the selected data samples. In the case of labeling image datasets though, to select data samples, since many images, for example, may be pre-selected. Nevertheless, in the case where a censor may be a camera, streaming data may be captured in dynamic environments. Accordingly, for this camera scenario, both data sample-selection and label-generation may be expected for data annotation purposes. The present implementations therefore realize still further advantages over conventional techniques, in that both data annotation steps (i.e., data sample-selection and label-generation) may be fully automated without requiring human intervention.

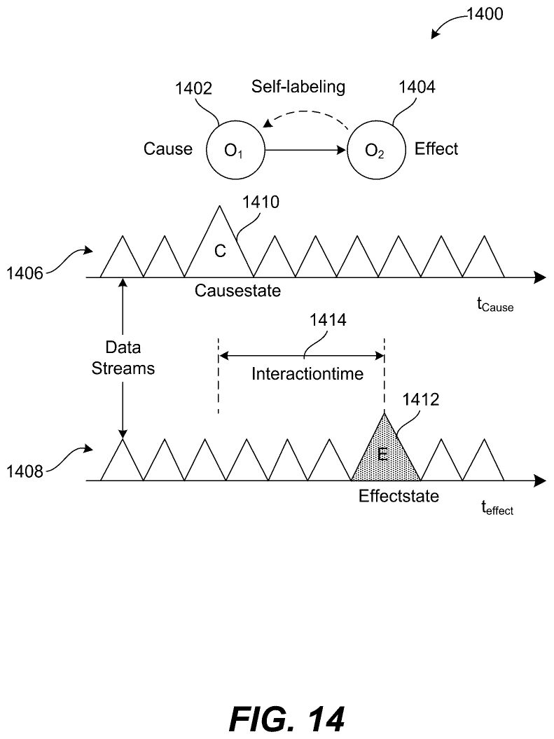

FIG. 14 is a schematic diagram depicting an exemplary operating principle 1400 for an object interaction scenario. In the exemplary implementation depicted in FIG. 14, operating principle 1400 illustrates a causality-based self-labeling technique that may be implemented with respect to a first cause object 1402 (o₁) and a second effect object 1404 (o₂) in consideration of the time lag between the occurrence of times of the respective cause and effect. In this example, a first data stream 1406 indicates data that may be received regarding first cause object 1402 (e.g., similar to first data stream 108, FIG. 1), and a second data stream 1408 indicates data that may be received regarding the second effect object 1404 (e.g., similar to the second data stream 110, FIG. 1). Further to this example, a cause state 1410 is detected for first cause object 1402 along first data stream 1406, and a corresponding effect state 1412 is detected for second effect object 1404 along second data stream 1408. An interaction time 1414 represents the time interval, lag, delay that occurs between detection of cause state 1410 and its corresponding effect state 1412.

Operating principle is therefore of particular utility with respect to the present self-labeling systems and methods that facilitate ML tasks. In this regard, such ML tasks may include pattern recognition tasks accomplished by supervised ML models. For such a pattern recognition tasks, it is advantageous to enable the present self-labeling techniques to scenarios involving at least two participating objects (e.g., first cause object 1402 and second effect object 1404) interacting, where one such object (e.g., first cause object 1402) induces effects on another object (e.g., second effect object 1404). For ease of explanation, the exemplary scenario depicted in FIG. 14 shows the causal relationship between objects o₁ and o₂ to be unidirectional and known a priori. The person of ordinary skill in the art will understand that this example is provided by way of illustration, and not in a limiting sense. The present techniques may be implemented with respect to multi-directional and/or unknown causal relationships without departing from the scope herein.

For the exemplary implementation depicted in FIG. 14, the ML task for operating principle 1400 may include training a model that digests the cause data related to o₁ (e.g., first data stream 1406) to infer the effect on o₂. Accordingly, for this example, the two data streams of sensor data 1406 and 1408 (i.e., cause and effect, respectively) are available during model deployment to enable the causal relationship therebetween to be viewed from an ML perspective. Similar to the exemplary implementation depicted in FIG. 1, the cause data from first data stream 1406 may therefore be utilized as input features x, and the corresponding effect data from second data stream 1408 may therefore be utilized as the output labels y, and in consideration of interaction time 1414 between corresponding cause and effect states 1410, 1412 to enable accurate pairing of the respective x|y data.

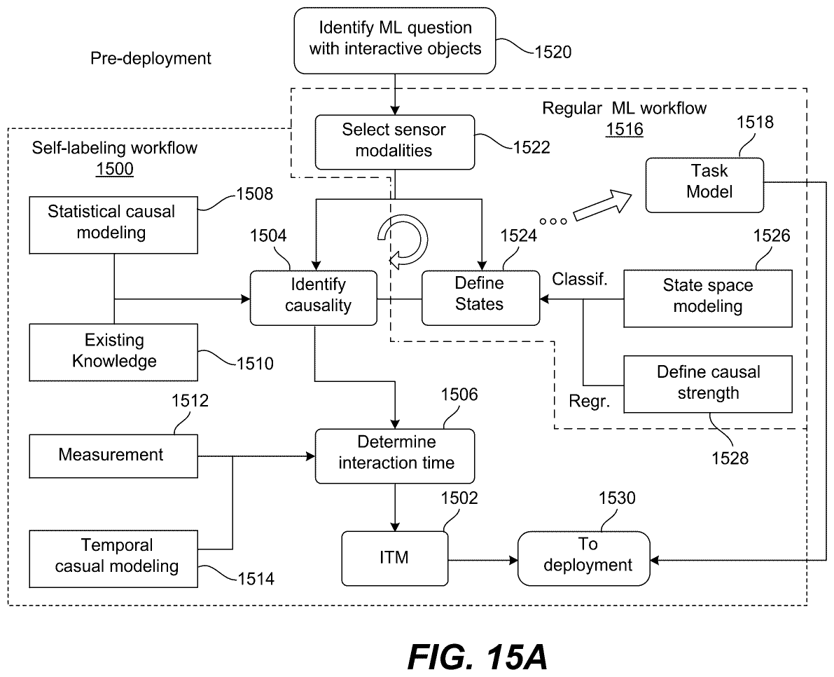

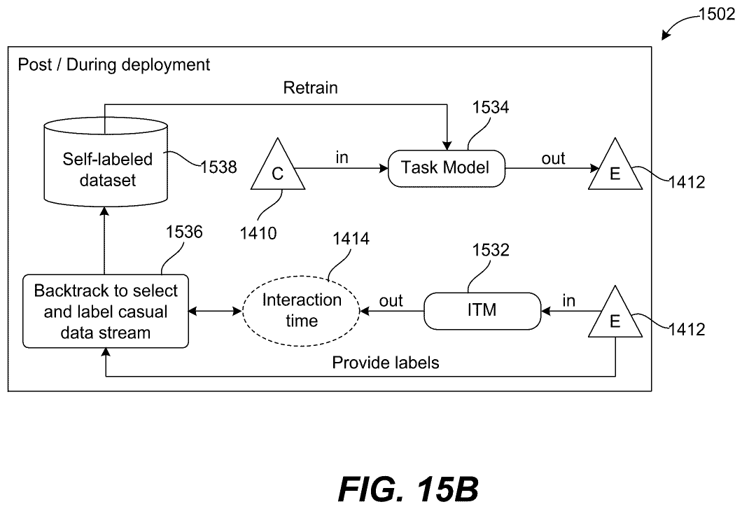

FIG. 15A is a flow diagram depicting an exemplary pre-deployment self-labeling workflow 1500. In the exemplary implementation depicted in FIG. 15A, pre-deployment self-labeling workflow 1500 is implemented using an ITM 1502 (e.g., ITM 204, FIG. 2), a causality identification module 1504 and an interaction time determination module 1506. In an implementation, causality identification module 1504 may implement one or more functional steps of the first stage pre-deployment process 500, FIG. 5, and may further utilize one or more statistical causal models 1508 (e.g., using causal model generator 308, FIG. 3) and/or an existing knowledge database 1510 (e.g., structured causality KG database 302, FIG. 3) to identify causal events. Interaction time determination unit 1506 may similarly implement one or more functional steps of second stage pre-deployment process 600, FIG. 6, and may further utilize measurement information 1512 and/or one or more temporal causal models 1514 to determine the interaction time (e.g., interaction time 1414, FIG. 14).

In an implementation, pre-deployment self-labeling workflow 1500 may include some functional steps of, and/or be integrated with, a conventional ML workflow 1516 (e.g., conventional ML process 1000, FIG. 10. For example, conventional ML workflow 1516 may include a task model 1518 developed from an identified ML question 1520 regarding interactive objects, sensor modalities 1522 selected for identified ML question 1520, and state definitions 1524 obtained based on selected sensor modalities 1522. State definitions 1524 may, for example, be further obtained based on at least one of a classification mode 1526 to model the state space, and a regression mode 1528 to define the causal strength, as described above.

In an exemplary implementation, pre-deployment self-labeling workflow 1500 may include some or all of the functionality of conventional ML workflow 1516. The person of ordinary skill in the art will understand that the separate delineation depicted in FIG. 15 between the two workflows is provided by way of illustration, and not in a limiting sense, in order to emphasize the novel and advantageous additional functionality provided by the present systems and methods. For example, causality identification module 1504 may be configured to additionally utilize selected sensor modalities 1522 and state definitions 1524 in the causality identification thereof, and also for self-labeling retraining and fine-tuning of task model 1518. In the exemplary implementation, upon completion of pre-deployment self-labeling workflow 1500, a trained/detuned task model 1518 is determined, by ITM 1502, to be ready for deployment to a deployment application 1530.

According to pre-deployment self-labeling workflow 1500, the interaction time (e.g., interaction time 1414, FIG. 14) between the respective data streams (e.g., data streams 1406, 1408, FIG. 14) of two objects (e.g., objects 1402, 1404, FIG. 14) may be identified, for example, by interaction time determination module 1506 before model deployment of task model 1518 to deployment application 1530. Accordingly, the causal relationships between the objects may be advantageously derived, for example, by causality identification module 1504, from existing knowledge (e.g., from existing knowledge database 1510) or causal modeling (e.g., from statistical causal models 1508). In this example, ITM 1502 advantageously serves as an auxiliary ITM to infer the interaction time using effect data. In an implementation, ITM 1502 may be trained using supervised or unsupervised methods, and may further include one or more of an ML, a statistical, a mathematical, or a physical model.

In an implementation, in the case of two data models being utilized, a primary functional ML model may be designated as the causal interactive task model (e.g., causal interactive task model 106, FIG. 1), and the secondary data model may be designated as ITM 1502. The person of ordinary skill in the art will appreciate that such designations are for illustrative purposes and are not intended to be limiting. In at least one implementation, the causal interactive task model may be pretrained concurrently, or in parallel, with the training of ITM 1502 using the self-labeled data.

FIG. 15B is a flow diagram depicting an exemplary mid-deployment self-labeling workflow 1502. In the exemplary implementation depicted in FIG. 15B, for ease of explanation, mid-deployment self-labeling workflow 1502 is depicted with respect to the exemplary two-object interaction scenario depicted in FIG. 14. In this example, mid-deployment self-labeling workflow 1502 is implemented with respect to an ITM 1532 (e.g., similar to ITM 204, FIG. 2, ITM 1502, FIG. 15A) and a task model 1534 (e.g., causal interactive task model 106, FIG. 1). The person of ordinary skill in the art will further understand that mid-deployment self-labeling workflow 1502 may be implemented during deployment to deployment application 1530, FIG. 15A, or post-deployment.

In exemplary operation of mid-deployment self-labeling workflow 1502, during deployment, ITM 1532 is configured to infer interaction time 1414 between cause state 1410 and effect state 1412. The effect data (e.g., data 116, FIG. 1) corresponding to second effect object 1404 may then be processed to generate the respective labels for the cause data (e.g., data 114, FIG. 1), as described above. An indexing unit 1536 is configured to receive the generated labels from effect object 1404, and then, based on interaction time 1414 inferred by ITM 1532, backtrack from the timestamp of the effect data, i.e., at effect state 1412, the inferred interaction time period to select the corresponding segment of cause data stream 1406 to be associated with the received label(s). Using this backtracked timestamp, a dataset collection unit 1538 may be configured to collect multiple self-labeled data-label pairs according to one or more of the techniques described above, and then retrain task model 1534 to improve the performance thereof during, or post-, deployment.

For the exemplary implementation depicted in FIG. 15B, the following parameters were considered for the illustrative self-labeling implementation: (a) a scenario having object interactions; (b) a known or derived causal relationship during the object interactions; (c) an interaction time between the respective cause and effect that is dependent on the effect data of the effect object (e.g., for ITM viability); and (d) effect data being relatively easier to process than cause data. The person of ordinary skill in the art will understand that it is not necessary, for implementation of the present self-labeling systems and methods, that the effect data be easier to process than the cause data. For illustrative purposes, this parameter was utilized to emphasize a case it may be more desirable to implement self-labeling from the perspective of the observer of the effect (e.g., effective recognizer 206, FIG. 2) rather than from the cause the respective.

According to the self-labeling systems and methods described above with respect to FIGS. 15A-B, several advantages over conventional techniques are achieved. For example, because the present techniques may be semi-supervised, the deployment thereof realizes a considerably reduction to required manual annotation efforts. Additionally, after deployment of the causal interactive task model, the present systems and methods achieve significantly improved continual and adaptive learning results that correct the data distribution drift problems arising using only conventional techniques. Accordingly, the present causal interactive task model is further advantageously configured to dynamically evolve to enable the automatic capture and labeling of data from various deployment environments, which therefore greatly increases the real-world performance of ML applications. Furthermore, the present systems and methods, considering the interaction time between cause and effect of events, are advantageously enabled to utilize cause data to more accurately forecast effects for preemptive decision making.

### Proof by Dynamic Systems

As self-labeling aids in modeling time-evolving systems, the present implementations may use dynamical system (DS) to demonstrate how the present self-labeling techniques consistently outperform conventional self-supervised learning (SSL) techniques that rely on distribution smoothness to infer labels in resolving concept drift. DS may use differential or difference equations to describe system states evolving with time, and many real-world systems may be modeled as DS when the system states thereof change with time. For example, interaction of two DS may be modeled as coupled differential equations. A simplified case of two interacted 1-d DS may thus be represented as follows:

$$\dot{x} = f ( x ) ; and \qquad ( 1 )$$

$$\dot{y} = y + h ( x ) , \qquad ( 2 )$$

where x and y represent scalar system states and serve as cause and effect, respectively as described above. For Eqs. (1) and (2), ƒ(·) defines a vector field, and h(·) represents the coupling function.

In the case where an unknown perturbation occurs in the system x, the cause side will show a corresponding disturbance, thereby changing the cause-effect relationship. In such cases, the two systems may be represented according to:

$$\frac{d x ( t )}{d t} = f ( x ( t ) ) + d ( x ( t ) ) ; and \qquad ( 3 )$$

$$\frac{d y ( t )}{d t} = y ( t ) + h ( x ( t ) ) , \qquad ( 4 )$$

where d(x) represents the perturbation. In this example, perturbation may represent a concept drift in ML, rather than a noise in control theory. For this example, the perturbation is regarded as an unknown factor that changes the learned relationship between the respective inputs and outputs. For the purposes of this disclosure, perturbation is considered to be related to the system state, rather than an independent value (as a function of t). This consideration emphasizes the advantageous according to the present systems and methods that consider perturbation as a factor influencing the input-output relation of an ML model after training, rather than real noise. The d (t) case is discussed further below.

In an exemplary scenario, system x and y may have initial and final values represented by x₁, x₂, y₁, y₂, respectively, where x₁, y₁ are the initial values and x₂, y₂ are the final values. Both systems will possibly propagate from initial to final values over the interaction time defined and utilized herein. For this exemplary scenario, x₁ represents the cause state and y₂ represents the effect state in an x-y interaction between two respective cause-event objects. The present systems and methods thus implement improved ML functionality to enable a mapping between cause x₁ and effect y₂ (e.g., causal state mapping module 202, FIG. 2). Using such mapping techniques, the present self-labeling systems and methods may be advantageously implemented to derive a self-labeled x₁-y₂ relation, under perturbation, in comparison with conventional SSL and fully-supervised techniques.

As described herein, the derivation of the self-labeled (SLB) x₁-y₂ relation may include, without limitation, one or more substeps for: (a) without perturbation, deriving the relation between the interaction time t_{if} and the effect state y₂ used for inferring interaction time from effect state; (b) under perturbation, using the given effect y₂ to (i) infer the interaction time, and (ii) select the associated x₁ state as the self-labeled value x_{slb}; and (c) under perturbation, deriving the relation between x_{slb} and y₂. In this exemplary scenario, these substeps are consistent with the functional steps described above with respect to FIGS. 15A-B, but are simplified for this exemplary illustration. From the relation between y₂ and x_{slb}, the relation between t_{if} and y₂ may be derived from the unperturbed scenario, and the relation between t_{if} and x_{slb} may be derived from the perturbed scenario, thereby enabling canceling out of the t_{if} value.

In the unperturbed scenario, the interaction time t_{if} may be inferred using the effect y₂. Using this inferred interaction time, Eqs. (1) and (2) may be solved using initial values to derive the following:

$$x ( t ) = {A}^{- 1} ( t + {Ax}_{1} ) ; and \qquad ( 5 )$$

$$y ( t ) = {e}^{t} {\int }_{0}^{t} {e}^{- τ} \cdot h ( {A}^{- 1} ( τ + {A}_{{x}_{1}} ) ) d τ + {e}^{t} {y}_{1} , \qquad ( 6 )$$

where

$$A ( x ) = {\int }^{x} \frac{1}{f ( ξ )} d ξ$$

(e.g., a constant is not needed for this integral solution), and is locally invertible on [x₁, x₂]. In this example, subscript Aₓ_{₁} represents A(x₁) and, for Eq. (6), x₁ may be substituted with x₂ since, during inference, x₁ may be unknown, but x₂ may effectively serve as a controlling parameter. Additionally, by defining y(t)=y₂, the relation between t_{if} and y₂ may be utilized to infer the interaction time according to:

$${y}_{2} = {e}^{{t}_{if}} {\int }_{0}^{{t}_{if}} {e}^{- τ} \cdot h ( {A}^{- 1} ( τ + {A}_{{x}_{2}} - {t}_{if} ) ) d τ + {e}^{{t}_{if}} {y}_{1} . \qquad ( 7 )$$

In the case of perturbation, according to Eq. (7), a given y₂ value may thus be used to infer t_{if}. From this inferred interaction time, Eqs. (3) and (4) may be solved to derive the following evolution function(s):

$$x ( t ) = {B}^{- 1} ( t + {B}_{{x}_{1}} ) ; and \qquad ( 8 )$$

$$y ( t ) = {e}^{t} {\int }_{0}^{t} {e}^{- τ} \cdot h ( {B}^{- 1} ( τ + {B}_{{x}_{1}} ) ) d τ + {e}^{t} {y}_{1} , \qquad ( 9 )$$

where

$$B ( x ) = {\int }^{x} \frac{1}{f ( ξ ) + d ( ξ )} d ξ ,$$

and is locally invertible on [x₁, x₂].

From Eq. (8), the true interaction time may then be derived for the evolution from x₁ to x₂ under perturbation, namely, tₜᵣᵤₑ=Bₓ_{₂}−Bₓ_{₁}. Accordingly, given values for t_{if} and tₜᵣᵤₑ, the SLB value will conform to x_{slb}=B⁻¹(tₜᵣᵤₑ−t_{if}+Bₓ_{₁}). The relation between t_{if} and x_{slb} may then be derived according to:

$${t}_{if} = {B}_{{x}_{2}} - {B}_{{x}_{slb}} . \qquad ( 10 )$$

Using Eq. (10) the inferred value for t_{if} may be substituted into Eq. (7) to derive the relation between y₂ and x_{slb}, under perturbation, according to:

$${y}_{2 slb} = {e}^{{B}_{{x}_{2}} - {B}_{{x}_{slb}}} ( {\int }_{0}^{{B}_{{x}_{2}} - {B}_{{x}_{slb}}} {e}^{- τ} \cdot h ( {A}^{- 1} ( τ + {A}_{{x}_{2}} - {B}_{{x}_{2}} + {B}_{{x}_{slb}} ) ) d τ + {y}_{1} ) \qquad ( 11 )$$

Test results according to Eq. (11) were than obtained to compare the input-output relation obtained according to the present self-labeling ML task model, under perturbation, with both conventional SSL and conventional fully-supervised (FS) techniques. For example, most conventional SSL techniques rely on input feature similarity to assign labels. In contrast, according to the present systems and methods, an enhanced SSL technique instead learns the x₁-y₂ relation in an unperturbed environment (e.g., during a supervised stage), and then leverages this obtained knowledge regarding the unperturbed x₁-y₂ relation to advantageously infer pseudo labels for both of the unperturbed and perturbed environments. Conventional FS techniques, on the other hand, typically learn the ground truth relation between perturbed x₁ and y₂ by training on data-label pairs.

From Eqs. (3) and (4), the original and perturbed DS may be directly solved according to:

$${y}_{2 trad} = {e}^{{A}_{{x}_{2}} - {A}_{{x}_{1}}} ( {\int }_{0}^{{A}_{{x}_{2}} - {A}_{{x}_{1}}} {e}^{- τ} \cdot h ( {A}^{- 1} ( τ + {A}_{{x}_{1}} ) ) d τ + {y}_{1} ) ; and \qquad ( 12 )$$

$${y}_{2 fs} = {e}^{{B}_{{x}_{2}} - {B}_{{x}_{1}}} ( {\int }_{0}^{{B}_{{x}_{2}} - {B}_{{x}_{1}}} {e}^{- τ} \cdot h ( {B}^{- 1} ( τ + {B}_{{x}_{1}} ) ) d τ + {y}_{1} ) , \qquad ( 13 )$$

where subscripts ƒₛ and trad represent FS and traditional SSL techniques, respectively. From the solutions obtained from Eqs. 12 and 13, the relative performance of y_{2slb}, y_{2trad}, and y_{2fs} may be evaluated by comparing the respective derivatives therefrom, such as in the case where x₁=x₂, and y_{2slb}=y_{2fs}=y_{2trad}.

Relations of (y_{2slb}, y_{2trad}, y_{2fs}), as well as the corresponding conditions thereof, are shown for the below in Table 1. Table 1 thus illustrates a simplified case where h(*) represents an identity map, and where x and y are deemed positive systems. In Table 1, + and − signs represent positive and negative, respectively. For this simplified illustration, the assumption of positive systems reasonably demonstrates the applicability of the present systems and methods to many real-world applications. As may be seen from a comparison between conditions 1, 2, 5, 6 against conditions 3, 4 in Table 1, the person of ordinary skill in the art will understand that, under particular conditions, the present SLB techniques consistently outperform conventional SSL techniques, and particularly in the case where a perturbation does not reverse the direction of the vector field that drives x. Nevertheless, for negative systems, relations will mirror those relations shown in Table 1.

TABLE 1
Theoretical comparison of the four methods.

| ID | f(x) | d(x) | f(x) + d(x) | Relation |
|---|---|---|---|---|
| 1 | + | + | + | fwd > trad > slb > fs |
| 2 | + | − | + | fs > slb > trad > fwd |
| 3 | + | − | − | trad > fwd > fs > slb |
| 4 | − | + | + | slb > fs > fwd > trad |
| 5 | − | + | − | fwd > trad > slb > fs |
| 6 | − | − | − | fs > slb > trad > fwd |

Alternatively, in the case where h does not represent an identity map, the following properties of h may be considered where h satisfies the conditions: (a) locally h(x)≥0 and h(x) monotonically increases; or (b) locally h(x)≤0 and h(x) monotonically decreases. For either non-identity map condition, the results shown Table 1, below remain valid. For this illustrative example, conditions for h represent local requirements.

As described herein, the present techniques for retrospective self-labeling provide significant advantages over conventional techniques. As described further below, the present systems and methods achieved still further advantages over conventional techniques with respect to the feasibility of using cause data to infer interaction time for self-labeling effect data. As illustrated further below, cause-based self-labeling is further described, and is represented using the subscript fwd.

Thus, in the case where cause data is utilized, the inferred interaction time from x₁ will conform to t_{if}=Aₓ_{₂}−Aₓ_{₁}. Under the perturbation scenario described herein, the present self-labeling systems and methods may infer forwards, beginning from when x₁ is received, until the self-label y₂ is captured from the effect data stream. Accordingly, referring back to Eq. (9), the t may be substituted with t_{if} to derive the following:

$${y}_{2 fwd} = {e}^{{A}_{{x}_{2}} - {A}_{{x}_{1}}} ( {\int }_{0}^{{A}_{{x}_{2}} - {A}_{{x}_{1}}} {e}^{- τ} \cdot h ( {B}^{- 1} ( τ + {B}_{{x}_{1}} ) ) d τ + {y}_{1} ) . \qquad ( 14 )$$

The comparative advantages obtained according to Eq. 14 are also shown in Table 1. The person of ordinary skill in the art will understand that, under conditions 3 and 4 in Table 1, where the relation between SLB and trad is undetermined, use of the fwd variable for cause-based self-labeling significantly outperforms the use of the trad variable.

### Exemplary DS

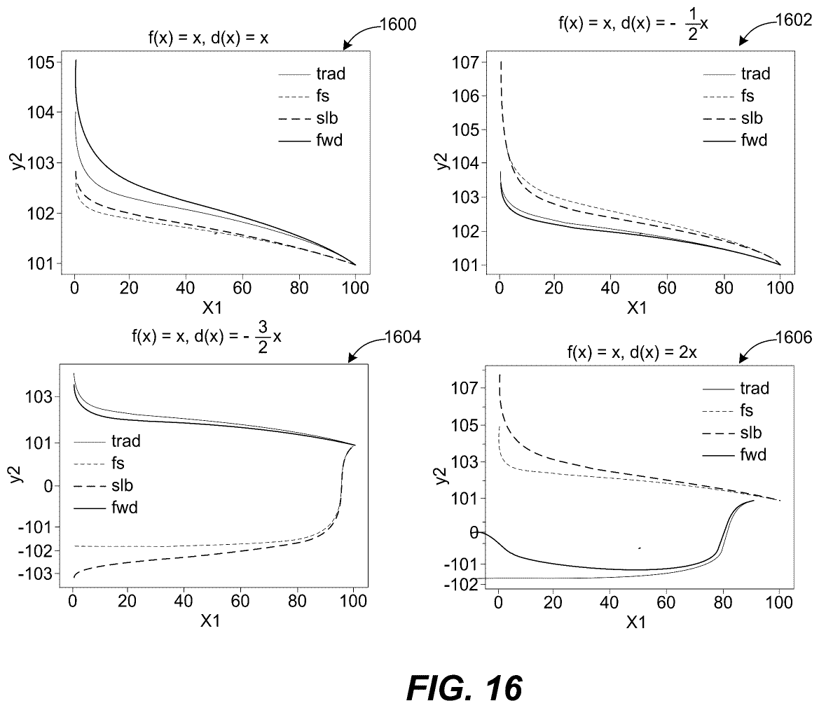

FIG. 16 is a graphical illustration depicting exemplary interacting DS plots 1600, 1602, 1604, 1606. In the exemplary implementations depicted in FIG. 16, DS plots 1600, 1602, 1604, 1606 represent the derived relations between x₁ and y₂ (i.e., in log scale) for two interacting DS according to four of the comparative techniques described above (i.e., trad, FS, SLB, and fwd). More particularly, DS plot 1600 illustrates a comparative graph for conditions ƒ(x)=x and d(x)=x, (e.g., according to one or more of Eqs. (1) through (15)), DS plot 1602 illustrates a comparative graph for conditions ƒ(x)=x and

$$d ( x ) = - \frac{1}{2} x ,$$

DS plot 1604 illustrates a comparative graph for conditions ƒ(x)=x and

$$d ( x ) = - \frac{3}{2} x ,$$

and DS plot 1606 illustrates a comparative graph for conditions ƒ(x)=x and d(x)=2x. The person of ordinary skill in the art may note that, for DS plots 1600, 1602, 1604, 1606, the x₁-y₂ relation information shown Table 1 is depicted for the case where h(·) is an identity map, and where, for example, x₂=100 and y₁=10. From FIG. 16, it may be further observed that the charted value for y_{2slb} is consistently closer to the ground truth value than the y_{2trad} value for each given range. Furthermore, it may also be observed that implementation of the forward self-labeling technique (i.e., fwd) consistently outperforms implementations of conventional SSL (i.e., trad).

### Discrete DS and GC

The graphical results described above with respect to FIG. 16 are based on use of continuous-time DS. However, in practice, many systems are modeled in the ideal discrete form x(k+1)=ƒ(x(k)). Accordingly, in the case of two interacting DS, the coupling form may be y(k+1)=g(y(k), x(k)) and, in the case of linear coupling, the system y becomes y(k+1)=y(k)+x(k). Nevertheless, even though the results shown above were based on continuous DS, the present principles are equally applicable to discrete DS. That is, by quantizing the time dimension, the present systems and methods may advantageously convert continuous DS into discrete DS. Accordingly, the present self-labeling implementations may be implemented even in the case where object properties are digitized and classified into finite states. In an exemplary scenario, the present systems and methods may utilize finite state machines, or variants thereof, to serve as modeling tools for object states.

In an implementation, Granger Causality (GC) techniques may be implemented to define a statistical test of causal relations between two random variables represented by time-series data. GC is predicated on the statement that the cause occurs before the effect. A standard GC in a linear auto-regressive model may be represented according to:

$${Y}_{n} = {a}_{0} + {\sum }_{k = 1}^{L} {b}_{1 k} {Y}_{n - k} + {\sum }_{k = 1}^{L} {b}_{2 k} {X}_{n - k} + {ξ}_{n} , \qquad ( 15 )$$

where ξₙ represents uncorrelated noise, n is the discrete step, and X defines the “Granger Cause” Y. This GC formula is similar to coupled discrete DS, where X and Y represent two distinct systems and the order L is 1. Thus, for GC, cause and effect data may be quantized into distinct states similar to discrete DS implement the present self-labeling techniques. In some cases, the present self-labeling systems and methods may follow the GC form where the order can be greater than 1. In this case, more sequential causal states may be utilized, and the effect state may then self-label a sequence of cause data.

Although specific methodologies and theories are discussed above with respect to FIGS. 14-16, any of a variety of methodologies and theories as appropriate to the requirements of a specific application can be utilized in accordance with implementations of the technology disclosed. Simulated experiments in accordance with implementations of the technology disclosed are further described below.

### Simulated Experimental Results

In some implementations, object interactions were simulated to demonstrate the advantages realized according to the present self-labeling techniques.

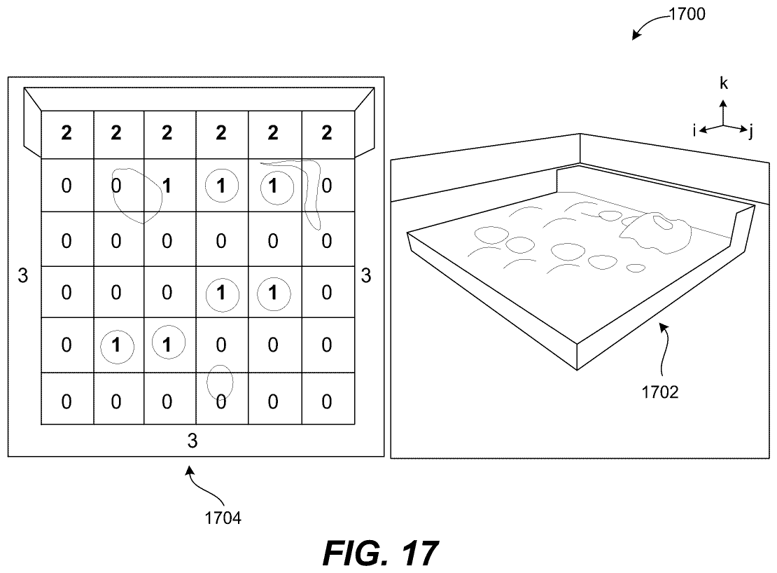

FIG. 17 illustrates an exemplary landscape simulation scenario 1700. For the exemplary implementation depicted in FIG. 17, simulation results were obtained through use of a three-dimensional (3D) simulation platform (i.e., ThreeDWorld (TDW) in this example, using a Unity engine). To obtain simulation results, a simulated ball was “dropped” at random locations, and the interaction of the dropped ball was observed with respect to a simulated finite ground surface region 1702. For this simulation, classical mechanical interactions between the ball and simulated finite ground surface region considered gravity, collision, and friction. Further to this simulation, finite ground surface region 1702 was defined as a complex landscape having hills, bumps, holes, walls, and uneven surfaces. A partition grid 1704 was then overlaid onto finite ground surface region 1702, such that region 1702 was partitioned into a plurality 6×6 blocks of equal size, which enabled the blocks to be classified into four separate classes based on the particular simulated features of each respective partitioned block.

As illustrated with respect to partition 1704, 23 blocks were classified into class 0 (i.e., “flat with minimal slope”), 7 blocks were classified into class 1 (i.e., “indentation that traps balls”), 6 blocks were classified into class 2 (i.e., “region contains wall”), with the remaining blocks (excluding the landscape) being classified into class 3. From this simulation, it may be seen that a ball falling from a random location will interact with differing random local topography of the land on which the ball falls. For example, the ball may bounce and roll on the landscape, and then settle on or off the landscape. Accordingly, the initial position of the ball, at first landing, may be used as the cause data since the relevant potential energy and the possible trajectories of each ball may be determined therefrom. According to this example, the effect data may then be defined as the trajectory of the ball upon contact with land, in consideration of the category of the region in which the ball eventually settles, to generate the corresponding effect label.

Thus, for this simulation, an ML task was created to train a model that ingests the initial position of the ball on region 1702, and then predict the final location category of the ball within partition 1704. For this simulation, a perturbation factor was added to represent a wind applied to the ball randomly in the air, and the friction and bounciness of each land block within partition 1704 were additional variables that were adjustable to enable alteration of the interactions. For this simulation, an additional mechanism was included to account for the number of balls accumulated on a land block, scaled by predetermined linear coefficients that enabled the simulation to dynamically change the block properties, and thereby increase the complexity of the system. These changeable parameters are summarized in Table 2, below.

TABLE 2
Changeable Parameters in the Simulation

| Parameter | Description | Default value |
|---|---|---|
| k₀ | Initial height range for sampling | [10, 15] |
| vᵢ, vⱼ | Ball's i/j axis moving speed before falling | 0.05, 0.05 |
| bounciness | Bounciness of the land in [0, 1]. | 0.75 |
| friction | Friction coefficient of the land in [0, 1] | 0.25 |
| wᵢ, wⱼ, wₖ | Wind force vector | (0.5, 0.5, −0.5) |

Accordingly, for the simulation experiment conducted with respect to FIG. 17, two data streams were simulated to independently sense the respective positions of the ball (a) in the air to collect cause data, and (b) on the land to obtain effect data. Accordingly, the final position classification of the ball, as well as its rebound number, was derived by processing the effect data stream. In this experiment, the land category was used as the label for the causal interactive task model, and the 3D coordinates of the final position and number of rebounds were used as the input for the ITM. For the exemplary simulation described above with respect to FIG. 17, the ITM used a gradient boosting decision tree (GBDT) with 500 estimators and 0.1 dropout rate as the regression model. The causal interactive task model was a multi-layer perceptron (MLP) of size (32, 64, 128, 256, 128, 64, 32), with an ReLU after each linear layer implemented in PyTorch, optimized using SGD with 0.0005 weight decay and 0.01 learning rate. The batch size was 128, with 600 epochs.

To obtain and accumulated dataset, the simulation generated a single ball, and then dropped the ball from a random position, sampled from a 3D uniform distribution where i∈[6, 6], j∈[6, 6], k∈[10, 15]. The resultant dataset generated by this simulation may be seen to be imbalanced, with a 2.1:4.9:3.4:4.6 class distribution in the unperturbed case, and a 1.1:4.7:3.2:6.0 class distribution in the perturbed case (e.g., using default simulation parameters). Accordingly, for this experiment, resampling was applied to balance classes, namely, taking 1500 samples per class, and 6000 samples overall.

Additionally, for this simulation, a nested k-fold cross validation was applied to reduce data selection bias, partitioning 6000 samples into three outer folds (i.e., 2000 samples each), selecting one outer fold as a test set, and the remaining two outer folds as training and validation sets, respectively. That is, the remaining 4000 samples from the other two outer folds were further each partitioned into five inner folds (i.e., 800 samples each). Using this partitioning, one inner fold was used to train the ITM and pretrain the MLP. Subsequently, 500-2500 samples from the four unused inner folds were utilized incrementally as self-labeled datasets to mimic drift adaptation, with the final 700 samples serving as the validation set. For this simulation, the outer and inner folds were rotated and averaged for model evaluation.

As demonstrated by the simulation results described above with respect to FIG. 17, the interaction time inferred by the ITM may be longer than the duration relevant to the ground truth, since the initial position of the ball may not exist in the cause data stream, and thus may not be available for self-labeling. To resolve this issue, the simulation included an additional to have the ball move horizontally before falling, thereby enabling corresponding ball positions that were capable of being self-labeled. For this mechanism, the horizontal movement was controlled by two coefficients shown in Table 2 with random direction. Using default parameters, the average R² score on test sets of the trained ITM was 0.84, and mean absolute error was 36.4, resulting in an average horizontal offset of 1.7, which are reasonably accounted for the average inaccuracy in the inferred interaction time equates to an offset of almost one block from the ground truth initial position.

The experimental results shown in Table 2 thus represent simulation results for the unperturbed case scenario. Experimental results generated using default parameters are shown further below in Table 3.

TABLE 3
Model Accuracy (%) Trained on Unperturbed Dataset

| | 500 | 1000 | 1500 | 2000 | 2500 |
|---|---|---|---|---|---|
| PseudoLabel [14] | 73.8 | 74.0 | 74.1 | 74.1 | 74.0 |
| MixMatch [53] | 68.3 | 68.0 | 68.0 | 68.1 | 68.3 |
| FixMatch [54] | 74.3 | 74.2 | 74.0 | 74.4 | 74.0 |
| FlexMatch [1] | 74.1 | 74.7 | 74.8 | 74.4 | 74.6 |
| PseudoLabelFlex [1] | 74.2 | 74.2 | 74.3 | 74.2 | 74.0 |
| SimMatch [55] | 72.8 | 72.5 | 72.8 | 72.7 | 72.7 |
| SoftMatch [56] | 74.7 | 75.0 | 74.7 | 74.5 | 75.0 |
| FreeMatch [57] | 74.3 | 74.6 | 74.7 | 74.7 | 74.7 |
| SLB (no pretrain) | 62.9 | 65.9 | 67.7 | 69.3 | 70.0 |
| FS (no pretrain) | 67.9 | 74.2 | 77.1 | 78.7 | 79.8 |
| SLB (v = 0.05) | 72.7 | 73.3 | 74.5 | 74.9 | 74.8 |
| SLB (v = 0.1) | 73.2 | 73.2 | 74.4 | 74.8 | 75.3 |
| SLB (v = 0.15) | 72.8 | 73.0 | 75.0 | 75.3 | 75.6 |
| FS | 75.7 | 77.3 | 79.7 | 80.3 | 81.0 |

As shown in Table 3, the present self-labeling techniques were compared with recent conventional semi-supervised models (i.e., implemented in TorchSSL and USB). The conventional techniques were originally with respect to image recognition datasets, adapted for this comparison to the collected simulation dataset, where the input data is a vector [i, j, k]. Accordingly, from Table 3, it may be observed that the present self-labeling systems and methods maintain a performance level that is at least a comparable with conventional SSL techniques across the five unlabeled dataset sizes without domain shift shown in Table 3. As may also be observed from table 3, the present self-labeling techniques further exhibit an increasing accuracy trend with more self-labeled data, i.e., comparable to the conventional FS technique, whereas other SSL techniques do not exhibit any significant benefit from enlarging the unlabeled dataset.

Accordingly, the results shown in Table 3, above, thus demonstrate the effectiveness of the present implementations for the unperturbed case scenario. As shown below with respect to Table 4, similar advantageous results are demonstrated when perturbation is applied. That is, the Table 4 results shown below are comparable to the Table 3 results shown above, but for the more complex case where perturbation (wind, in this example) was applied at a random time during initial 60 frames of ball falling.

TABLE 4
Model Accuracy (%) Adapted on Perturbed Dataset

| | 500 | 1000 | 1500 | 2000 | 2500 |
|---|---|---|---|---|---|
| PseudoLabel [14] | 69.1 | 69.1 | 69.1 | 69.1 | 69.0 |
| MixMatch [53] | 66.1 | 65.9 | 66.0 | 66.3 | 65.8 |
| FixMatch [54] | 68.9 | 69.1 | 69.0 | 68.9 | 69.0 |
| FlexMatch [1] | 69.4 | 69.3 | 69.4 | 69.6 | 69.7 |
| PseudoLabelFlex [1] | 69.2 | 69.5 | 69.4 | 69.4 | 69.8 |
| SimMatch [55] | 68.4 | 68\|.0 | 68.3 | 68.3 | 68.2 |
| SoftMatch [56] | 69.2 | 69.5 | 69.6 | 69.5 | 69.7 |
| FreeMatch [57] | 69.5 | 69.6 | 69.5 | 69.4 | 69.5 |
| SLB (no pretrain) | 64.2 | 67.4 | 69.4 | 71.2 | 72.3 |
| FS (no pretrain) | 71.1 | 76.1 | 78.0 | 79.2 | 79.9 |
| SLB (v = 0.05) | 70.8 | 72.4 | 73.5 | 74.3 | 74.4 |
| SLB (v = 0.1) | 71.1 | 72.2 | 73.3 | 74.2 | 74.5 |
| SLB (v = 0.15) | 71.4 | 73.0 | 73.8 | 74.2 | 74.8 |
| FS | 74.4 | 76.3 | 77.7 | 78.9 | 79.4 |

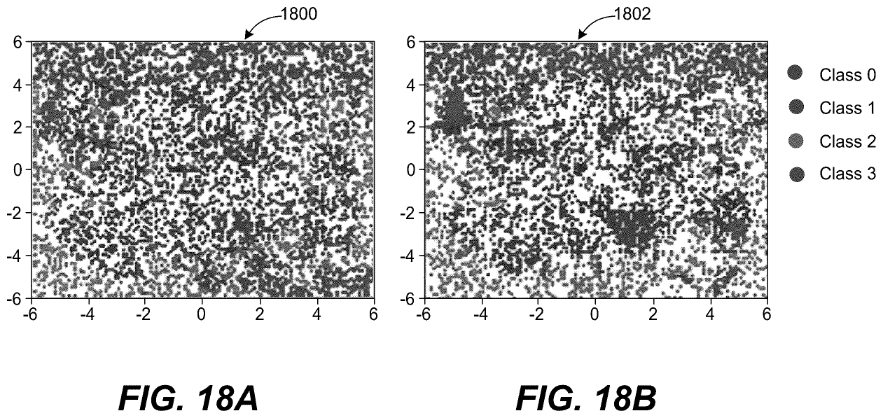

FIG. 18A is a graphical illustration depicting an exemplary input-output label plot 1800 generated with perturbation. FIG. 18B is a graphical illustration depicting an exemplary input-output label plot 1802 generated without perturbation. More particularly, input-output label plots 1800, 1802 graphically illustrate the data distributions of input and output labels in the case scenario using the initial horizontal positions of balls and the corresponding labels. Plot 1800 thus illustrates simulation results in the case of wind perturbation; and plot 1802 illustrates simulation results in the case where wind perturbation was not considered.

From FIGS. 18A-B and Table 4, the person of ordinary skill in the art may observe how the input-output mapping changes as wind perturbation is added (or removed), thus simulating the concept shift. To consider the other SSL techniques, the training data combined a labeled unperturbed dataset and an unlabeled perturbed dataset with data samples identical to the pretraining and self-labeled set used in to evaluate the present innovative self-labeling method. In the case of perturbation (e.g., plot 1800) SSL techniques that were based solely on feature similarity and smoothness show no significant improvement. In contrast, the present systems and methods for self-labeling may be seen to consistently maintain higher accuracy, as well as increasing improvement in accuracy as more data is collected, thereby indicating that the present implementations exhibit high potential for lifelong adaptive learning, while also validating the theoretic proofs described above. Additionally, since this experiment used 3D with complex internal interaction mechanisms, the results illustrated herein further demonstrate that the present self-labeling techniques are applicable well beyond the simplified 1D exemplary case scenarios described above.

For the experimental results shown in FIGS. 18A-B, the SLB technique was tested without pretraining its causal interactive task model, and with different vₓ and v_{y} (vₓ=v_{y}) in Tables 3 and 4. Thus, it may further be observed how the present self-labeling systems and methods have a greater impact on accuracy, in comparison with conventional techniques. For example, in the case where v (i.e., the penalty for incorrect interaction time inference) is increased, the performance of the SLB technique still exceeds that of the other conventional SSL techniques for perturbed cases, and even with v=0.15, which caused an average horizontal shift of 5.0, or more than two blocks of distance.

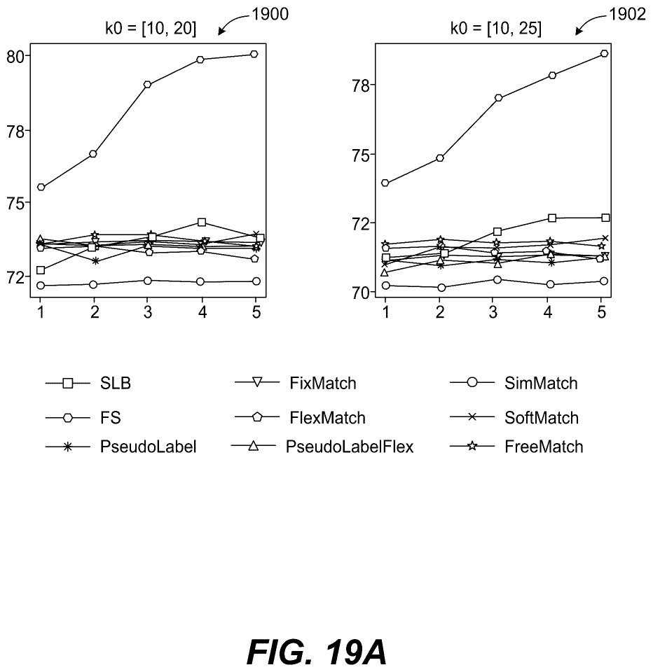

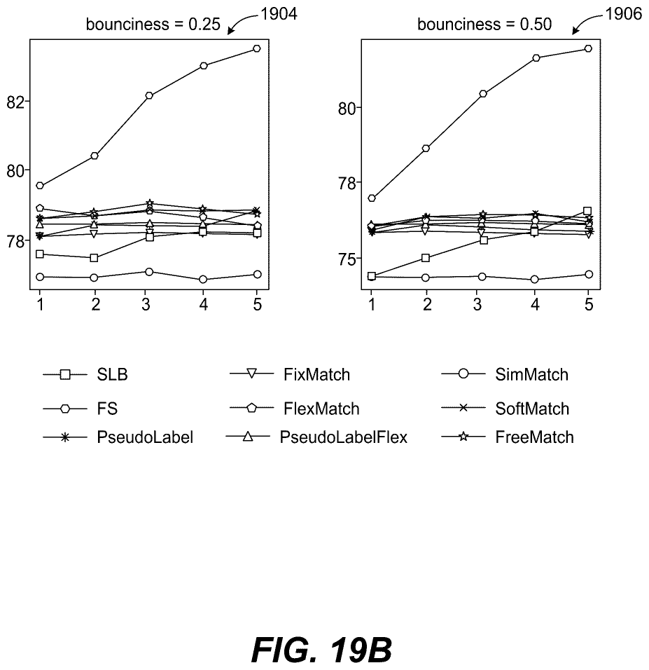

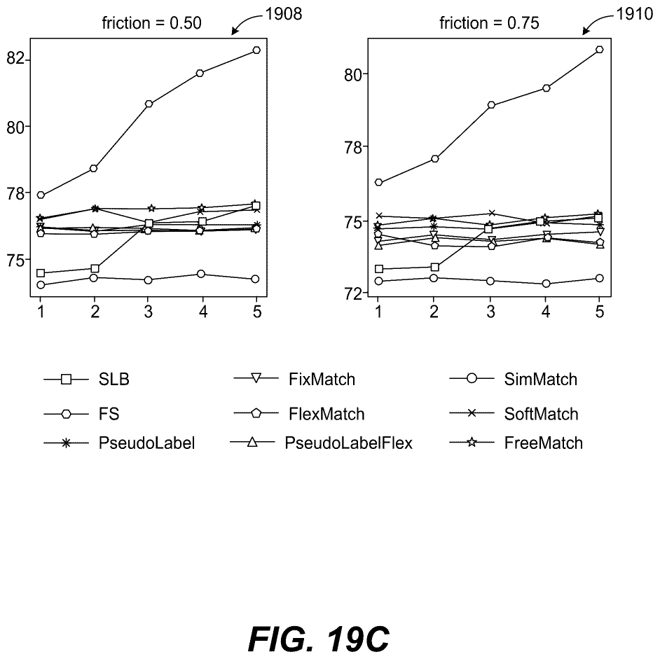

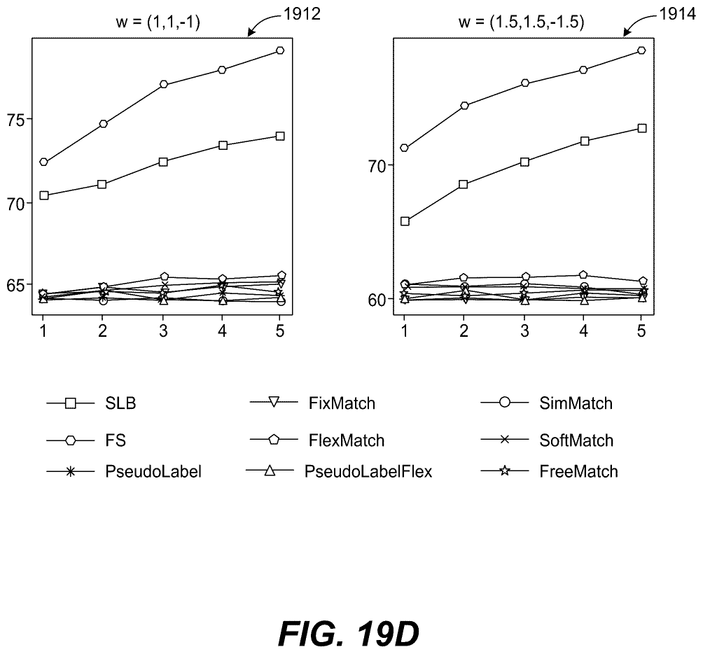

FIG. 19 is a graphical illustration depicting exemplary test result plots 1900, 1902, 1904, 1906, 1908, 1910, 1912, 1914 for the implementations described herein. In the exemplary implementations depicted in FIG. 19, plots 1900, 1902, 1904, 1906, 1908, 1910, 1912, 1914 represent test results obtained to further validate the proof of concept for the present self-labeling techniques described herein. With respect to a FIG. 19, to further validate the simulations and test results described above, a number of additional experiments were conducted for nine different task model techniques (i.e., SLB, FS, PseudoLabel, FixMatch, FlexMatch, PseudoLabelFlex, SimMatch, SoftMatch, and FreeMatch). Various simulation parameters (i.e., k₀, bounciness, friction, and wind) were then adjusted for each experiment to test the comparative effectivity of the various techniques. Accordingly, plot 1900 illustrates a comparative graph for parameter k₀=[10, 20], plot 1902 illustrates a comparative graph for parameter k₀=[10, 25], plot 1904 illustrates a comparative graph where bounciness=0.25, plot 1906 illustrates a comparative graph where bounciness=0.50, plot 1908 illustrates a comparative graph where friction=0.50, plot 1910 illustrates a comparative graph where friction=0.75, plot 1912 illustrates a comparative graph where w=[1, 1, −1], and plot 1914 illustrates a comparative graph where w=[1.5, 1.5, −1.5].

The person of ordinary skill in the art will observe, from the graphical results illustrated in FIG. 19, that, irrespective of the various simulation parameters, implementation of the present self-labeling techniques as shown achieves and maintains superior performance, in comparison with conventional techniques.

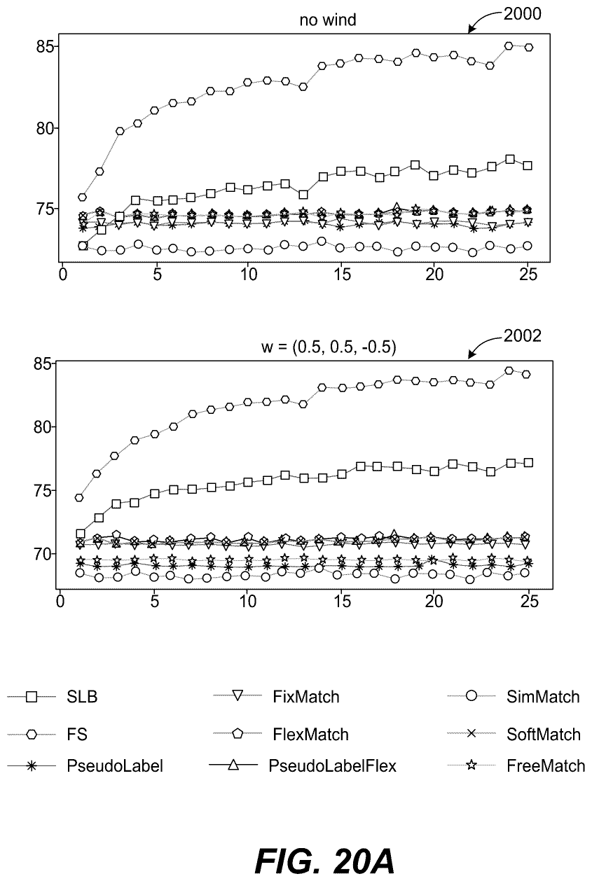

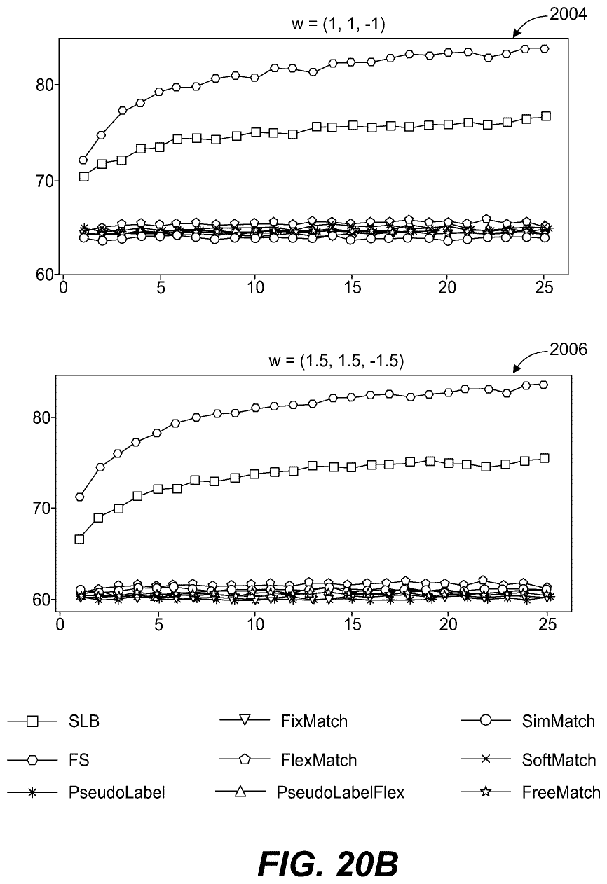

Furthermore, with respect to plots 1912 and 1914 specifically, it may be further seen that, in the case of Increasingly intense perturbations, the measured performance of conventional SSL techniques exhibits a drop of approximately 10% or greater, when compared to the results for the unperturbed case scenario shown in Table 3, above. In contrast, the present self-labeling systems and methods demonstrate similar accuracy levels with respect to the original domain, while further demonstrating greater accuracy with as the amount of data increases, as described further below with respect to FIG. 20.

FIG. 20 is a graphical illustration depicting exemplary test result plots 2000, 2002, 2004, 2006 for the implementations described herein. More particularly, plots 2000, 2002, 2004, 2006 additional obtained for the nine task model techniques examined with respect to FIG. 19 (i.e., SLB, FS, PseudoLabel, FixMatch, FlexMatch, PseudoLabelFlex, SimMatch, SoftMatch, and FreeMatch), but only for variations of the wind parameter w. Accordingly, plot 2000 illustrates a comparative graph in the case of no wind, plot 2002 illustrates a comparative graph where w=[0.5, 0.5, −0.5], plot 2004 illustrates a comparative graph where w=[1, 1, −1] (i.e., similar to plot 1912, FIG. 19), and plot 2006 illustrates a comparative graph where w=[1.5, 1.5, −1.5] (i.e., similar to plot 1914, FIG. 19). For each of plots 2000, 2002, 2004, 2006 though, the comparative test results were obtained using 25 increments of self-labeled datasets containing 500 samples in each increment, thereby providing up to 12,500 samples total of self-labeled data.

As may be observed from plots 2000, 2002, 2004, 2006, the accuracy trends observed in plots 1912, 1914, FIG. 19, our further validated with respect to the unperturbed case scenario (i.e., no wind) and three perturbed case scenarios having different respective wind magnitudes. By comparing the results of plot 2000 with the results shown in Table 3, above, it may be observed that the accuracy of the present self-labeling implementations increasingly improves as the number of self-labeled data increments increases, and the innovative techniques herein thus demonstrably outperform conventional SSL techniques under the same relative conditions. These results still further demonstrate the comparatively superior performance of the present self-labeling implementations, even in the case where domain shifts do not arise, thereby significantly improving capabilities to achieve autonomous adaptive learning.

### Dependent vs Independent Perturbation

Most DS analyses treat perturbations as a function of time due to the assumption of independence. However, as demonstrated above with respect to Eqs. (1)-(15), the function d(x) may be defined to keep x homogeneous. From an ML perspective, the perturbation term simulates the distribution difference between training data and real data, i.e., concept drift. For ease of explanation, the present description uses DS theory perturbation nomenclature; however, with a distinct physical meaning. Perturbation independence does not affect the concept drift simulation, given the change in the input-output relation. For example, the dimension d may be represented by various forms (e.g., constants, piece-wise functions, impulse functions, etc.), where the changepoint conditioned on t may be converted to x, since the boundary of interaction is defined.

### Extension to N-Dimensional DS

The mathematical self-labeling analysis described above with respect to Eqs. (1)-(15) was provided, for ease of explanation, in consideration of 1-dimensional (1D) case scenarios. Nevertheless, the experimental test results described above with respect to FIGS. 16-20 demonstrate the scalable applicability of the present systems and methods to higher-dimensional data. In this regard, an N-dimensional DS would intrinsically be composed of coupled 1D state variables. Thus, depending on the boundary definition and synchronization of two Interacting DS, the interaction of two 1D DS may also be effectively viewed as an internally coupled 2D DS. The present implementations thus advantageously enable implementation of the present self-labeling techniques to such higher-complexity N-dimensional DS Interactions, where the definition of interaction boundary may be ambiguous.

### Theoretical vs Real ML Applications

In the theoretical analysis, it is assumed that an ML model may ideally learn a function from given inputs and outputs. In practice, however, some trained ML models may not generalize well with respect to the input range, thereby giving rise to a practical problem that some self-labeling methods may suffer from biased input data ranges. For example, as described above with respect to plot 1600, FIG. 16, a self-labeled causal data range is shown to slightly change from [0.1, 100] to [0.22, 100]. Accordingly, in the case where \dot{x}=x, \dot{y}=2x, and d(x)=1, the causal data range of x_{slb} may further change to [3.7, 100]. Although the present inventors contemplate that such data range changes may marginally affect self-labeling performance in practice in some regions, the advantages achieved according to the present systems and methods remain demonstrably superior in comparison with conventional techniques, even in the relatively small number of regions that may be marginally affected.

### Connection to Control/Reinforcement Learning

The techniques described above with respect to DS and other interactions may be further advantageously implemented within the paradigm of control systems and Reinforcement Learning (RL) (e.g., robot learning). For example, RL leverages the interactions between control agents and the respective environments thereof to enable the agents to learn from interactive trials with designed reward functions. According to the present systems and methods, self-learning may be further implemented in cooperation with an RL-based control to utilize both interactions and feedback in the form of either effects or rewards caused by the interactions in the model learning process. In the case of RL for robot-object interactions, the present implementations enable adaptation of a new robot control strategy such that the learning output will improve robot behaviors. For example, the exemplary implementation described above, a self-labeling system may stand away and observe interactions from two channels, but without interfering with interactions governed by their own dynamics. Accordingly, a self-labeling system according to the present techniques enables adaptation of robust ML models for recognizing cause or effect states, but without imposing any control over agents. In contrast, dimensional RL techniques require some agent control.

### Causality

The innovative implementations described above build on causation, rather than correlation, as conventionally implemented. The present systems and methods thus improve upon conventional techniques because causality, and particularly causal direction, is more consistent across domains than correlation. Correlation for example, is strongly associated with probability, whereas causality possesses greater physical regularity. From a physics perspective, for example, in the Minkowski space-time model, causality is preserved in a time-like light cone irrespective of the reference frames of the observer, thereby demonstrating the considerably more reliable invariance of causality in comparison with correlation. Furthermore, the directionality of causation more explicitly characterizes state relations and time lags, since cause will always necessarily precede effect. As described above, the present implementations distinct and advantageous real-world applications.

### Multi-Variable Causality

For ease of explanation, the implementations described above consider causality with respect to two variables. Nevertheless, the present implementations may also be implemented for case scenarios having more than two variables that may render the causal structure more complex (e.g., inducing fork, collider, and/or confounder cases). For example, for a collider case scenario, each respective cause may have a different interaction time. For this case scenario, the present systems and methods may advantageously be configured to train more ITMs to infer each such different interaction time. Additionally, in a fork case scenario, multiple effects may also jointly infer interaction time and generate labels with the fork. For this case scenario, the respective variables may be separated for analysis where the corresponding state transitions thereof may be derived and smoothed on a temporal scale.

Although specific simulated experiments and results are discussed above with respect to FIGS. 16-20, a variety of simulated experiments and results, as appropriate to the requirements of a specific application, may be utilized in accordance with implementations herein.

### CPS Case Studies in Manufacturing

Manufacturing has been a vibrant field for diverse AI applications. In comparison with other fields, manufacturing requires comprehensive domain knowledge, while containing rich contextual information for AI processing. The following exemplary case studies illustrate particular advantages realized according to the present systems and methods for manufacturing ML applications that apply the present interactive causality driven self-labeling techniques and adaptive ML models.

For example, typical manufacturing production processes involved multiple interactions, and levels of interaction, between humans, machines, and materials throughout the process. Just as the Industry 4.0 concept revolutionized manufacturing by integrating information technology and operation technology, a new concept called Operator 4.0 is emerging. Operator 4.0 aims to emphasize the crucial roles of humans in terms of operational efficiency, adaptive feedback, and improved productivity.

The following exemplary case studies leverage the concept that workers are inherently connected to manufacturing systems through the active and reactive interactions of the users with relevant machines and materials. Such worker-machine interactions thus provide a source for valuable contextual intelligence that may be used to contribute to operation integrity, worker intention prediction, and anomaly detection of abnormal machine conditions. Accordingly, the following exemplary case studies achieve robust recognition worker-machine by addressing some or all of the following challenges: (a) adapting ML models to account for unpredictable human behavior and variable machine interfaces; (b) automating the model adaptation process, and thereby mitigate or eliminate the need for human intervention; and (c) developing generic solutions applicable across various manufacturing environments. By addressing these challenges, the present systems and methods demonstrate how ML systems may be significantly enhanced to better understand and respond to dynamic interactions between humans, machines, and materials in a manufacturing process, and thus significantly more efficient and productive operations.

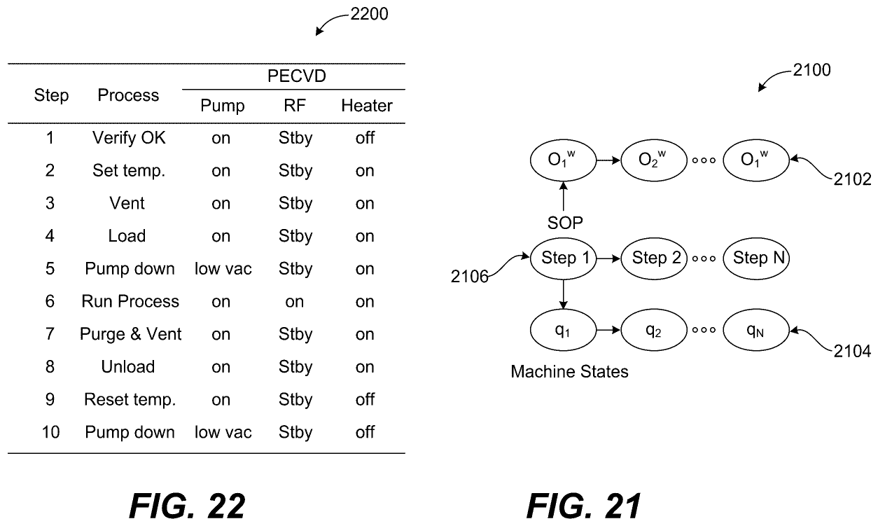

FIG. 21 is a schematic illustration depicting a logical diagram 2100 for standard operating procedure (SOP) cause and effect states. That is, in a typical manufacturing process, interactions occur between two or more objects, such as workers, machines, or materials, which interactions may follow predefined instructions defined as the SOP. Logical diagram 2100 thus depicts a finite state machine representation of a case study for a chemical vapor deposition machine. For this case study, an Interactive Cyber Physical Human System (ICPHS) was designed to enable human-machine interaction (HMI) recognition for a semiconductor manufacturing environment, as well as to facilitate an adaptive HMI recognition model. In the exemplary implementation depicted in FIG. 21, logical diagram depicts the SOP for a plurality of worker states 2102 (e.g., cause objects oᵢ), a plurality of machine states 2104 (e.g., effect states qᵢ), and a plurality of operational steps 2106 between respective worker states 2102 and machine states 2104.

FIG. 22 depicts an exemplary data table 2200 for a simplified implementation of logical diagram 2100, FIG. 21. More particularly, data table 2200 represents a simplified SOP for steps 2106, FIG. 21, used to run chemical vapor deposition machine that was the subject of this case study. In this study, interactions between objects were shown to induce a reciprocal effect on each object side, thereby forming causal relationships among the interactive objects. By leveraging this causality, the ICPHS was configured to collect data from one object (e.g., worker states 2102, in this example), and then use the status of the other object (e.g., machine states 2104, in this example) for self-labeling. The self-labeled data generated therefrom was then used for retraining and improving the ML model.

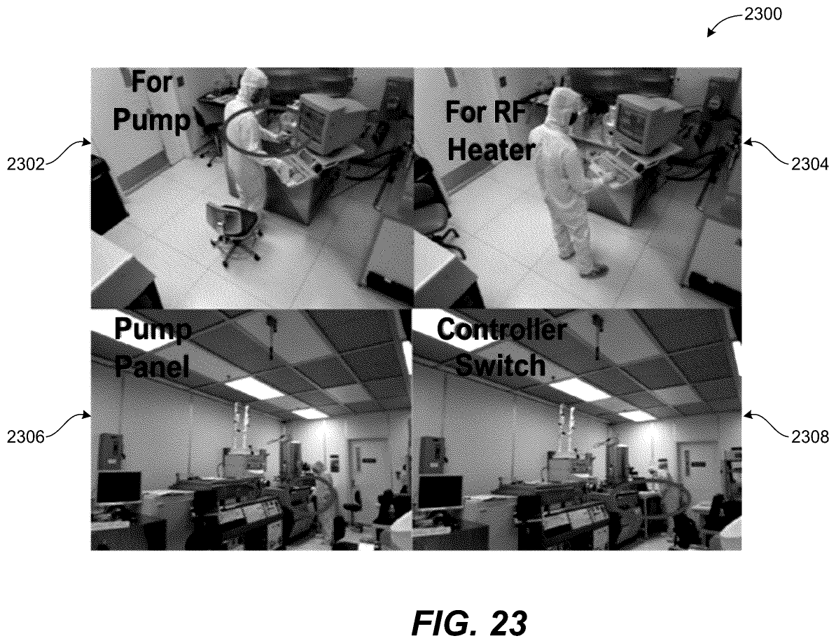

FIG. 23 depicts an operating principle 2300 for an exemplary worker-machine interaction scenario. More particularly, operating principle 2300 depicts the respective image captures (e.g., by a camera or a video sensor, not shown) of worker-machine interaction for the case study described above with respect to FIGS. 21-22. As depicted in FIG. 23, a first frame capture 2302 depicts HMI recognition with respect to a pump of a PlasmaTherm device considered in this semiconductor manufacturing case study. A second frame capture 2304 depicts HMI recognition with respect to the RF heater of the PlasmaTherm device. A third frame capture 2306 depicts HMI recognition with respect to a pump panel of an E-Beam device considered in this semiconductor manufacturing case study. A fourth frame capture 2308 depicts HMI recognition with respect to a controller switch the E-Beam device.

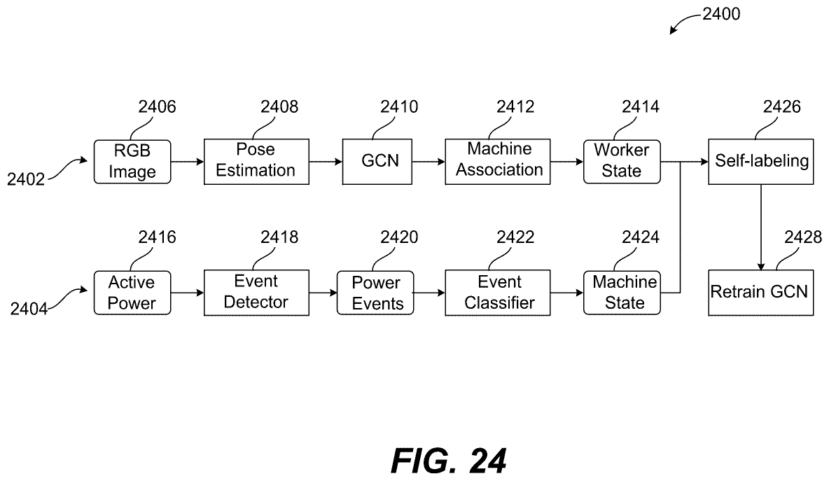

From frame captures 2302-2308, the practicality of the present ICPHS configuration may be observed for this case study involving a multiuser semiconductor manufacturing facility using at least two machines (e.g., the PlasmaTherm and E-Beam devices). For the study, the PlasmaTherm device was fully automated with a programmable logic controller (PLC), and the E-Beam device was operated manually. Energy disaggregation techniques were applied to power signals to detect real-time changes in the machine states of the respective devices, which were then used to self-label worker actions. As described further below with respect to FIGS. 24-26, frame captures 2302-2308 advantageously enabled HMI recognition based on worker actions detected among the captured video data.

FIG. 24 is a flow diagram depicting an exemplary real-time data processing pipeline 2400. More particularly, pipeline 2400 schematically depicts the processing flow to achieve HMI recognition for the semiconductor manufacturing case study described above with respect to FIGS. 21-23. To gather data for pipeline 2400, each machine (e.g., PlasmaTherm and E-Beam devices) was equipped with a webcam and a three-phase power meter as respective sensors. The webcam captured real-time videos (e.g., frame captures 2302-2308, FIG. 23) of the surroundings of the respective machine, thereby functioning as a primary cause data channel 2402, while the power meter recorded power signals from the respective machine, thereby serving as a secondary effect-observing channel 2404.

Primary cause data channel 2402 included in RGB (i.e., color) image capture unit 2406, a pose estimation unit 2408, a graph convolutional network (GCN) 2410, a machine association unit 2412, and a worker state identification unit 2414. Secondary effect-observing channel 2404 included an active power monitor 2416, an event detector 2418, a power event identifier 2420, an event classifier 2422, and a machine state identification unit 2424.

In operation of pipeline 2400, the captured video stream (e.g., frame captures 2302-2308, FIG. 23) was divided into segments and then fed into a two-step cascaded ML model (e.g., GCN 2410) serving as the causal interactive task model to estimate human activities. The actions recognized by GCN 2410 were then associated with a corresponding machine (e.g., by machine association unit 2412) based on spatial consistency, thereby enabling the determination of the link between human activities (e.g., from worker state identification unit 2414) and specific machines. Simultaneously, the aggregated power signal undergoes processing to identify machine states (e.g., at machine state identification unit 2424) corresponding to identified worker states (e.g., at worker state identification unit 2414).

In further operation of pipeline 2400, the identified worker and machine states were then fed to a self-labeling module 2426, which compared and temporally aligned the information from both streams ingested from primary and secondary channels 2402, 2404, that is, with the video data from primary channel 2402 indicating human activities, and the power signal data from secondary channel 2404 indicating the corresponding machine component states. By combining and cross-referencing the respective human and machine data sources, as well as the predetermined interaction time of the corresponding worker and machine state transitions, the self-labeling processing executed by self-labeling module 2426 was shown to be both reliable and robust. For this case study, the ITM included a lookup table, with gaussian randomness as the interaction time between worker action and corresponding machine energy event. In practical applications, the interaction time may also be determined based on measured hardware circuitry responses. For this case study, after self-labeling by self-labeling module 2426, pipeline 2400 was able to effectively retrain GCN 2410 using a self-labeled dataset to facilitate automated adaptation of a retrained/fine-tuned GCN 2428.

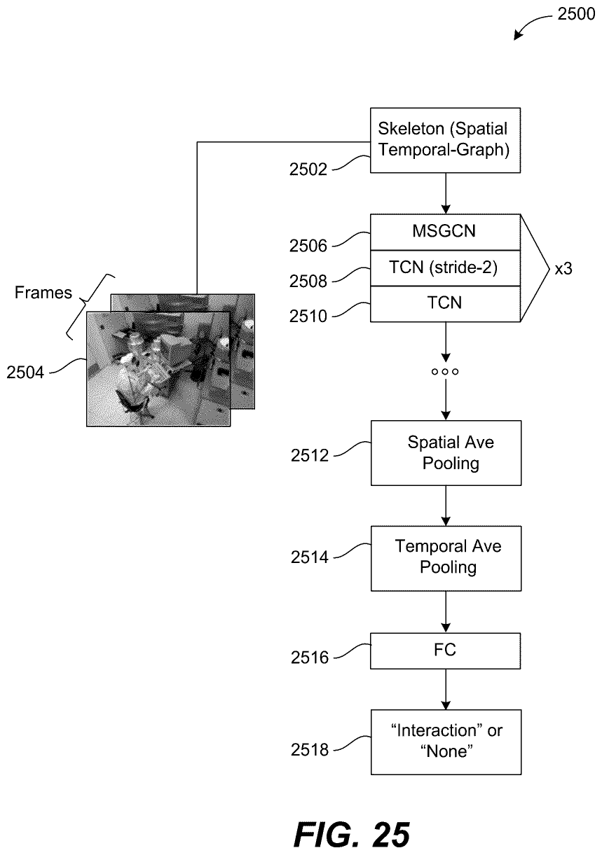

FIG. 25 is a flow diagram depicting an exemplary energy disaggregation process 2500 for data processing pipeline 2400, FIG. 24. In the implementation depicted in FIG. 25, an Energy State Detector (ESD) was utilized to serve as the effect recognizer (e.g., effect recognizer 206, FIG. 2) configured to detect and classify power events, and also to conduct unsupervised energy disaggregation. Energy disaggregation, for example, may involve solving an optimization problem using power signatures from individual machine components, with a goal of exploring possible combinations to identify the combined signal that most closely matches the actual aggregated signal. For the case study described above with respect to FIGS. 21-24, energy disaggregation process 2500 was implemented to disaggregate the state transitions of each respective machine component from the main power signal. According to this exemplary technique, real-time classification of the states of machine components was achieved. Implementation of energy disaggregation process 2500 is therefore particularly useful for enabling indication of worker actions that may be taken prior to self-labeling.

In the exemplary implementation depicted in FIG. 25, process 2500 illustrates a cascade of action recognition steps that may be implemented to develop and/or refined and HMI recognition model. For example, at step 2502, process 2500 is configured to create a spatial temporal graph from a series of input sensor frames 2504 (e.g., frame captures 2302-2308, FIG. 23). For this particular case study, to protect worker privacy in the work environment, process 2500 utilized OpenPose to extract skeletons from the spatial temporal graph created in step 2502. For this case study, each skeleton was composed of 15 joints, excluding head and foot joints, and the extracted skeletons then functioned as the basis for feature extraction and representation learning from graph-structured data.

In step 2506, a Multi-Subgraph-based GCN (MSGCN) variant was applied to the skeletons, which effectively captured multi-scale structural features from non-local neighbors. In step 2508, a stride-dilated temporal convolution network (TCN) predicts energy consumption from the MSGCN (e.g., stride=2). Through this incorporation of multiscale connections with TCNs, Models used and/or generated with respect to process 2500 are capable of achieving robust and privacy-preserving feature extraction and representation learning from graph-structured skeleton data.

In step 2510, a second TCN predicts energy consumption from the stride-dilated TCN. In some cases, the first and second TCNs may be the same. In other cases, the second TCN may implement a different stride value than the first TCN. In an exemplary implementation, steps 2506 through 2510 may be iterated three times in succession before proceeding to step 2512. In step 2512, process 2500 applies spatial average pooling to the predicted energy consumption. In step 2514, process 2500 applies temporal average pooling to the pooled spatial averages. In step 2516, from the average spatial and temporal pools, fully-connected (FC) layer representations may be extracted regarding the causal relationship between a worker and a machine/machine component detected from input sensor frames 2504. In step 2518, process 2500 determines, from the extracted FC layer representations, whether a causal relation has occurred between a worker and a respective machine/machine component. In an exemplary implementation of step 2518, process 2500 may be further configured to output result data reflecting the occurrence of a causal interaction (e.g., “interaction”) or not (e.g., “none”).

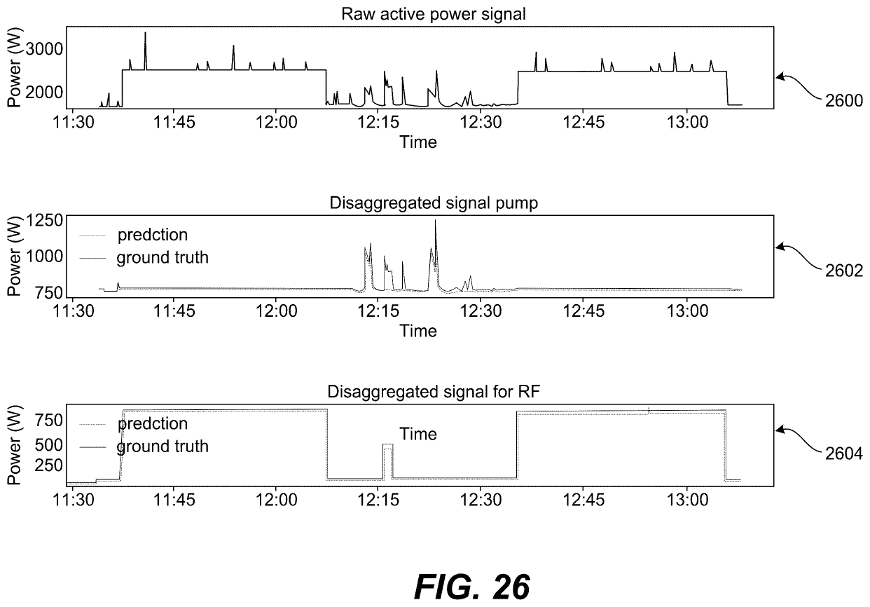

FIG. 26 is a graphical illustration depicting exemplary test result plots 2600, 2602, 2604 obtained with respect to energy disaggregation process 2500, FIG. 25. More particularly, plots 2600, 2602, 2604 show measured power results over time for various sensor inputs obtained for the PlasmaTherm device used in the case study described above with respect to FIGS. 21-25. As depicted in FIG. 26, plot 2600 illustrates the raw active power measured by a sensor of the PlasmaTherm device used to monitor baseline power data. Relative to plot 2600, plot 2602 illustrates the energy disaggregation measured by a pump sensor of the PlasmaTherm device, and plot 2604 illustrates the energy disaggregation measured by an RF sensor of the PlasmaTherm device. From plots 2600, 2602, 2604, the resultant energy disaggregation for two components (e.g., pump and RF generator) of the PlasmaTherm device may be observed with respect to the raw active power signal of the device.

For the case studies described above with respect to FIGS. 21-26, the particular Plasma Therm device of the study included a machine interface having a keyboard and a monitor. Manual activations of machine operations were executed, through human interaction with the device keyboard, for four individual machine components of the PlasmaTherm device, namely, the RF generator, the pump, the heater, and the device main body. For the case studies described above, the present systems and methods were deployed on the PlasmaTherm to automatically collect and label samples over a period of 1.5 months. A total of 139 self-labeled positive (interaction) samples were collected during this period, and it was observed that 23 of the collected samples related to RF operation, but were incorrectly labeled due to variations in the on-set RF operation response time. Accordingly, during the case study, an automated post-processing filter was introduced to address this issue. The automated post-processing filter thereby successfully functioned to successfully filtered out 22 mislabeled samples, thus resulting in an adjusted total of 117 positive samples demonstrating improved label error rate of 0.85%. In one case, 100 samples from different respective classes were selected from a public dataset for pretraining.

The adaptive learning capability according to the present systems and methods were further demonstrated by grouping self-labeled samples in chronological order. Table 5, below, shows the experimental evaluation resulting therefrom. From Table 5, it may be observed that, as the quantity of self-labeled data used for retraining as increased, the corresponding detection accuracy also improves. Considering the entire dataset 117 self-labeled data samples, the detection accuracy is shown to be 12.5% higher than and initial accuracy result, and at least 6.9% higher than may be realized utilizing conventional techniques (i.e., K-means, P&C, CrossCLR, in the exemplary results shown in Table 5). From Table 5, the person of ordinary skill in the art will understand that the innovative adaptive learning mechanism implementations described herein demonstrate significantly improved performance in comparison to conventional techniques.

TABLE 5
Experimental results of PlasmaTherm

| Method | Dataset | Precision | Recall | F1 score | Accuracy |
|---|---|---|---|---|---|
| Present | 100 | 0.843 | 0.912 | 0.869 | 85.7% |
| Present | 100 + 39 | 0.946 | 0.980 | 0.962 | 96.0% |
| Present | 100 + 78 | 0.956 | 0.980 | 0.968 | 96.6% |
| Present | 100 + 117 | 0.981 | 0.985 | 0.983 | 98.2% |
| K-means | 100 + 117 | 0.592 | 1 | 0.744 | 64.5% |
| P&C | 100 + 117 | 0.858 | 0.942 | 0.899 | 89.0% |
| CrossCLR | 100 + 117 | 0.879 | 0.964 | 0.919 | 91.3% |

The experimental results shown above with respect to Table 5 thus demonstrate the improved performance resulting from implementation of the present systems and methods for the PLC-controlled machine depicted in image capture frames 2302, 2304, FIG. 23. As shown below with respect to Table 6, similar advantageous results were demonstrated with respect to the E-Beam machine depicted in image capture frames 2306, 2308, FIG. 23.

For the PlasmaTherm case study described above, in contrast to the PLC machine, the E-Beam was manually operated. Additionally, the E-Beam machine featured four separate functional components, each having multiple control panels and switches located at different positions, as depicted in FIG. 23. Due to its manual nature, the E-Beam machine involved a significantly greater number of worker interactions through the various interfaces of the separate functional components, which were positioned at different respective locations. Accordingly, the accurate recognition of worker-machine interaction for manually operated machines is significantly more complex than HMI recognition for fully automated data. Furthermore, in a typical manual machine operation, a particular worker may tend to engage with the respective machine interfaces using different static postures (e.g., standing, sitting, squatting, bending, etc.), thereby adding still further complexity to the interaction recognition process.

Thus, similar to the PLC analysis described above with respect to Table 5, a system implementing the present implementations was also deployed over a period of 1.5 months for data collection and self-labeling in the manually operated E-Beam machine case scenario. During this study period, a total of 211 positive samples were collected, with 16 samples thereof being mislabeled due to response time variations. 500 samples from each class were selected for pretraining, and, after applying a post processing filter to eliminate improper samples, 141 self-labeled positive samples remained. Correspondingly, 141 self-labeled negative samples were randomly selected, with no mislabels having been found in these randomly selected negative samples. The label noise level for the self-labeled positive samples was found to be 7.8%.

Table 6, below, shows the evaluation results for the E-Beam machine case scenario. As indicated in Table 6, model accuracy exhibits a substantial boost of 9.9% through retraining with self-labeled samples, thereby further verifying the practicality and effectiveness of the adaptive learning framework of the present systems and methods.

TABLE 6
Experimental results of E-Beam

| Dataset | Precision | Recall | F1 score | Acc |
|---|---|---|---|---|
| 500 | 0.800 | 0.699 | 0.736 | 75.2% |
| 500 + 141 | 0.893 | 0.802 | 0.843 | 85.1% |

### Operator Intention Recognition in Manufacturing Human-Robot Collaboration

Manual assembly processes are utilized in many manufacturing sectors. Despite the fact that many repetitive assembly lines now utilize robots, certain assembly processes continue to require operator (i.e., human) engagement with assistive collaborative robotic arms (cobots). In such scenarios, cobots assist the human operators by instantly and seamlessly transporting needed parts to an assembly bench that is easily accessible by the respective operator, where the operator may then receive and assemble the cobot-transported parts following a predefined sequence (e.g., according to an SOP). Successful human-cobot collaboration generally requires a high throughput of the human-assembled products. Accordingly, the efficiency between human operators and cobots remains a critical concern in the industry.

For example, in order to achieve seamless cooperation, cobots are generally required to recognize the assembly steps, as well as the operator intentions, in a timely manner and then act properly to move parts in an optimally efficient manner. For safety purposes, many cobots presently in-use in the industry are designed to act passively, such as in the case where a robot is required to receive operator commands (e.g., by pushing a button) before acting to execute the next task or processing. Although this passive relationship has been effective to provide workplace safety, it has also resulted to compromise efficiency due to the lack of predictability.

Some conventional solutions have proposed deep learning-based vision technology to recognize product status and/or worker actions to infer a subsequent step or action by the human operator. Such data-driven models have been useful to capture and learn consistent patterns representing the intentions of moving to the next assembly steps after training on a pre-collected and labeled dataset. However, similar to the other conventional ML techniques described above, these conventional solutions lose potential efficiency by failing to consider the temporal causal relation between operators and cobots, thus also failing to adequately account for and/or leverage the time interval between respective causes and effects.

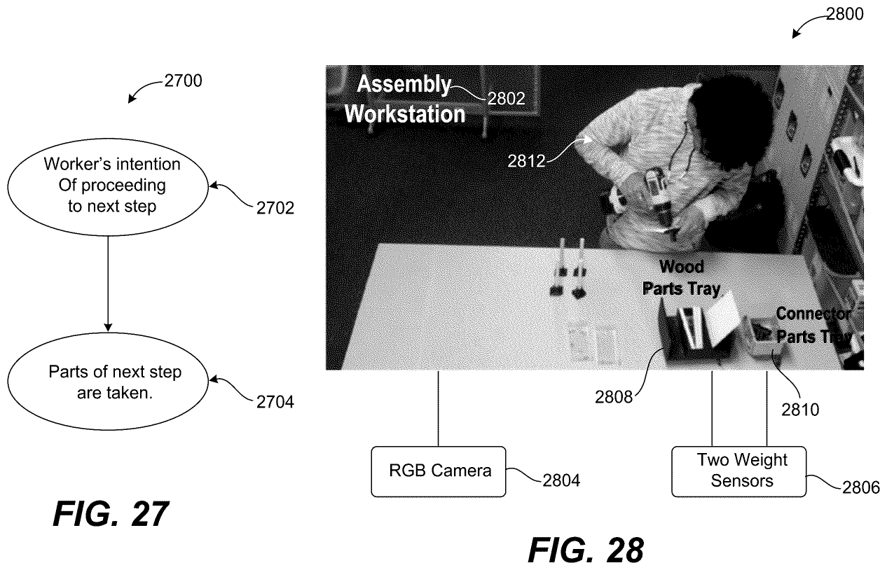

For the case study described below with respect to a FIGS. 27-31, a manual assembly scenario was implemented to apply the innovative self-labeling systems and methods described herein, and thereby develop a dynamically-adaptive ML system capable of effectively achieving intention recognition. For ease of illustration, the following case study was performed using a standard chair assembly specifying 12 distinct steps for the relevant SOP, and two different categories of parts for assembly: (1) wood parts; and (2) plastic parts. More particularly, the SOP for this chair assembly was established to guide the interactions between a human operator and assembly materials.

FIG. 27 illustrates an operating principle 2700 of causality for an exemplary case study. For this chair assembly case study, a known causality embedded in the human-material interaction may be summarized by the concept that the completion of a present step gives rise to a cause event 2702 having a corresponding effect 2704 for the next assembly part to be picked for a succeeding step. For operating principle 2700, cause event 2702 was defined as the operator intention that may be recognized for a collaborating robot/cobot to initiate effect 2704, which, in this case, was defined as the next assembly part being picked.

FIG. 28 depicts a perspective view of an exemplary environmental setup 2800 to demonstrate operating principle 2700, FIG. 27. As illustrated in FIG. 28, environmental setup 2800 reflects a physical layout for a manual assembly workstation 2802 used for the chair assembly case study. For this case study, environmental setup 2800 included a first sensor 2004 (i.e., the camera this example) configured to physically view the physical environment about manual assembly workstation 2802, and a second sensor 2806 (e.g., a pair of weight sensors 2806(1), 2806(2), in this example) configured to respectively determine the weight(s) of (a) wood assembly parts in a wood parts tray 2808, and (b) connector assembly parts in a connector parts tray 2810.

For this given domain knowledge, weight sensors 2806(1), 2806(2) effectively function as two effect observers configured to sense the weight of parts held in each tray 2808, 2810, respectively, such that the distinguishable weight change of both trays holding the respective spare parts may be detected in real-time. That is, the effect observers are enabled to determine when an assembly part is taken from its respective tray from the measurable weight change, which will further indicate the completion of a previous workflow step that occurs before the next part should be taken from the respective tray 2808, 2810, for example, by a human operator 2812 stationed within environmental setup 2800.

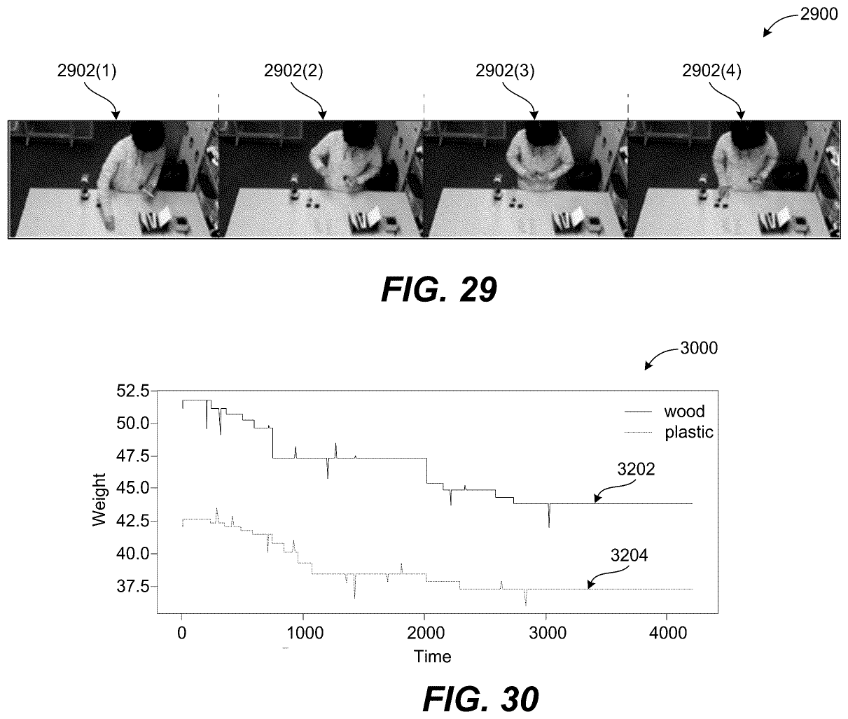

FIG. 29 illustrates an exemplary frame sequence 2900 captured for an implementation of environmental setup 2800, FIG. 28. More particularly, for environmental setup 2800, FIG. 28, first sensor 2804 included an RGB camera mounted above assembly workstation 2802, and which was configured to capture a sequential series of image frames 2902 as a cause data stream indicating various body gesture(s) and assembly status(es) of human operator 2812 with respect to manual assembly workstation 2802 and/or the physical layout of environmental setup 2800.

FIG. 30 is a graphical illustration depicting an exemplary comparative weighting plot 3000 for environmental setup 2800, FIG. 28. As shown in FIG. 30, comparative weighting plot 3000 illustrates the distinguishable weight changes to respective trays 2808, 2810 of manual assembly workstation 2802, FIG. 28. More particularly, comparative weighting plot 3000 includes a first subplot 3002 indicating the measurable weight of wood parts tray 2808 over time, and a second subplot 3004 indicating the measurable weight of connector parts (i.e., plastic parts, in this example) tray 2810 over time. In an exemplary implementation, weight measurements taken for comparative weighting plot 3000 may be used to generate and effect data stream, and may further include at least one weight measurement for each tray 2808, 2810 corresponding to at least one image frame 2902, FIG. 29, obtained to generate the cause data stream.

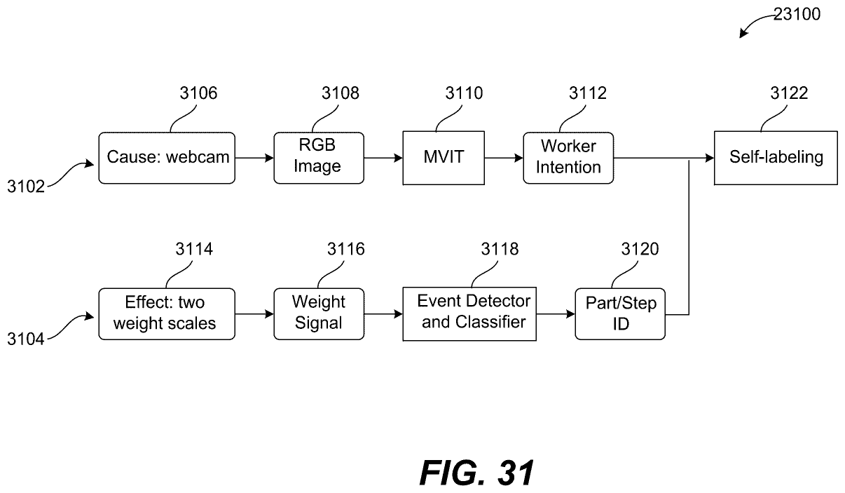

FIG. 31 is a flow diagram depicting an exemplary data processing pipeline 3100 for frame sequence 2900, FIG. 29, and for weighting plot 3000, FIG. 30. In the implementation depicted in FIG. 31, an exemplary system architecture was configured to implement the innovative adaptive AI techniques of the present implementations for accurate recognition of operator intention. In some aspects, data processing pipeline 3100 is similar to data processing pipeline 2400, FIG. 24, and includes a cause data channel 3102 configured to process captured data from image frames 2902, FIG. 29, and an effect-observing channel 3104 configured to process detected weight changes indicated in weighting plot 3000, FIG. 30, and which operates in parallel with cause data channel 3102.

Accordingly, cause data channel 3102 included a cause sensor 3106 (e.g., first sensor/camera 2804, FIG. 28), at least one RGB image 3108 (e.g., image frames 2902, FIG. 29) captured by cause sensor 3106, a Multiscale Vision Transformer (MVIT) 3110, and a worker intention identification unit 3112. Effect-observing channel 3104 included an effect recognizer 3114 (e.g., weight sensors 2806(1), 2806(2), FIG. 28), a weight signal 3116 measured by effect recognizer 3114, an event detector/classifier 3118, and an assembly part/SOP step identification unit 3120.

In operation of pipeline 3100, the data stream corresponding to image frames 2902 was fed into MVIT 3110 to model RGB image(s) 3108 such that MVIT 3110 was enabled to function as a causal interactive task model enabling worker intention identification unit 3112 to estimate worker intention as a cause event. The actions recognized by MVIT 3110 were then associated with an associated assembly part or SOP step from assembly part/SOP step identification unit 3120, which were based on the detected weight signal events (e.g., from event detector/classifier 3118). The resulting identified worker intentions and parts/steps from cause and event channels 3102, 3104, respectively, were then jointly fed to self-labeling system 3122 to execute one or more of the automatic processing techniques described herein.

According to data processing pipeline 3100, self-labeling system 3122 may be considered to involve three computational models, including without limitation: (a) an effect recognizer; (b) an interaction time model; and (c) a causal interactive task model. Accordingly, once a causal relationship is identified, the effect recognizer may be configured to recognize the relevant effect states. For the particular chair assembly case study described above with respect to FIGS. 27-31, effect state detection may occur after state transitions are identified, and then followed by state recognition.

To generate an interaction time model for the chair assembly case study, an XGBoost regressor was applied to infer individual interaction time(s). For this particular case study, since two effects were captured by two sensors, two ITMs were implemented for effect-observing channel 3104. That is, the effect data stream used for ITM input included the concatenation of the raw weight data from the two weight sensors 2806(1), 2806(2), together with the relevant effect labels. For this case study, the XGBoost regressor used a 0.01 learning rate and 2000 estimators. For the causal interactive task model, MViT 3110 was selected, based on its relatively lightweight footprint and good performance, to recognize the cause states using a vision transformer model for videos.

### Dataset

To demonstrate the effectiveness of the chair assembly case study described above with respect to FIGS. 27-31, four different human operators (e.g., human operator 2812, FIG. 28) conducted a complete chair assembly 150 times from start to finish of the relevant SOP. Three streams of data, namely, from first camera sensor 2804 the two weight sensors 2806(1), 2806(2), respectively were saved for the entire duration of each complete assembly that was executed. Each stream of assembly data was then segmented into 11 video classes, providing a total of 1650 video samples for each completed assembly operation. For training purposes, the videos were resized into a 224*224 resolution at 4 frames per second (fps), and each respective video clip that indicated operator intentions was sliced to have a same temporal length of 4 seconds. To generate a comparative weighting plot 3000, FIG. 30, the weight sensor data was recorded at 10 Hz.

For validation purposes, the entire dataset generated for this chair assembly case study was manually labeled with respect to each of the cause-and-effect states, as well as the interaction time between each cause-effect pair. This dataset was then split into (a) a pretraining subset, (b) a self-labeled subset, (c) a validation subset, and (d) a test subset including 350, 700, 200, and 400 samples, respectively. The pretraining set was used to train the ITM models and pretrain the causal interactive task model. The self-labeled set was autonomously self-labeled by effect state detectors and the ITMs for adaptively retraining the causal interactive task model. The self-labeled set was used as an unlabeled training set for training other SSL systems (described further below with respect to Table 7) for comparative purposes.

Accordingly, for this chair assembly case study, the present self-labeling techniques were compared to conventional FS and SSL techniques. The results of this comparison are shown below in Table 7. From Table 7, it may be observed that there is not an apparent data shift between training and test sets. Nevertheless, the results shown in Table 7 demonstrate that the present self-labeling systems and methods achieve advantageous outcomes, in comparison with conventional techniques, even with respect to more complex manual assembly manufacturing operations. For example, as indicated below, the ITM of the present implementations achieves an R2 score of 0.677, with a mean absolute error of 1.97, and the present self-labeling techniques further achieve 88.2% accuracy for this case study, which is comparable to the results achieved using conventional FS techniques, and considerably better than results produced using conventional SSL techniques, all of which can be seen to fall below 80% accuracy in Table 7. Accordingly, these results thus further demonstrate the advantageous applicability of the present self-labeling techniques for complex interaction scenarios having more than 10 classes.

TABLE 7
Experimental results of the manual assembly case study

| Method | Accuracy (%) |
|---|---|
| PseudoLabel (2013) | 72.2 |
| MixMatch (2019) | 76.9 |
| FixMatch (2020) | 76.4 |
| FlexMatch (2021) | 60.4 |
| PseudoLabelFlex (2021) | 79.6 |
| FreeMatch (2023) | 64.9 |
| Fully supervised | 92.1 |
| Self-labeling | 88.2 |

### Multivariate Self-Labeling

As described above, supervised models form the majority of conventional ML applications due to their reliable performance despite requiring training dataset collection and annotation, consuming considerable time and labor. Adaptive ML allows models to adapt to environmental changes (e.g., concept drift) without full supervision to avoid laborious manual model adaptation. Several classes of methods have been proposed to achieve adaptive ML with minimum human intervention, including pseudo-labels, empowered by semi-supervised learning (SSL), delayed labels, and domain knowledge enabled learning.

Recently, self-labeling (SLB), a method based on interactive causality, has been proposed and demonstrated to equip AI models with the capability to adapt to concept drifts after deployment. The fundamental idea of self-labeling is to contextualize ML tasks with causal relationships, then apply the associated causation and learnable causal time lags (i.e., interaction time) to causally related data streams, autonomously generating labels and selecting corresponding data segments that can be used as self-labeled datasets to adapt ML models to dynamic environments. It transforms complex problems on the cause side into easier problems on the effect side by temporally associating cause and effect data streams. Compared with traditional semi-supervised learning, self-labeling targets realistic scenarios with streaming data and is more theoretically sound for countering domain shifts without needing post deployment manual data collection and annotation.

The self-labeling theory formulated leaves some key topics to be explored. First, the proof and experiments in use a minimal causal structure with two interacting variables. Causal graphs using Bayesian networks (e.g., structural causal models) represent causality with four basic graph structures: chain, fork, collider, and confounder. The application of self-labeling in more complex causal graphs has not been well-defined. Second, the proof makes an implicit assumption that the auxiliary interaction time model (ITM) and effect state detector (ESD) are error-free with 100% accuracy. In practical applications, however, ITM and ESD models are inaccurate, potentially degrading self-labeling performance. This needs extensive investigation to understand the impact of inaccuracy in the two auxiliary models. In addition, as self-labeling requires less manual annotation but more computing power for ITM and ESD inferencing, additional insights regarding the merit of self-labeling can be revealed by evaluating the tradeoffs between accuracy and cost. The cost herein includes the electricity consumed for compute and manpower cost for data annotation and thus requires a shared metric for comparative evaluation.

This application extends interactive causality enabled self-labeling theory and proposes solutions to these research questions. A domain knowledge modeling method is adopted using ontology and knowledge graphs with embedded causality among interacting nodes. This study explores the application of self-labeling to scenarios with multivariate causal structures via interaction time manipulation among multiple causal variables, focusing on the four basic causal structures extensible to more complex graphs. Additionally, we propose a method to quantify the impact of ITM and ESD inaccuracy on self-labeling performance using the dynamical systems (DS) theory and a metric incorporating the cost of human resources to evaluate tradeoffs along the spectrum of supervision. A simulation utilizing a physics engine is conducted to demonstrate that self-labeling is applicable and effective in scenarios with complex causal graphs. It is also demonstrated experimentally that the interactive causality based self-labeling is robust to the uncertainty of ESD and ITM in practical applications. Self-labeling is also shown to be more cost-effective than fully supervised learning using a comprehensive metric.

The motivation of self-labeling originates from the necessity of domain adaptation to counter data distribution shifts (e.g., concept drift) after ML models are deployed. To adapt a ML model (referred to as the task model) to the concept drift without the needs of manual data annotation, many types of methods have been proposed including unsupervised or semi-supervised domain adaptation, natural and delayed labels (such as user interactions in recommendation systems, and domain knowledge-based learning. Among them, the recent interactive causality enabled self-labeling is focused on automatic post-deployment dataset annotation by leveraging causal knowledge. In general, the data annotation consists of two steps in real applications: (1) select which samples to be labeled in streaming data; (2) generate labels for the selected samples. For static datasets, Step 1 is usually not required since the samples are selected already. The self-labeling method addresses the two steps by: (1) utilizing causality to find the sensor modalities that can generate labels for the task model; (2) inferring learnable causal time lags to associate labels from effects to the cause data to generate a dataset for retraining task models.

Self-labeling is applied to scenarios with interactive causality that represents an unambiguous causal relationship in an interaction between objects. Causality in general has various definitions across disciplines. The nomenclature of Interactive Causality is to emphasize that the causality leveraged for the self-labeling is associated with direct or indirect interactive activities among objects, which helps to identify useful causal relationships in application contexts for self-labeling. Self-labeling leverages the temporal aspect of asynchronous causality, where interaction lengths and intervals are super-imposed on time series data of sensing object states to form associations. In asynchronous causality, from the definition in physics, causes always precede effects, and the causal time lags between the occurrence of causes and effects is also referred to as the interaction time to emphasize the interactivity. Self-labeling is predicated on the assumption that established causal relationships and the interaction time are less mutable than the input-output relations of ML models when there is concept drift, allowing self-labeling to adapt ML models to dynamic changes.

The self-labeling method works in the real-world environments with streaming data instead of static datasets. It captures and annotates samples from the real-time data streaming to generate a retraining dataset for task model domain adaptation because naturally data are acquired as streams in many real-world applications. Note that this does not mean the focus of self-labeling falls into the topics of time series domain adaptation which the self-labeling can be applied to. The self-labeling method aims to assist ML tasks that are pattern recognition tasks accomplished by super-vised machine learning models, which are referred to as task models. The task model is the model for which the self-labeling provides automated procedural continual learning. Suppose an interaction scenario with two objects o1 and o2, as illustrated in FIG. 1, the causal relationship between objects o1 and o2 is known a priori and extracted from the domain knowledge modeling. In this interaction context, the task model can be explained as ingesting the cause data related to o1 to infer the effect on o2. Due to the strong causal relationships, the effect state transitions indicate the state changes of the cause. Therefore, the effect can be utilized to generate labels for the task model. The effect state transitions are detected by the effect state detector (ESD) and constitute labels for training the task model. The temporal interval between cause and effect, defined as interaction time (i.e., causal time lag), is utilized in self-labeling via prediction of the interaction time from effect data only, using a computational model known as the interaction time model (ITM.) The ITM is used to associate effects with the corresponding causes as training data, which accomplishes Step 1 of the data annotation procedure. Thus, inputs and labels are automatically generated for the continual learning of the task model, enabling adaptation to dynamic changes to input and/or output data distribution. The intrinsic causality can be extracted from domain ontology, domain experts, documented knowledge (e.g., standard operating procedure), or even knowledge distilled by large language models and formulated as a dynamic causal knowledge graph (KG) with interactive nodes.

The proof of self-labeling uses a simplified dynamical system where two 1-d systems x and y interact as:

$${x}^{\cdot } = f ( x ) + d ( x ) \qquad ( 1 )$$

$${y}^{\cdot } = y + h ( x ) , \qquad ( 2 )$$

where ƒ(·) defines a vector field, h(·) is the coupling function, and d(x) is the perturbation, simulating the impact of concept drift. Given an initial state (x₁, y₁) and final state (x₂, y₂), x₁ is defined as the cause state and y₂ as the effect state. The ML task is to learn a mapping between cause x₁ and effect y₂ in the x-y interactive relationship.

We describe several key steps relevant to the scope of this paper from the full derivation. The derivation can be summarized in three steps: 1) in the original domain without perturbation, derive a relationship between inferred interaction time t_{if} and y₂ that is to use effect y₂ to infer interaction time; 2) under perturbation derive the relation between t_{if} and the self-labeled x_{slb} that is to use t_{if} to select corresponding x as the self-labeled cause state; 3) cancel out t_{if} to derive the relation between y₂ and x_{slb} that is the learned task model by the self-labeling method. The intermediate steps of the above Step 1 and 2 are summarized as:

$${y}_{2} = {e}^{{t}_{if}} {\int }_{0}^{{t}_{if}} {e}^{- τ} \cdot h ( {A}^{- 1} ( τ + {A}_{{x}_{2}} - {t}_{if} ) ) d τ + {e}^{{t}_{if}} {y}_{1} , and \qquad ( 3 )$$

$${t}_{if} = {B}_{x} 2 - {B}_{x} slb . \qquad ( 4 )$$

The self-labeling method is compared with fully supervised (FS) and conventional semi supervised (SSL) methods by solving the DS to derive:

$${y}_{2 slb} = {e}^{{B}_{{x}_{2}} - {B}_{{x}_{slb}}} \cdot ( {\int }_{0}^{{B}_{{x}_{2}} - {B}_{{x}_{slb}}} {e}^{- τ} h ( {A}^{- 1} ( τ + {A}_{{x}_{2}} - {B}_{{x}_{2}} + {B}_{{x}_{slb}} ) ) d τ + {y}_{1} ) , \qquad ( 5 )$$

$${y}_{2 trad} = {e}^{{A}_{{x}_{2}} - {A}_{{x}_{1}}} \cdot ( {\int }_{0}^{{A}_{{x}_{2}} - {A}_{{x}_{1}}} {e}^{- τ} h ( {A}^{- 1} ( τ + {A}_{{x}_{1}} ) ) d τ + {y}_{1} ) , and \qquad ( 6 )$$

$${y}_{2 s} = {e}^{{B}_{{x}_{2}} - {B}_{{x}_{1}}} \cdot ( {\int }_{0}^{{B}_{{x}_{2}} - {B}_{{x}_{1}}} {e}^{- τ} h ( {B}^{- 1} ( τ + {B}_{{x}_{1}} ) ) d τ + {y}_{1} ) , \qquad ( 7 )$$

where subscripts slb, fs, and trad represent self-labeling, FS, and traditional SSL methods, respectively.

$$A ( x ) = {\int }_{0}^{x} \frac{1}{f ( ξ )} d ξ and B ( x ) = {\int }_{0}^{x} \frac{1}{f ( ξ ) + d ( ξ )} d ξ$$

We use subscript Aₓ₁ to represent A(x₁) and so as B(x).

Given the background, this study will extend the self-labeling theory to multivariate causality and comprehend the research questions.

### Self-Labeling in Multivariate Causal Graph

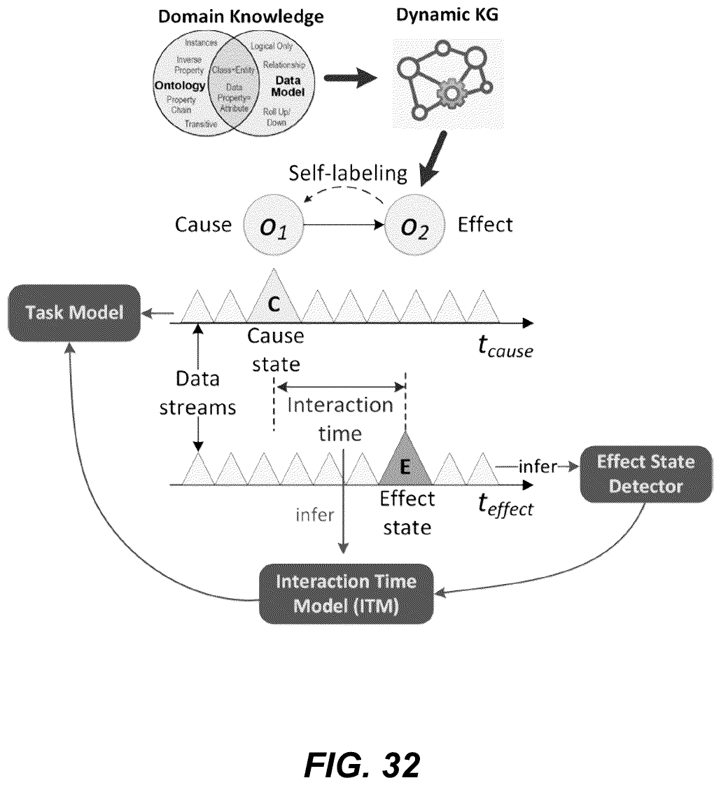

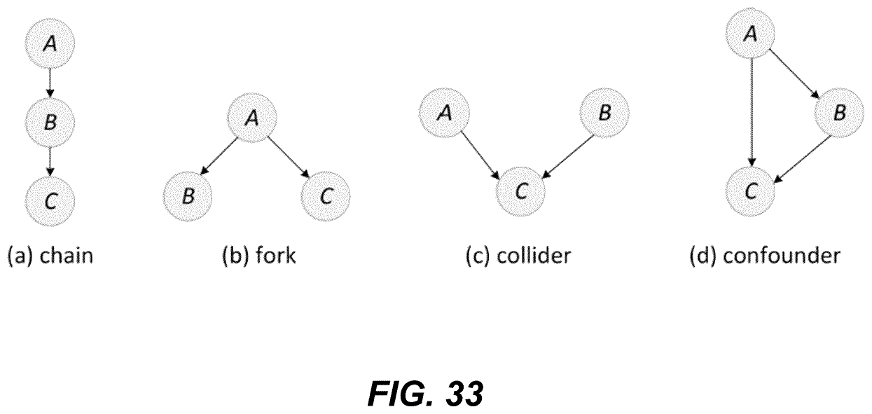

The self-labeling is established on existing causal relationships. With more complex causal systems, causal graphs become an effective tool to rep-resent the relations. A self-labeling scenario on a simple single cause and effect causal structure is illustrated as a foundation in FIG. 32. In structural causal models, there are four basic causal structures, namely chain, collider, fork, and confounder, illustrated in FIG. 33 where nodes are variables and edges describe a forward causal relationship. We explore the application of self-labeling in these basic causal structures and their extension to more complex causal graphs.

Chains are a sequence of nodes forming a direct path from causes to effects. In the minimal example shown in FIG. 33, B acts as a mediator, facilitating the indirect influence of A on C. Forks occur when a single cause produces multiple effects where A is the common cause for effect B and C. Colliders are situations where multiple causes (A and B) converge to produce a single outcome C. A confounder is a third variable A that affects both the cause B and the effect C, making it difficult to establish a direct causal relationship between B and C. Confounders complicate the causal analysis and causal effect inference. These four structures form the basis for most causal relationships and thus will be discussed in this section for their applications in self-labeling.

An emerging question when a causal relationship involves multiple variables is how to organize and leverage the relationships, including interaction time, of each set of variables for self-labeling. Additionally, the undetermined logical relation among variables (e.g., AND/OR/XOR) further complicates the relational analysis for self-labeling. The logical relations referred to here are the function space that maps cause variables to effect variables, e.g. different logical relations of A and B in a collider to generate effect C. The following analysis of interaction time calculation does not assume specific logical relations, and focuses on the state transitions to maximize information available to the ITM. Given a chain structure, the combined interaction time from C to A can be represented as:

$${t}_{CA} = {t}_{CB} + {t}_{BA} \qquad ( 8 )$$

following the sequentially transmitted causal effect. Hence, the interaction time of two pairs of variables in a chain can be directly combined for the self-labeling between A and C. Self-labeling here is invariant to the causal logical relations among the variables as the causal effect is passed independently.

In a fork structure, the multiple effects can individually or jointly label the cause depending on the availability of effect observers. The causal logical relations can limit the effectiveness of a subset or singular variable due to partial observability. In FIG. 33(a), the necessary interaction time is represented as:

$${t}_{AC} = max ( {t}_{A B} , {t}_{A C} ) . \qquad ( 9 )$$

The combination of individual interaction times uses max to capture all effect transitions for self-labeling. FIG. 33(a) depicts an example of a fork with both steady and transient effect states where the combined interaction time is max (t1, t2). The ESD and ITM process relevant portions of signals from B and C to infer the interaction time and label of A. In practice, observing additional effect channels can improve label granularity.

In a collider, multiple cause variables jointly influence an effect variable. Regardless of the logical relations, the cause state changes can be defined between steady states or as transient states as shown in FIGS. 33(b) and 33(c). State transitions between steady states as in FIG. 33(c) are less sensitive to ITM inaccuracies as state information persists after the transient portion of the cause signals. In transient state to capture the information-rich state transitions of each cause variable, an individual ITM is used for each cause-effect pair to extract self-labeling input data. To preserve rich information between the involved relationships, the self-labeled data segments from multiple cause variables can form the input for the task model as a multi-dimensional input, allowing the task model to find discriminative features to learn the relation of A and B with regards to their joint effect C. Similar learning strategies can be adopted for other logical relations.

In the confounding structure, the confounder A affects B and C. If the self-labeled variable pair is B and C, the confounder A functions as an additional cause, which can be treated similarly to a collider. For the self-labeled pair A and C, B forms an intermediate cause and indirect path to the effect. In this case, the effect in C can result from either path, each with distinct interaction times to A. To select the proper interaction time, B must be observed to determine the causal path. However, in practice, a single ITM can be designed to infer the interaction time for A and C through either path by teaching the ITM differentiable characteristics of the two paths.

In a more complex causal graph, the self-labeling schema for the four basic cases can be used as a tool to analyze the interaction time calculus by disentangling a complex graph into the four basic structures.

### Quantitative Analysis of Self-Labeling

This section provides a comprehensive analysis of the ITM and ESD and a comparative cost analysis for self-labeling.

### Inaccuracy of ITM and ESD

In practice, the ITM and ESD used in self-labeling are computational models with inherent inaccuracies. These inaccuracies can result in improper task model training inputs, shifting the learning away from the ground truth. In this section, we study the impact of ITM and ESD inaccuracy on self-labeling performance.

The quantification of ITM inaccuracy is accomplished by imposing an error factor ξₜ on the inferred interaction time t_{if}=G (y₂) in the self-labeling derivation outlined in Section 2, where G(·) represents the inverse function of Eq. (3). We define ξₜ=t^{ξt}/t_{if} where t_{if} is the error-free inferred interact time and the error-imposed inferred interaction time is t^{ξt}_{if}=ξₜG(y₂), where ξₜ=1.1 represents a positive 10% error and ξₜ=0.9 a negative 10% error. The learned y_{2slb} and x_{slb} relation upon a ξₜ inaccurate ITM is

$${y}_{\text{?}}^{\text{?}} = \text{?} \cdot ( {\int }_{0}^{\text{?}} {ε}^{- τ} h ( A \text{?} ( τ + {A}_{{x}_{2}} - \frac{1}{{ξ}_{t}} ( {B}_{{x}_{2}} - {B}_{x \text{?}} ) ) ) d τ + {y}_{1} ) . \qquad ( 10 )$$

$$\text{?} \text{indicates text missing or illegible when filed}$$

To analyze the ITM error's impact on self-labeling, we find the derivative of Eq. (10) to be:

$$\frac{{dy}_{2 slb}^{{ξ}_{t}}}{{dx}_{slb}} = - \frac{1}{{ξ}_{t}} {B}_{{x}_{slb}}^{′} {\text{?}}^{( B - {x}_{2}} - {B}_{{x}_{\text{?}}} ( {y}_{1} + h ( {A}^{- 1} ( {A}_{{x}_{2}} - \frac{1}{{ξ}_{t}} ( {B}_{{x}_{2}} - {B}_{{x}_{slb}} ) ) ) ) . \qquad ( 11 )$$

$$\text{?} \text{indicates text missing or illegible when filed}$$

It is challenging to analytically derive the impact of ξt in Eq. (11). For specific scenarios with numerical representations, the impact of ξt can be analyzed accordingly. We will discuss a numerical example in the next section. An error factor ξe is introduced to quantify the impact of ESD inaccuracy. With both ξt and ξe, Eq. (5) becomes

$${y}_{{2}_{slb}}^{ξ} = \frac{1}{{ξ}_{0}} {e}^{\text{?} ( {B}_{{x}_{2}} - {B}_{{x}_{slb}} )} \cdot ( {\int }_{0}^{\frac{1}{{ξ}_{t}} ( {B}_{{x}_{2}} - {B}_{{x}_{slb}} )} {e}^{- τ} h ( {A}^{- 1} ( τ + {A}_{{x}_{2}} - \frac{1}{{ξ}_{t}} ( {B}_{{x}_{2}} - {B}_{{x}_{slb}} ) ) ) d τ + {y}_{1} ) . \qquad ( 12 )$$

$$\text{?} \text{indicates text missing or illegible when filed}$$

Likewise, the derivative of Eq. (11) can be used to quantify the impact analytically.

Note the conceptual difference between the ground truth interaction time tₜᵣᵤₑ, error-free inference t_{if}, and error-imposed t^{ξt}. This study focuses on ITM model inaccuracy (t_{if} versus t^{ξt}), rather than cases where t_{if} is unequal to tₜᵣᵤₑ due to the perturbation.

### DS Examples for ITM and ESD Quantification

We will use a numerical example of a dynamical system to discuss the impact of ITM and ESD inaccuracy on self-labeling performance. Given ƒ(x)=x, d(x)=x, ξₜ, and ξₑ, we can solve Eq. (1) and Eq. (2) and derive:

$${y}_{2 slb} = \frac{1}{{ξ}_{e}} ( {x}_{2} {log ( {x}_{2} / {x}_{1} )}^{\frac{1}{2 {ξ}_{t}}} + {{y}_{1} ( {x}_{2} / {x}_{1} )}^{\frac{1}{2 {ξ}_{t}}} ) . \qquad ( 13 )$$

Based on Eq. (7), the fully supervised equivalent is:

$${y}_{2 fs} = {x}_{2} - {( {x}_{1} {x}_{2} )}^{2} + {{y}_{1} ( {x}_{2} / {x}_{1} )}^{2} . \qquad ( 14 )$$

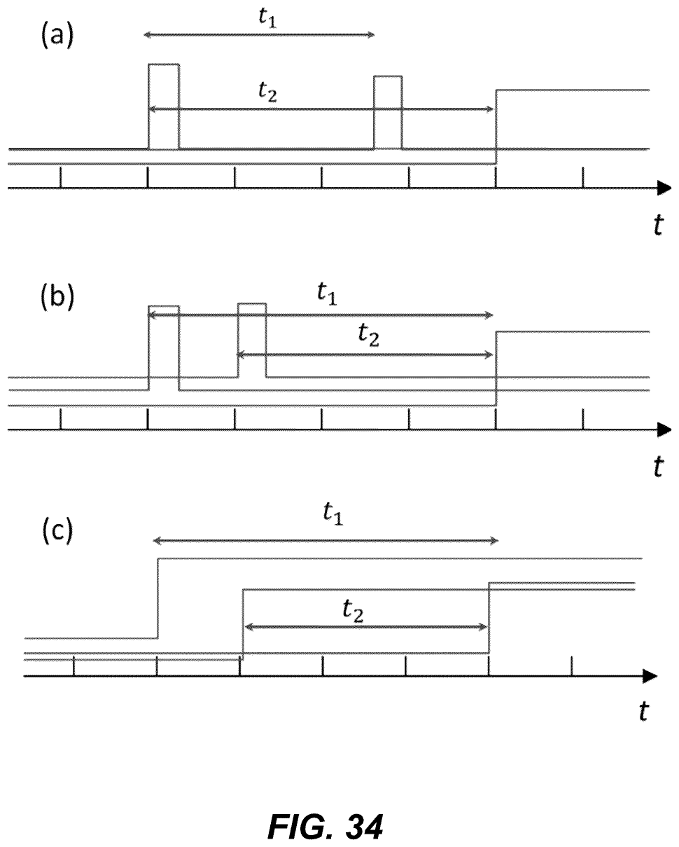

In the numerical self-labeled example above, we can adjust the error factors to visualize ITM and ESD accuracy influence on the learning result. The result is shown in FIG. 34 where ξₜ and ξₑ are changed independently. In FIG. 34, it is evident that self-labeling holds strong potential in ITM and ESD error tolerance given its performance at a 30% error ratio, indicating that in practical applications with non-ideal ITM and ESD models, self-labeling can still retain its overwhelming performance advantage over traditional SSL methods.

### ITM as a Sampling Window

In the self-labeling procedure, the ITM infers the interaction time from effect state change to cause state change. This defines a sampling window on the cause data stream, selecting the relevant data segments. As the sampled data is directly used to train the task model, it is necessary for the ITM to maintain the desired sampling behavior, as described in this section.

The ITM accuracy is necessarily bound by an acceptable error margin ϵ, defined as the deviation of the SLB-learned y_{2slb} from the optimal learning result y_{2fs} for the same x₁. The acceptable bounds for y₂, y_{2low} and y_{2high}, can be expressed as (1−ϵ) y_{2fs}≤y_{2fs}≤(1+ϵ)y_{2fs} in relation to the defined error margin. Substituting y_{2slb} in Eq. (3) with y_{2low} and y_{2high} provides similar bounds t_{iflow} and t_{ifhigh} for t_{if}. For comparison, the actual inferred interaction time and corresponding y₂ are calculated following the regular derivation procedures in Eq. (4) and Eq. (5) and compared with the bounds for y₂ and t_{if}.

Using the numerical example with x₁=80, we can substitute x₁ in Eq. (13) to obtain y_{2fs}=21.7376, the optimal learning result at x₁=80. For ϵ=0.5, y_{2high}=32.6064 and y_{2low}=10.8688, substitution of y_{2slb} by y_{2high} and y_{2low} in y_{2slb}=x₂t_{if}+y₁e^{tif} produces t_{ifhigh}=0.2035 and t_{iflow}=0.0079.

The nominal t_{if} and y_{2slb} can be derived from t_{if}=log^{x2}=0.11157 and y_{2slb}=x₂t_{if}+y₁e^{tif}=22.3373. The values y_{2slb}=22.3373 and t_{if}=0.11157 are within their respective error bounds, indicating that the current ITM sampler is satisfactorily accurate given ϵ=0.5.

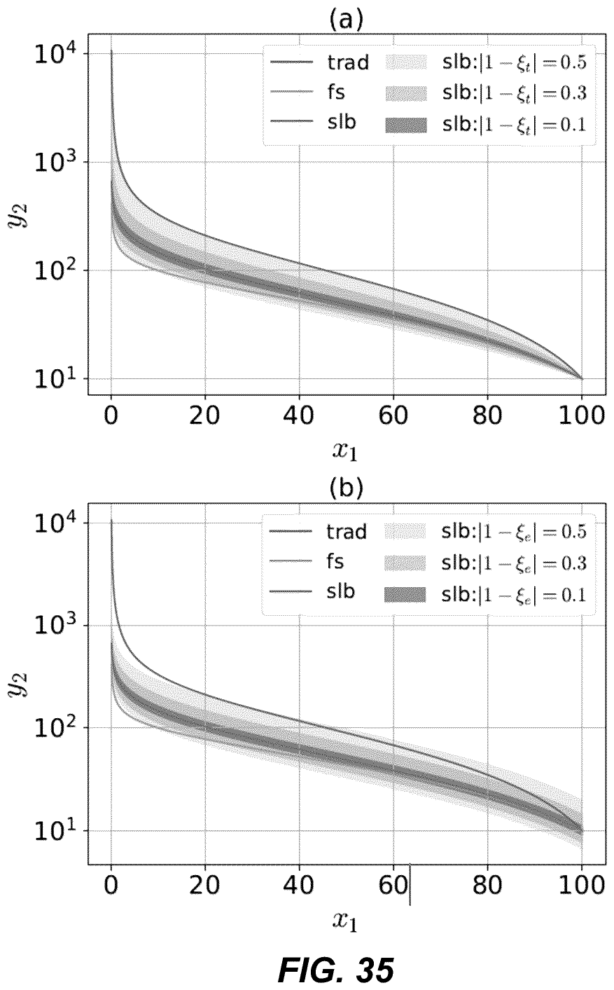

The ITM error bound is visualized in FIG. 35. It can be observed that with higher error tolerance ϵ, the ITM requirement is relaxed, increasing the amount of allowable data samples.

### Cost Assessment of Self-Labeling

The cost of producing an ML model arises not only from electricity consumed for computation but also from the human resources required for data labeling. This section proposes a metric to evaluate the cost and accuracy tradeoff between self-labeled, fully supervised, and semi-supervised learning.

To incorporate the cost of both labor and electricity, a cost index is defined to quantify the additional post-deployment cost for countering concept drift as

$$cost index = Δ acc E + M \qquad ( 15 )$$

where Δacc is accuracy variation after deployment, E represents the electricity cost, and M represents the cost of manual labeling. E and M use the US dollar ($) as their unit and can be represented as a product of the number of data samples n and the unit cost per sample Ce and Cm respectively,

$$E = n \times {C}_{e} \qquad ( 16 )$$

$$M = n \times {C}_{m} \qquad ( 17 )$$

Cm is the labor cost to label a data sample, and Ce, the unit cost of electricity consumption, is estimated by using a product of needed compute time per sample t_{compute}, used GPU power P, and the electricity rate r as

$${C}_{e} = {t}_{compute} ( h ) \times P ( k W ) \times r ( \$ ) . \qquad ( 18 )$$

In the post-deployment stage, self-labeled, fully supervised, and semi-supervised learning each involves differing operations, incurring labor and electricity costs. For self-labeling, post-deployment operations are ITM inference, ESD inference, and retraining on self-labeled datasets. Fully super-vised learning requires manual dataset labeling and retraining on the newly labeled data to achieve continual learning. Semi-supervised learning's post-deployment costs are from continual training exclusively. To simplify the analysis, two assumptions are made: (1) the task model, ITM, and ESD use ML models with equal energy consumption; (2) the energy consumption from continuous ESD inference during periods with no state changes that are candidates for self-labeling is insignificant.

In the pre-deployment stage, the aggregate costs for FS and SSL are identical, namely the labeling and training of a pre-training dataset. SLB incurs additional costs from the labeling of effect state changes and interaction times and the training of ITM and ESD. Hence, the pre-deployment cost of a SLB system is higher than that of FS systems.

Additionally, a coefficient α is introduced to quantify the ratio between the duration needed for training and inference per sample where α×Cetrain=Ceinfer as it is approximated that ITM, ESD, task model are equivalent in energy consumption but operate in different modes during self-labeling.

For cost index_{slb} to be greater than cost index_{fs}, the condition

$$\frac{Δ {acc}_{slb}}{{E}_{slb} + {M}_{slb}} \geq \frac{Δ {acc}_{fs}}{{E}_{fs} + {M}_{fs}} \qquad ( 19 )$$

must be satisfied, resulting in:

$$\frac{Δ {acc}_{sjb}}{Δ {acc}_{fs}} \geq \frac{( 1 + 2 α ) \times {t}_{compute} \times P \times r}{{t}_{compute} \times P \times r + {C}_{m}} \times β , \qquad ( 20 )$$

where β is the ratio of the number of data samples nslb and nfs. Section 5 includes case studies demonstrating these metrics. Note that this analysis is practically meaningful only when both FS and SLB systems can achieve and maintain the desired accuracy despite potential domain shifts after deployment.

### Experiment Results and Discussion

This section provides a simulated experiment to demonstrate the self-labeling method for adaptive ML with complex causal structures and to quantify the impact of ITM and ESD uncertainties experimentally.

### Multi-Cause Simulation and Self-Labeling Experiment

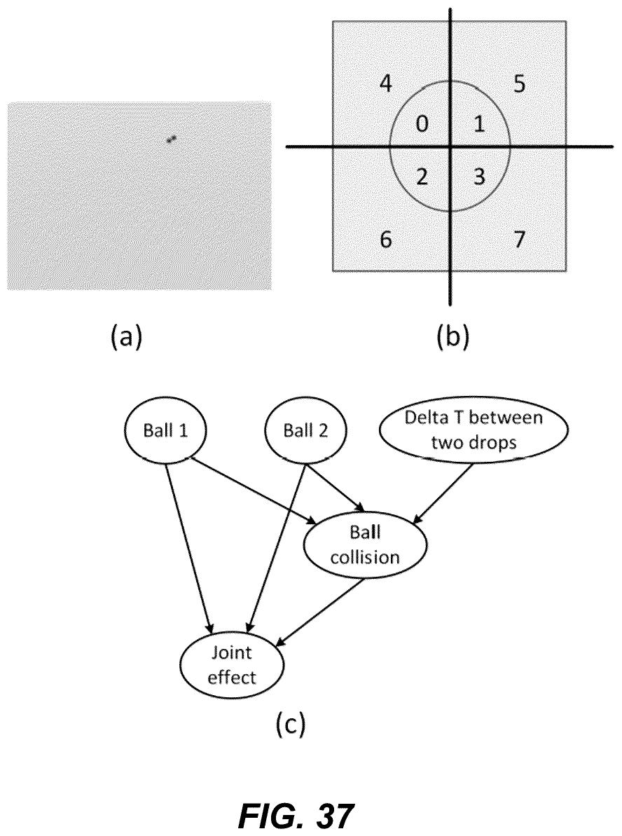

To demonstrate the effectiveness of self-labeling in scenarios with complex causal structures, a simulation with multiple causes is designed and evaluated. TDW with PhysX engine is used to create the simulation environment. In this simulation, two balls are dropped onto a flat surface of size 150×150 at randomized positions and times. The two balls will fall, potentially collide and interact, and eventually settle or reach the preset maximum simulation duration. The initial position of ball 2 is set to be higher than ball 1, and both are constrained in an area of size 20×20 to produce a collision at a roughly 50% rate. Collisions alter the balls' trajectories, complicating the causal structure and forcing the system to consider both causal paths. The final effect is a joint effect representing the distance vector from the final position of ball 1 to the final position of ball 2. The joint effect is discretized by categorizing the distance vector into 8 classes as described in FIG. 37(b) depending on the vectors' angle and magnitude. Robustness to concept drift is tested by applying a perturbation in the form of wind, applied at a randomized bounded time to disturb balls' trajectories. The wind magnitude wind is 0.5 by default and applied randomly to one ball. To penalize inaccurate interaction time inferences greater than the ground truth, the balls are instantiated with an initial horizontal velocity of 0.0025 before dropping. The chosen value of 0.0025 changes the initial distance of colliding balls by an average of 11% and alters their joint behaviors, thus penalizing inaccurate interaction times.

The causal graph for this simulation shown in FIG. 37(c) contains two basic causal structures. The variables representing the initial position of ball 1, the initial position of ball 2, and the final effect form a collider structure. The addition of the possibility of collision creates a confounder structure within the graph.

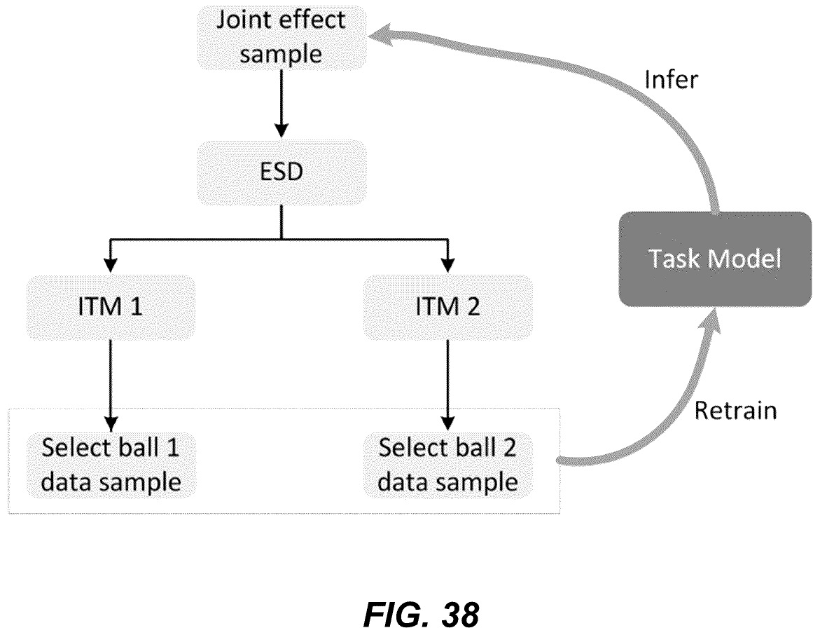

The objective of the task model is to use the two balls' initial properties to infer the class of the distance vector as the joint effect. Thus, the joint effect is used to self-label the cause events. As the cause states are transient, independent ITMs are required for each causal (cause-effect) pair. An interesting observation is that the observation of the ball collision is not necessary to self-label this scenario as the root causes of collision are observed. The holistic self-labeling workflow for this simulation is described in FIG. 38. The two ITMs independently infer interaction times to select cause states from their respective data streams. The selected cause states are then combined as a self-labeled sample to retrain the task model.

Dataset. In total, 11700 class-balanced samples are used. The pre-training set has 600 samples. To simulate the incremental adaptiveness of learning, 360 samples are used per increment in the self-labeled dataset with 25 total increments. The test set is comprised of 1500 samples, and the validation set has 600 samples. The input for the task model is a 6-element vector comprised of the 3-d and planar Euclidean distance of the two balls' initial positions, the 3-d distance vector, and the interval between drops. The input features for the ITMs are vectors with 18 elements, including the 3-d final positions and velocities of the two balls, their relative distance, the joint effect category, and the number of surface rebounds each ball experienced. The two data streams of monitoring each ball's properties before reaching the ground represent the two cause streams. The data stream of the joint effect after two balls reaching the ground represents the effect stream.

Nested k-fold validation is applied to performance evaluation. The task model is a multi-layer perceptron (MLP) of size (32, 64, 128, 256, 128, 64, 32) with ReLU activation, a batch norm layer, and a dropout layer after each linear layer implemented using PyTorch and optimized by AdamW using a weight decay coefficient of 0.0005 and 0.001 learning rate. The batch size is 64 with 600 epochs. Two XGBoost models optimizing for mean squared error loss are used as the ITMs for each cause data stream. ESDs use the categorization rule in FIG. 37(b) to infer labels. When evaluated on the perturbed dataset with wind magnitude wind=0.5, the R2 score for ITM 1 (ball 1) is 0.884, and its Mean Absolute Error (MAE) is 23. The R2 score of ITM 2 (ball 2) is 0.928, and its MAE is 17.7.

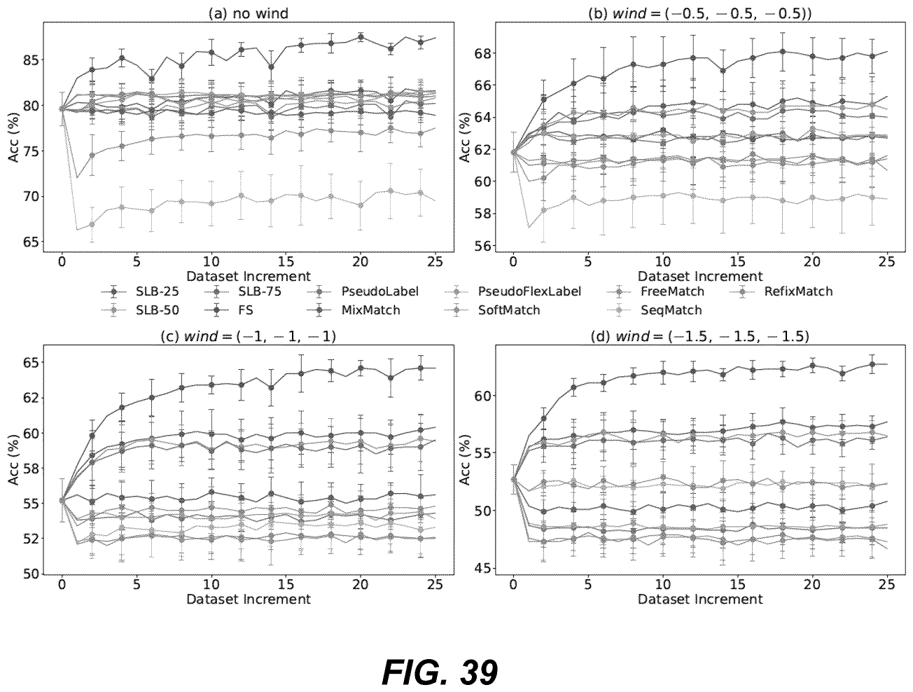

FIG. 39 shows training results for the self-labeling method, fully supervised learning, and five recent semi-supervised methods. Three wind magnitudes (0.5, 1.0, 1.5) are tested to evaluate concept drift resiliency. It can be observed that in the unperturbed case, self-labeling accuracy gradually increases, eventually outperforming other methods as it continues to learn via additional self-labeled samples. In the perturbed cases, self-labeling consistently outperforms other traditional SSL methods, further demonstrating its superiority in adapting to data shifts given complex causal structures. To further validate self-labeling effectiveness, we increase the penalty parameter to 0.005 and 0.0075 with results shown in FIG. 39. With an increased penalty, self-labeling performance is degraded but still outperforms traditional SSL in concept drift adaptation.

### Non-Ideal ITM and ESD

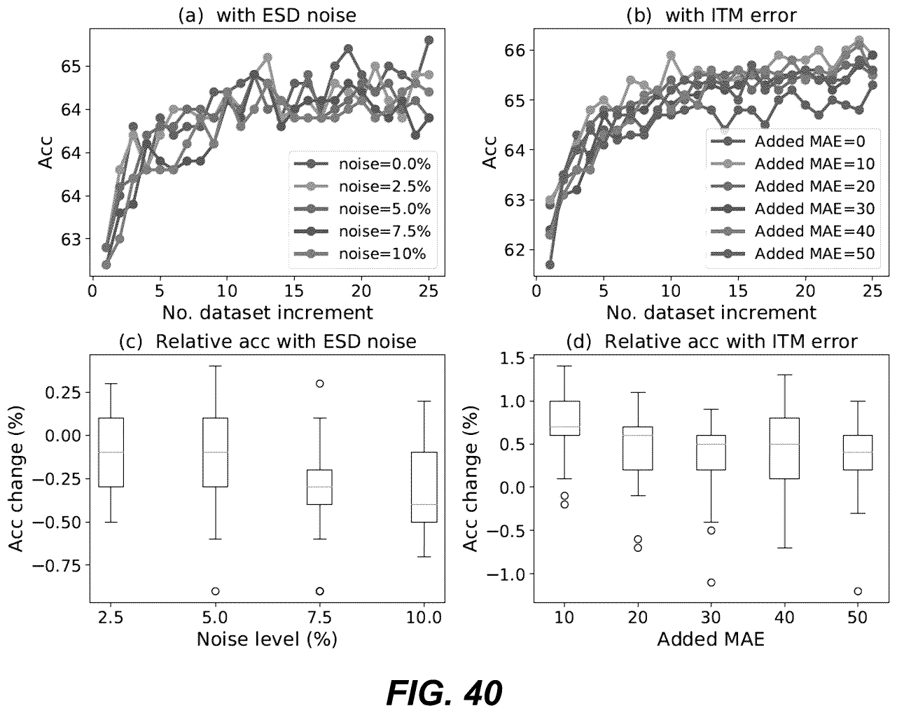

The impact of ESD inaccuracy is quantitatively tested using the multi-variate simulation. We intentionally control ESD label noise by randomizing a portion of the ESD output to observe its effect on self-labeling performance. FIG. 40 shows the experimental results with four levels of label noise in the perturbed case with wind=0.5. The result in FIGS. 40(a) and 40(c) shows that ESD label noise both increases volatility and degrades self-labeling performance. The performance deterioration is mild, with an average decrease of 0.32% at 10% noise level, demonstrating the robustness of the self-labeling method against ESD inaccuracy.

Additionally, the impact of ITM performance on task model accuracy is also shown. This experiment quantifies the impact of ITM errors by modifying the baseline ITM output. While the baseline ITM output is not error-free in reality, we approximate it to be error-free for the purposes of this comparison. Additive MAE with random sign (positive or negative) is introduced to the baseline ITM error level, sampled from a Gaussian distribution with parameterized mean and variance. The variance is set as half of the mean which ranges from 0 to 50 with a step size of 10. We can observe that with this random error added, SLB performance is slightly improved. In this perturbed case, as the ITMs are trained in the original domain, ITM inference is incongruent with perturbed interaction times and inherently deviates from the ground truth. The additive error can either improve or worsen this deviation. Its randomness functions as a compensation element in the self-labeling methodology, which can be beneficial to self-labeling performance, as shown in FIG. 40(d). These experiments confirm the applicability of self-labeling in real-world applications with tolerance for imperfect ESD and ITM implementations.

### Cost Analysis Experiment

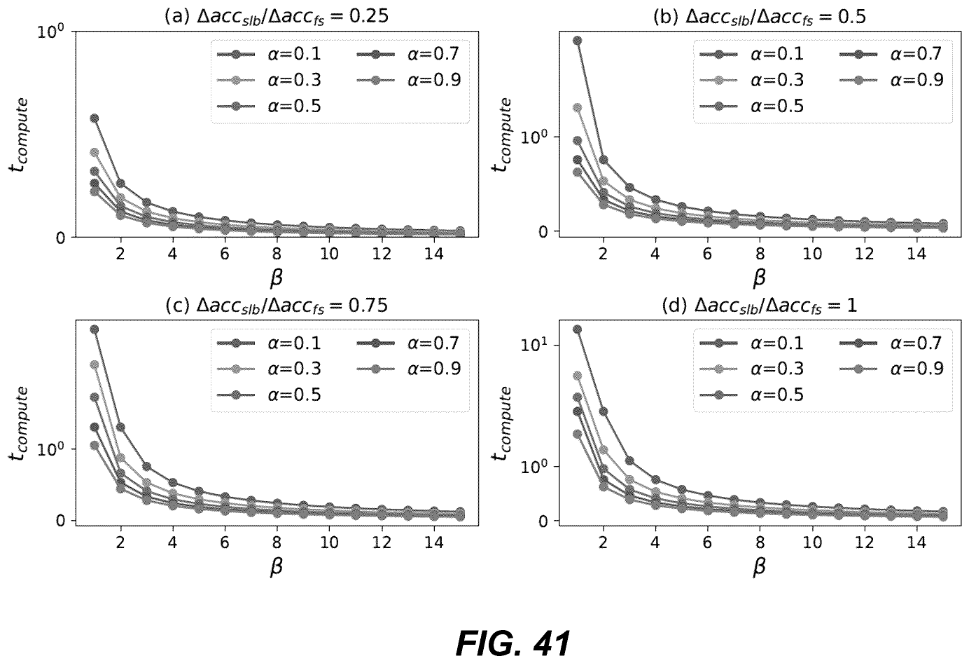

Based on experimental figures and estimated values, we can perform a cost index analysis. Amazon SageMaker Ground Truth charges approximately Cm=0.104 per label, a sum of the price per each reviewed object ($0.08) and the price of Named Entity Recognition ($0.024). Reasonable estimations can be made for α, P, and r in Eq. (19). Modern GPUs consume 200 to 450 Watts, and a nominal 400 W consumption (NVIDIA A100) is used in this study. The industrial electricity rate in the US is about $0.05 to $0.17 per kWh, and the average r=$0.09 is used in the following analysis3. Empirically, the ratio of inference to training time α is low, such that 0.1≤α≤1. t_{compute} is highly dependent on model size and Δaccslb/Δaccfs is determined experimentally. FIG. 41 plots the derived t_{compute} against α, β, and Δaccslb/Δaccfs.

We can approximate

$$\frac{Δ a c c s l b}{Δ a c c f s} = 0.5$$

when β=1. Empirically, we make the conservative estimate α=0.5. Given the estimated parameters above, Eq. (19) can be solved to find that t_{compute}≤1.3 h, being that if the average training time per sample on a single GPU is less than 1.3 hours, cost index_{slb}≥ cost index_{fs}. In practice, this condition is easily satisfied. FIG. 10 provides additional insights and comparisons. It is necessary to evaluate cost across β as SLB may require more data than FS to achieve the same accuracy. In an extreme case where β=15, α=0.9,

$$\frac{Δ a c c s l b}{Δ a c c f s} = 0.25 ,$$

we find t_{compute}≤1 min. For many mainstream image processing algorithms, e.g., a benchmark by NVIDIA using A100 with ResNet50, t_{compute}=0.27 s in training with 250 epoch, satisfying the t_{compute} requirement of 1 minute.

Overall, with common α and β values, SLB is generally cost-efficient relative to FS as long as both methods reach the desired accuracy for the application. This remains true as long as manual labeling costs far exceed the electricity costs per unit trained.

### Discussion

ITM and ESD error in real applications. This paper uses a simulation to validate that self-labeling has a high tolerance for ITM and ESD noise. Previous studies have shown that deep learning (DL) models are relatively robust to certain label noise levels. While the ESD performance directly determines the label noise, the ITM is the input sampler for cause states in the cause data stream, selecting a period of samples in the cause data stream as the training input. The ITM error tolerance arises from the smoothness of state change transients in the real world. For example, a ball's movement and trajectory are smooth such that deviated interaction times can preserve the trend of motion for ML. However, as DL model tolerance for temporal shifts in input data has not yet been widely studied, this input nonideality appears in self-labeling and requires future study. Intuitively, ITM errors shift the sampling window, which may exclude moments with high information density or differentiating features, greatly hampering model performance. In addition, in practical applications, ESD noise has a second-order effect on ITM performance, as the ESD output may be included in the ITM input. This second-order effect can be studied in the future.

Cost analysis. It is evident that fully supervised learning has greater accuracy and resource consumption than methods on the unsupervised spectrum. This paper presents a cost index, including labor costs for data annotation, to compare the adaptive learning performance of FS and SLB. Despite traditional semi-supervised learning's advantage in resource consumption as calculated using equations in Eq. (14), it is not included in this analysis as, experimentally, it has been found to achieve no observable or consistent accuracy improvement with increased data in the simulated experiment. Outside of the two assumptions, it is important to consider the accuracy figure achieved by self-labeling. The proposed metric does not account for the impact of accuracy in practical applications, where minor decreases in performance may result in a great impact on user experience.

Domain knowledge modeling. This work relies on causality extracted from existing knowledge. Besides documented knowledge or domain experts, the potential of large language models (LLMs) reveals a rich knowledge base for extracting causality. Several pioneer works have demonstrated that LLMs are able to answer several types of causal questions, while some work argues LLMs' ability of discovering novel causality. Using LLMs as the initial causal knowledge base for the proposed interactive causality-based self-labeling method will be an inspiring future work.

This application addresses several remaining questions in the interactive causality enabled self-labeling including multivariate causality application, robustness towards ITM and ESD error, and a cost and tradeoff analysis including manpower for self-labeling. The demonstration in this study further enhances the application values of self-labeling. More theoretical development of the interactive causality driven self-labeling is discussed as the future work in this direction.

The integration of real-time machine learning (ML) technology into cyber-physical systems (CPS), such as smart manufacturing, requires a hardware and software platform to orchestrate sensor data streams, ML application deployments, and data visualization to provide actionable intelligence. Contemporary manufacturing systems leverage advanced cyber technologies such as Internet of Things (IoT) systems, service-oriented architectures, microservices, and data lakes and warehouses. ML applications can be integrated with existing tools to support and enable smart manufacturing systems. For example, Yen et al., developed a software-as-a-service (SaaS) framework for managing manufacturing system health with IoT sensor integration that can facilitate data and knowledge sharing. Mourtzis et al., proposed an IIoT system for small and medium-sized manufacturers (SMMs) incorporating big data software engineering technologies to process generation and transmission of data at the terabyte-scale monthly for a shop floor with 100 machines. Liu et al., designed a service-oriented IIoT gateway and data schemas for just-enough information capture to facilitate efficient data management and transmission in a cloud manufacturing paradigm. Sheng et al., proposed a multimodal ML-based quality check for CNC machines deployed using edge (sensor data acquisition) to cloud (Deep Learning compute) collaboration. Morariu et al., designed an end-to-end big data software architecture for predictive scheduling in service-oriented cloud manufacturing systems. Paleyes et al., summarized the challenges in deploying machine learning systems in each stage of the ML lifecycle. For manufacturing companies especially SMMs, the relatively outdated IT infrastructure, lack of IT expertise, and heterogeneous nature of manufacturing software and hardware systems complicate ML application deployment. While systems in the literature have demonstrated various ML applications, they lack support for adaptive ML.

A major component of the cyber manufacturing paradigm is actionable intelligence, providing users with critical in-formation to act at the right time and place. Manufacturers significantly favor personalized intelligence for its ability to adapt to their specific use cases. However, barriers exist to the development and deployment of personalized ML systems in manufacturing environments. The cost of manually collecting and annotating a training dataset slows the democratization of ML-enhanced smart manufacturing systems, especially in SMMs. Recently, the development of adaptive machine learning, which autonomously adapts ML models to diverse deployment environments, has become a viable solution to lower the entry barrier to ML for SMMs. Several types of adaptive ML methods, including pseudo-labels empowered by semi-supervised learning (SSL), delayed labels, and domain knowledge enabled learning, have been proposed.

A novel interactive causality based self-labeling method has been proposed to achieve adaptive machine learning and has been demonstrated in manufacturing cyber-physical system applications. This method utilizes causal relationships extracted from domain knowledge to enable an automatic post-deployment self-labeling workflow to adapt ML models to local environments. The self-labeling method works in real time to automatically capture and label data and is able to effectively utilize limited pre-allocated or public datasets. Self-labeling is a coordinated effort between three types of computational models, namely task models, effect state detectors (ESDs), and interaction time models (ITMs), to execute the self-labeling workflow for adapting task models after deployment. The merit of the self-labeling method is in its ability to fully leverage the unique properties of ML applications in CPS contexts, including scenarios with rich domain knowledge, dynamic environments with time-series data and possible data shifts, and diverse environments with limited pre-allocated datasets to fulfill the needs of personalized solutions at the edge.

To support and execute the interactive causality based self-labeling (SLB) method, especially for SMMs, the system infrastructure must support the following requirements: 1) real time timestamped data transfer of sensor, audio, and video data from heterogeneous services and devices; 2) a causality knowledge base that manages the interaction between models to facilitate self-labeled ML between causally related nodes. 3) a core self-labeling service that connects the ML services, routes data streams, executes the self-labeling workflow, and retrains and redeploys ML models autonomously at the edge; 4) a scalable architecture to easily accommodate new edge, ML, and SLB services. Due to the unique needs of interactive causality, a novel software system is required to realize self-labeling functionality for various ML models. This software system harnesses real-time IoT sensor data, ML, and self-labeling services to enable self-labeling adaption of models to ever-changing environments.

In this paper, we propose and implement the AdaptIoT system as a platform to develop cyber manufacturing applications with adaptive ML capability. The AdaptIoT platform employs mainstream software engineering practices to achieve an affordable, scalable, actionable, and portable (ASAP) solution for SMMs. AdaptIoT defines an end-to-end IoT data streaming pipeline that supports high throughput (≥100 k msg/s) and low latency (≤1 s) sensor data streaming via HTTP and defines a standard interface to integrate ML applications that ingest sensor data streams for inference. The most important feature of AdaptIoT is its inherent support for self-labeling, managing various computational models (e.g., ML models) to automatically execute flexible self-labeling workflow to collect and annotate data without human intervention to retrain and redeploy ML models. A causality knowledge base is incorporated to store and manage the virtual interactions among computational models for self-labeling. AdaptIoT employs a scalable micro-service architecture that can easily integrate future capabilities such as data shift monitoring. We deploy AdaptIoT in a small-scale makerspace to simulate its application in SMMs and develop a self-labeling application using the AdaptIoT platform, demonstrating its applicability and the adaptive ML capability of AdaptIoT in real-world environments. Part of the platform source code is open-sourced at https://github.com/yuk-kei/iot-platform-backend.

### Exemplary Interactive Causality and Self-Labeling Technique

The Interactive Causality enabled self-labeling (SLB) method is developed to achieve fully automatic post-deployment adaptive learning for ML systems such that deployed ML models can adapt to local data distribution changes (e.g., concept drift.) This section includes a brief review of the self-labeling technique.

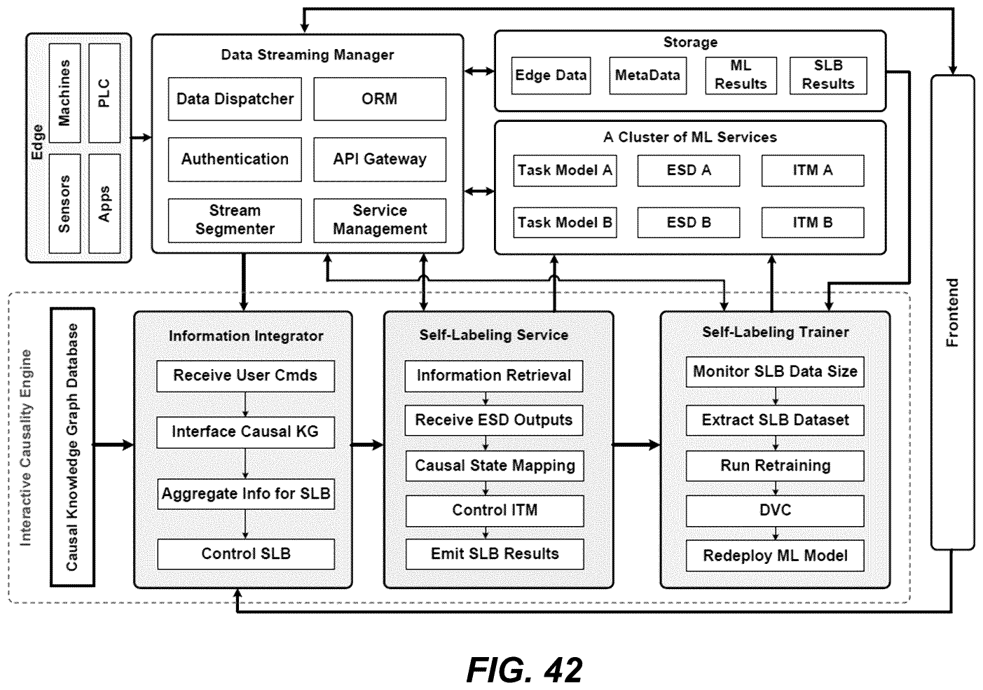

Self-labeling begins with selecting two causally connected nodes within a dynamic causal knowledge graph (KG), which can be obtained from domain knowledge and ontology. In the minimum case where the selected nodes are adjacent, the cause-and-effect events are related by an interaction time between their occurrences. This interaction time can vary but typically has a correlation with the effect state transient. SLB requires monitoring one or more data streams so that the cause-and-effect state transitions can be observed. In FIG. 42, the cause-and-effect time-series data streams are collected at nodes o1 and o2 respectively. The first of the three models required for SLB is the effect state detector (ESD), which monitors the data streams that provide effect data and is responsible for identifying effect state transients, including classification. The interaction time model (ITM) intakes the effect data within windows selected by the ESD, optionally including the ESD output, and predicts the interaction time (i.e., causal time lag) between the cause-and-effect state transitions. The relevant portion of the cause data stream is extracted using the effect state transition timestamp determined by the ESD and the interaction time output by ITM. With the cause data associated with effect state transitions, we use effect transitions as the label and cause data as the input features to train the task model.

The task model is our primary decision model, enriched by SLB through continual learning. Continual learning through self-labeling is particularly beneficial in scenarios where the input and/or output data distributions shift from their values during initial training. The relationship between cause and effect is resilient to drifts in data, and this resiliency is inherited by the self-labeling method to provide a basis for continual learning. Time-series data streams are collected for each system, with the causal relationship defining a cause and an effect system. A key advantage of the self-labeling method is its ability to independently detect and label the effect system and propagate said label to the relevant time-series data in the cause system, automating the continual learning described above. This allows for a robust predictive classifier to be implemented without necessitating human intervention to facilitate continual learning.

### AdaptIoT Self-Labeling

In an exemplary embodiment, the following systems and methods illustrate an exemplary AdaptIoT modular software architecture and specialized modules for self-labeling applications.

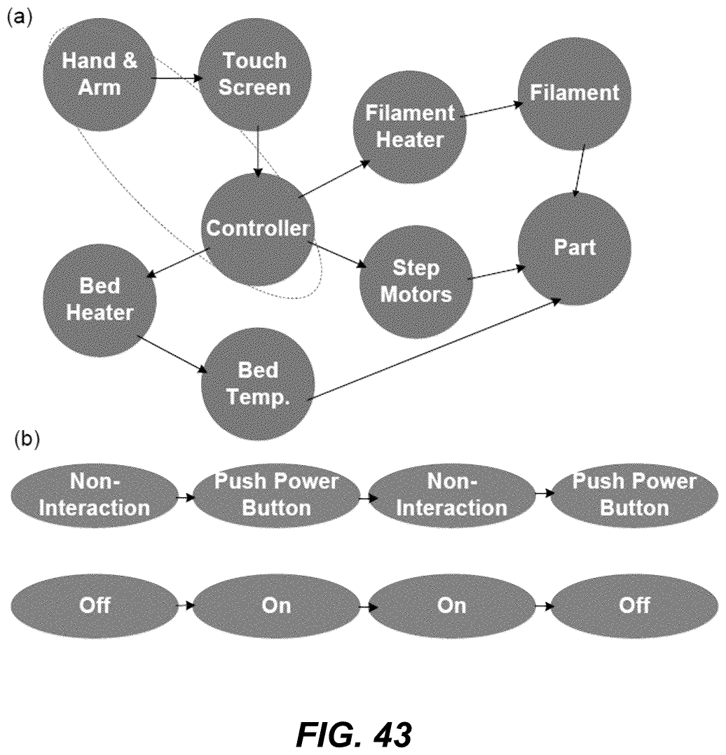

To meet the unique requirements of self-labeling applications, a high-level system block diagram is illustrated in FIG. 43. The major functional modules of the system are composed of edge services, the Data Streaming Manager (DSM), databases for storage, and clusters of ML services (note that even though named as ML services for generalizability, some of them can be simple data/signal processing or statistical models), the Interaction Causality Engine (ICE), and a frontend Graphical User Interface (GUI) handler. The edge services comprise of sensors, edge computing de-vices, external applications, and machines on the factory floor. The in situ edge services stream data via the DSM to databases and applications, including the ICE and ML services. The DSM is the main message broker, routing high-throughput streaming data generated by edge, ML, and ICE services to their destination. The DSM serves as the backend for data streaming and service management.

To efficiently store various types of data, multiple database types are implemented, including time-series databases, SQL, and no-SQL databases. The databases store raw timestamped sensor data, metadata for services and devices, processed ML results, and self-labeling results. In addition, a cluster of ML services, including task models, ESDs, and ITMs, runs to provide actionable intelligence while participating in the self-labeling workflow.

### Interactive Causality Engine

The Interactive Causality Engine (ICE) is the core engine enabling adaptability for deployed ML task models. ICE consists of a causal knowledge graph database, an information integrator, a self-labeling service, and a self-labeling trainer. The four components undertake different tasks and jointly execute the self-labeling workflow in an automatic manner.

The causal knowledge graph database stores multiple KGs with directional links that represent the interactivity and underlying causality among the linked nodes. These KGs are extracted and reformulated from existing domain knowledge. A simplified KG sample of a 3D printer is shown in FIG. 43(a). A direct link in this graph represents interactivity, and connections between nodes suggest the possibility of causality between the nodes. The links in the KG can be bidirectional, differing from many causal graph model definitions (such as structural causal models) as the low-level causal relationships between connected nodes are broken down into state-level representations in the temporal scale. In simple terms, at a high level two bilaterally linked nodes can be mutually causally related but at finer temporal resolutions, in any instance one side serves exclusively as the cause and the other as the effect. Given two connected nodes, the state transition mappings (i.e., logical relations) of two nodes are represented as a dynamic and temporal state machine as exemplified in FIG. 43(b). We represent this state machine with corresponding state transition relationships by using a truth table.

The information integrator bridges the causal KG database, the self-labeling service, sensor metadata, ML services, and users to ingest and integrate needed information and control the self-labeling. Through the information integrator, users can start or stop a self-labeling workflow among the causally linked nodes. The information integrator also scrutinizes the information completeness for running a self-labeling service. The self-labeling service receives inputs from the information integrator and initiates a self-labeling workflow by coordinating the raw data streams from sensors, corresponding ML services, and the self-labeling trainer. When a self-labeling service starts, the following functions will be executed: 1) receive control signals from the information integrator to start or stop a self-labeling workflow; 2) receive inputs from the information integrator, including the selected causal nodes, the truth table representing the causal logical relations, the URLs of corresponding sensor streams and ML services, and the output paths (URLs); 3) receive outputs from ESDs and execute causal state mapping to find consistent cause states; 4) assemble inputs for ITMs and route them to corresponding ITMs; 5) receive ITM outputs, combine ITM outputs with corresponding cause states, and emit them to a database for storage; 6) optionally select corresponding data segments from cause streams based on the information in Step 5. Note that since the actual interaction time of each effect can be very different, Step 3 inspects whether to self-label the causes needs to wait additional effect states being detected. The self-labeling service can run multiple self-labeling workflows in parallel for various nodes in KGs.

The self-labeling trainer is an independent and decoupled service that constantly monitors the number of self-labeled samples, receives users' commands via the information integrator, retrains task models, and redeploys the task models. It is designed to be separate from the self-labeling service for reusability and extensibility. The self-labeling trainer will schedule a training session at non-peak hours when the number of self-labeled samples reaches the requirements with user approval. In addition, data version control (DVC) is applied to version self-labeled datasets and trained weight files for MLOps to efficiently manage the continuous retraining empowered by self-labeling. After retraining, users can choose whether to redeploy the task model with the new weights.

### Unit Service Model

To connect and scale to heterogeneous edge services and ML services, an abstract layer-wise unit service model is designed to work as the fundamental architecture for a single service in the proposed AdaptIoT system. The unit service model is designed to accommodate and standardize all types of services in the system that generates data and sends generated data to a storage place. This layer-wise architecture for a single service ensures the scalability and homogeneity of downstream interfaces. The unit service model is abstracted into four layers from the bottom up: the asset layer, data generation (DataGen) layer, service layer, and API layer.

Asset layer defines an abstraction of the independent com-ponents connected to the system, such as hardware (e.g., sensors and machines), external applications (e.g., proprietary software), or external data sources (e.g., external database). A key uniqueness for this layer is that the system can interface with the independent components to receive data or run applications but cannot control or access their sources.

The data generation layer encapsulates a software that generates one data sample upon called once. This layer performs the core function of data generation by interacting with the Asset layer. A higher-level abstraction of heterogeneous edge applications is achieved in this layer by defining uniform Class attributes and functions. For example, the sensor firmware as the asset layer communicates with the DataGen layer to retrieve one data sample per call. The inference function of a ML model using various ML frameworks, e.g., scikit-learn, PyTorch, or Tensorflow, is unified with the same interface to interact with the Service layer. To receive data generated by external applications, we define a Receiver function using REST API to accept a POST request from external applications and data sources. The POST request after scrutinization is rerouted in the Receiver for the DataGen layer to use GET to acquire samples individually.

The Service layer integrates necessary functions as a microservice on top of the data generation. It handles receiving inputs from upper API layers, i.e., inputs needed for ML inference in the DataGen layer. It integrates the inputs and the DataGen layer to generate data in a discrete or continuous way. Upon new data is generated, an emitter function is executed to send out data to the following pipeline. Besides interacting with the DataGen layer, the Service layer integrates other auxiliary functions, including control (i.e., start, stop, update), service registration, and metadata management, for the API endpoints in the API layer. Up to this layer, all the heterogeneous applications from the bottom are consolidated with a homogeneous interface.

The top layer is the API layer, where the API endpoints are defined using a web framework. This layer handles all the API-level I/O and interactions with other services by calling functions defined in the Service layer. Besides the four basic layers, an orchestration layer is designed to moderate the same type of services with same or different configurations operating on the same hardware. This layer is optional, depending on the actual needs of service orchestration.

### System Implementation and Analysis

This section details the system implementation of AdaptIoT, including the software and hardware infrastructure, and provides an example implementation of a self-labeling service hosted on AdaptIoT.

### Hardware Infrastructure of the Cyber MakerSpace

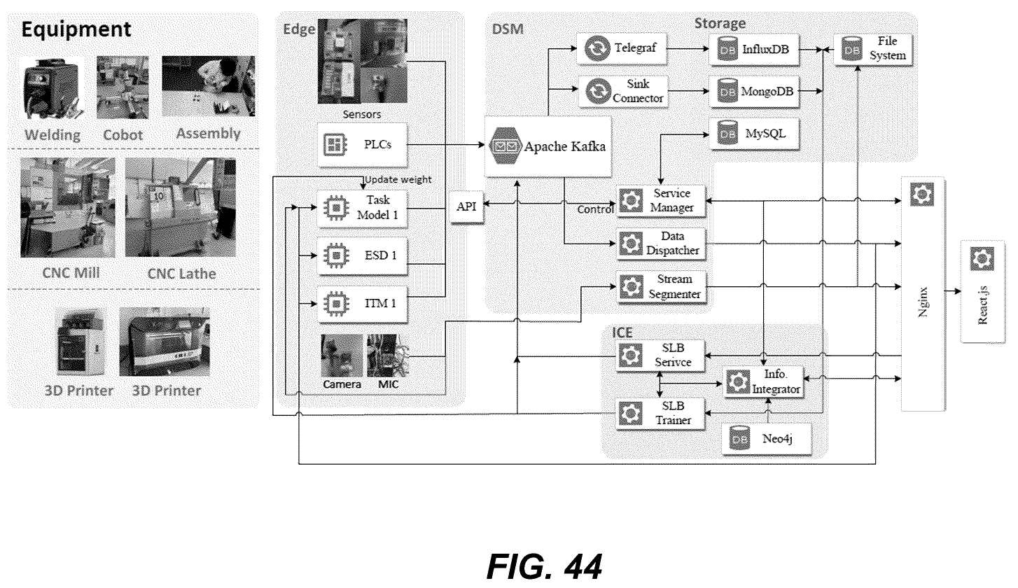

FIG. 44 illustrates a complete implementation of the pro-posed AdaptIoT system for self-labeling applications and the hardware infrastructure, including manufacturing equipment. This system is deployed to a cyber makerspace lab with common manufacturing equipment including 3D printers, CNC Machines (Mill and Lathe), a collaborative robot, and TIG welding machines. We heavily instrument each machine and the entire space with sensors to collect multimodal signals, including cameras, power meters, vibration, acoustic, distance, environmental, and other specialized sensors. The sensors are installed at multiple locations and critical components of a machine. In addition, the CNC machines and the robot are controlled by programmable logic controllers (PLCs) that are interfaced to acquire information about machine running status directly.

### AdaptIoT System Implementation

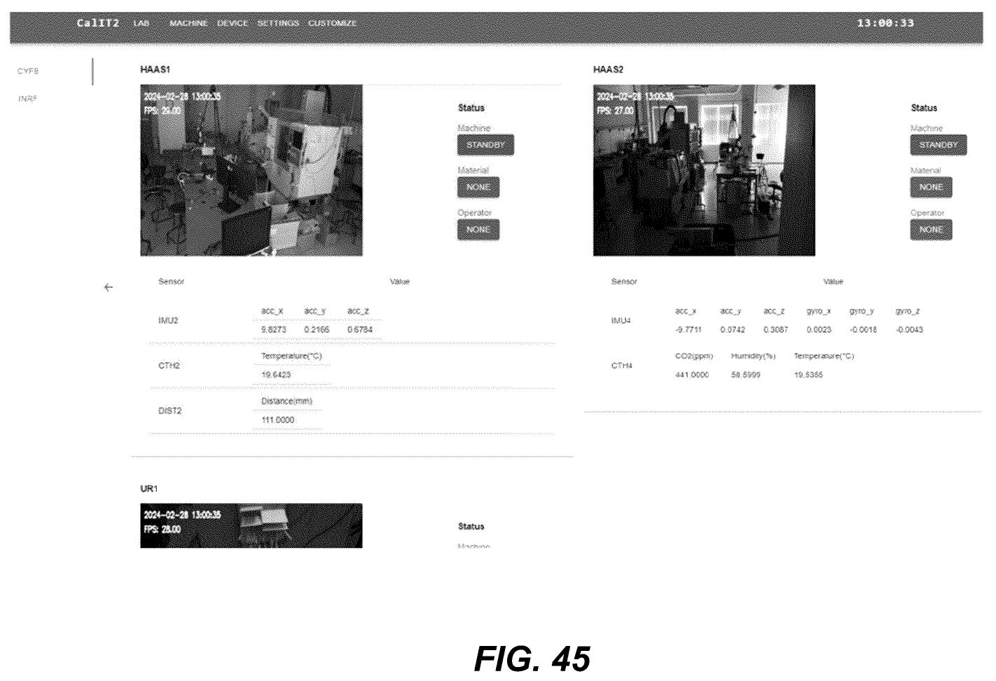

The implemented services and software components are shown in FIG. 44 with examples of edge services. FIG. 45 shows an example of the web-based GUI. Each block in FIG. 44 represents an independent dockerized web service running on various hardware and executes one or more functions as described in FIG. 43. Except for databases, all other communications among services are via REST API by the lightweight Flask web framework. Four services, service manager, data dispatcher, stream segmenter, and information integrator, are exposed to the React frontend via Nginx. The internal APIs are hidden behind the four previously mentioned services.

Software Components: Message queue. A message queue is a communication method used in distributed systems and computer networks for asynchronous communication between various components or processes. The key feature of a message queue is that it decouples the producers and consumers in terms of time and space. Producers and consumers do not need to run simultaneously or on the same machine. This decoupling is useful in building scalable and flexible systems, as components can communicate without being directly aware of each other. Due to these features, we choose a message queue as the main message broker in DSM. Popular message queue systems include Apache Kafka, RabbitMQ, and Apache ActiveMQ. This study uses Kafka due to its outstanding horizontal scalability and high throughput.

Database and storage. Several types of data are needed to be stored, and accordingly, several types of storage are chosen. We consider the factors including data structure, throughput, size, access frequency, and scalability. A MySQL database stores static metadata for all the services and users. For example, the relational metadata for a sensor service includes its factory locations, associated machines, vendor information, and URL for getting data. An IoT system with streaming sensors requires a continuous high data throughput (e.g., ≥10 k samples/sec), which puts additional demand on database ingestion speed. Time series databases are typically designed to handle high throughput, especially in scenarios with a continuous influx of timestamped data. For storing high-throughput sensor data, a time-series database InfluxDB is chosen. Regarding the results generated by ML services, we use both MongoDB and MySQL, depending on the data types. In addition, a graph database Neo4j is chosen to store the causal knowledge graph. Video and audio data are stored in file systems only.

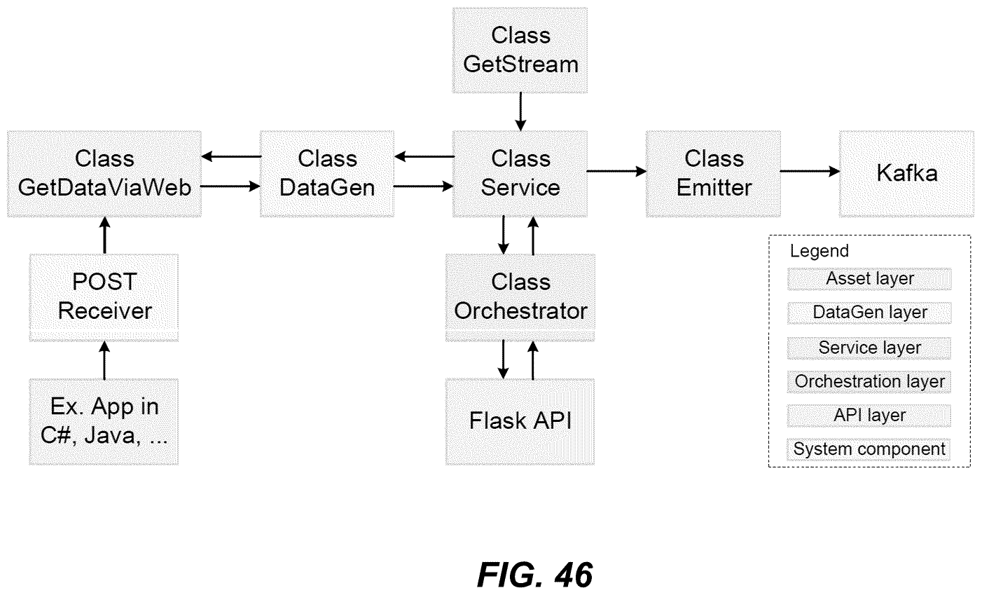

Implementation of the unit service model. FIG. 46 describes the detailed implementation of a unit service model in connecting with an external application. Starting from the asset layer, external applications in various languages and platforms can post an authenticated JSON format message via REST API to the Receiver from which an asset layer function GetDataViaWeb can get data. The Receiver connects with the API gateway to serve as the system-level data ingestion service for external data sources. The DataGen class calls GetDataViaWeb continuously to acquire the JSON message and wrap it into a defined standard message format. The Service class in the service layer integrates DataGen and input sources GetStream to execute service-level functions. The received inputs from GetStream in JSON format are transmitted downwards to the data generation layer and possibly asset layer for processing. In class Service, the generated data is sent to an Emitter that manages all the data transmission to Kafka. An Orchestrator stays on top of multiple Service of same type for control and interaction with other unit services. A Flask API layer provides a lightweight web server for each unit service and defines the API endpoints on the top.

Data Flow: As an illustration, we will describe a complete data flow in AdaptIoT from an edge sensor to an ML service. An edge sensor encapsulated in a unit service model generates a sample and emits it to the Kafka cluster. In the Kafka cluster, the sample is allocated to a partition for processing, after which this sample is routed to two places. First, the sample is routed by Telegraf to the InfluxDB for persistence. In the meantime, due to the unique requirement of many ML applications that need continuous data processing, the Data Dispatcher is implemented to route received individual samples into an HTTP data streaming via Server Sent Events (SSE) and a query interface via REST API. ML services that need this data stream can use the standard HTTP method to receive the stream. The inferred ML results are emitted to Kafka again and routed to the corresponding MongoDB and data dispatcher. The React frontend queries the APIs for visualization.

### ICE Implementation

Two types of data structures are used to represent the causality among nodes in a KG and the exact causal logical relations between any selected nodes. For the causal knowledge graph, we use a graph database Neo4j to represent the nodes, attributes of nodes, and the directional relationships among nodes. The truth table is used to represent various causal logical relations among arbitrary nodes. The truth tables are stored in a MongoDB in key-value pairs.

We define a standard class SlbService that can apply the self-labeling method on any causally related ML services given relevant parameters. The outputs of self-labeling are three key values by fusing the outputs of ESD and ITM, including a corresponding cause state, a timestamp of the end of the cause state, and the duration of the cause state. To partition the cause data streams based on self-labeling results, the system supports operation in two modes. Mode 1 saves the raw self-labeling outputs in MongoDB that are used to generate a retraining dataset by the SLB trainer afterward. Mode 2 is to create self-labeled data samples on the fly when SlbService is running to provide immediate feedback for users. Both modes can be turned on at the same time. The SLB trainer independently monitors the number of self-labeled samples by querying the database at a constant frequency and manages ML training scripts for retraining ML models.

Negative Samples. Similar to other natural label-based systems, i.e., social media recommendation systems where users' interactions (likes, views, comments) are used as positive labels, in many cases, the ESD can only provide positive labels when there are state transitions different from the background distribution. The acquisition of negative samples from the background data distribution follows the same strategy as recommendation systems via negative sampling or more advanced importance sampling. The negative sampling is undertaken by each ESD since ESD keeps a buffer of its own historical states. The ESD randomly samples the background distribution as the negative labels and sends them to the self-labeling service for processing.

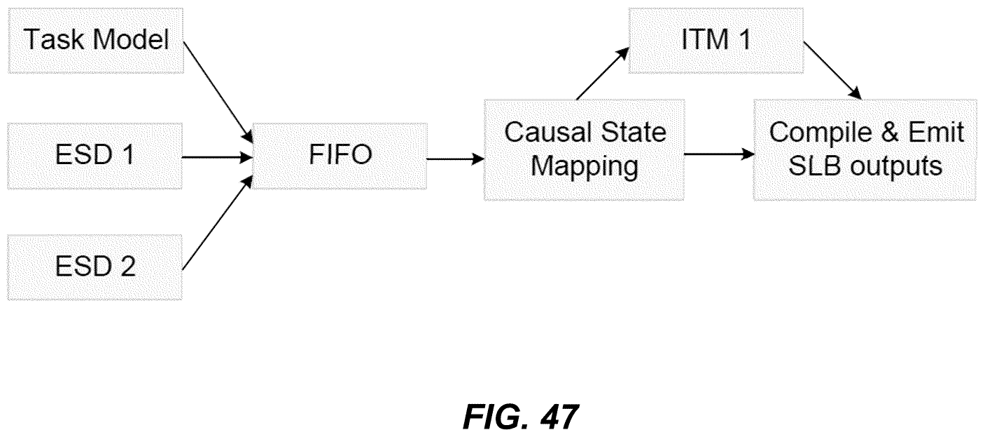

SLB Implementation. A detailed implementation of the self-labeling service is described in FIG. 47. A non-trivial situation of self-labeling is to cope with multiple asynchronous effects for causal state mapping to self-label the corresponding cause states. The SLB service needs to wait for the delayed effects in order to jointly or individually execute ITMs, or neglects detected effects if no other effects arrive in the given time period and the received effects are unable to determine a unique cause state. We apply a first-in-first-out (FIFO) queue to cache the arrived effects. The Causal State Mapping module regularly scans the FIFO and determines if the current effect states are enough to determine an unambiguous cause state referring to the retrieved causality from KG. In addition, the Causal State Mapping module monitors the timespan and evict effects states that cannot formulate a deterministic cause state due to the lack of necessary effects in a given time period. After the causal state mapping, ITMs are triggered to infer the interaction time by using the assembled effect states as inputs, after which the self-labeling results are compiled and emitted.

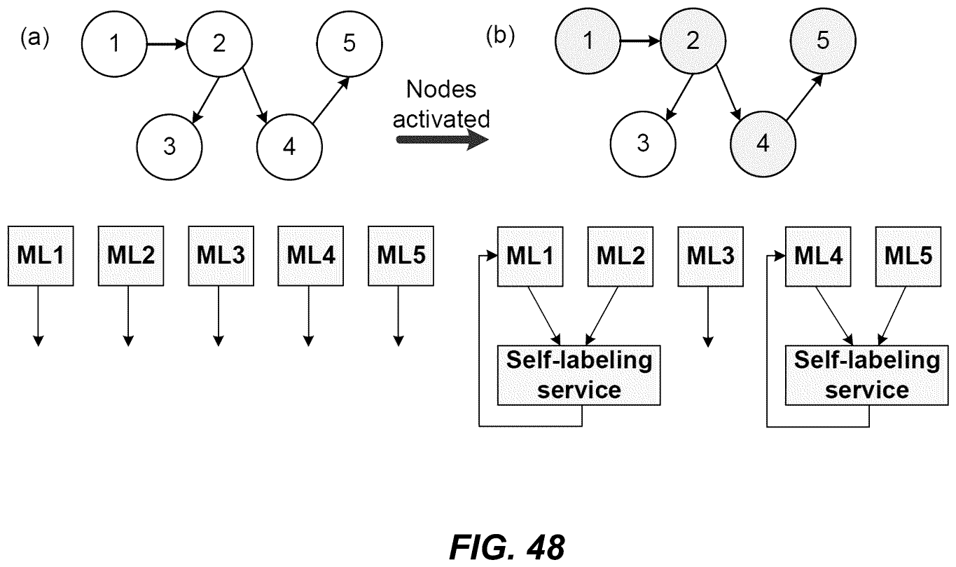

FIG. 48 illustrates the interactions among ML services with the self-labeling mechanism guided by the causal knowledge graph. Initially, five ML services operate independently for state change detection of the corresponding nodes in the KG. By choosing some of the causally linked nodes for self-labeling, the corresponding ML services start interacting with each other via the defined self-labeling workflow. In turn, self-labeling improves detection accuracy, and the ML services can infer again independently.

TABLE 8
TEST RESULTS OF A SINGLE EDGE NODE

| Mean | Mean msg | Mean | Max |
|---|---|---|---|
| throughput | size | Delay | Delay |
| 284 msg/s | 250.2 byte | 31 ms | 64 ms |

### System Characterization

A system characterization of several key performance indicators is conducted to evaluate the performance of the proposed AdaptIoT system. The system's backend and frontend applications are deployed on a workstation with a 20-core Intel Xeon W-2155 at 3.30 GHz. The workstation's Ethernet data transfer rate is 1 Gbps.

We use Raspberry Pi 3B with 1G RAM and 300 Mbps Ethernet as the host processor for multiple time-series sensors installed on machines. Depending on sensor types, the sampling frequency of each sensor ranges from a few hundred Hz to 0.2 Hz. A standard configuration of a sensor node for characterization purposes consists of one host processor, one 6-DOF IMU sensor, one CTH (CO2, temperature, humidity) sensor, and one distance (time of flight) sensor, while it can also be customized freely. For a single edge node with one IMU, one CTH, and one distance sensor, the average end-to-end timing performance from the data generator to the database is evaluated, and the results are shown in Table 8.

As for camera streaming, Raspberry Pi 4B with 8G RAM and 1 Gbps Ethernet is chosen. Correspondingly, Raspberry Pi Camera Module 3 with 1080p resolution and 30 fps is used. Each camera produces streams simultaneously in two modes: preview and full HD resolution. The preview mode streams at 240p resolution for GUI display only. The average end-to-end delay is 39 ms. The full HD mode streams at 1080p to the video segmenter for self-labeling and the corresponding ML services for inference. This design ensures that the acquired video dataset and ML inference can use high-quality images while reducing bandwidth requirements for GUI users. The average frame size is 69 KB, and theoretically, using 1 Gbit, the system can support about 60 cameras simultaneously.

To provide a baseline for characterization, we detail the system configuration below. First, a mock test is accomplished to evaluate the maximum capacity of a single Kafka producer and consumer. We use a laptop with an AMD Ryzen 7 6800H 16-core CPU and 1 Gbps network as the transmitter for hosting the mock sensor. An Apache Kafka cluster with 3 nodes and 10 partitions is used. The Kafka single producer test result is shown in Table 9. The maximum throughput of a single consumer is 388 k msg/s, which is equivalent to 92.5 MB/s. Note that the test is accomplished with only one producer, one consumer, and three Kafka nodes. Due to the horizontal scalability of Kafka, higher performance can be realized by proper scaling.

Additionally, a realistic system capability test is conducted on the real deployment. We start with 3 standard sensor nodes, 9 additional power meters with 1 Hz data rate, and 3 additional edge sensor services, including a Tiny ML board, an IMU sensor, and a data query service for the UR3e robot, while 8 camera streamings run in the background. In total, 29 edge services are actively running; on average, 108 million messages are generated daily. We monitor the data ingestion speed of InfluxDB, and the average data ingestion rate is 1259 messages per second (msg/s). Based on a single consumer with an average receiving speed of 92.5 MB/sec and a time-series edge producer with an average data rate of 41 msg/s, the theoretically maximum number of supported time-series edge services is 13.2 k.

TABLE 9
KAFKA SINGLE PRODUCER THROUGHPUT TEST RESULTS

| Max number | Mean | Max |
|---|---|---|
| of messages | delay | delay |
| 182k | 679 ms | 979 ms |

### Self-Labeling Experiment Running on AdaptIoT

To demonstrate the applicability of the proposed system for self-labeling applications, a self-labeling application is developed and deployed on AdaptIoT to demonstrate the system's efficacy. The self-labeling application utilizes the example in and replicates the adaptive worker-machine interaction detection on a 3D printer. The experiment is to use the concept of interactive causality to design the self-labeling system for adapting a worker action recognition model. The cause side uses cameras to detect body gestures as an indication of worker-machine interactions. The effect side uses a power meter to detect machine responses in the form of energy consumption.

The developed self-labeling application is driven by a causal knowledge graph that describes the extracted domain knowledge. This KG representing the causality embedded in the 3D printer operation among people, machines, and materials is built and loaded to the graph database with corresponding metadata as shown in FIG. 43. As an illustration, we implement five sensors for five nodes in the KG with five corresponding ML services to detect the state change of each node. Among the five implemented nodes, two interactive nodes are chosen to conduct self-labeling, as highlighted in the red circle. The two nodes represent a worker's body movement and the machine's status change.

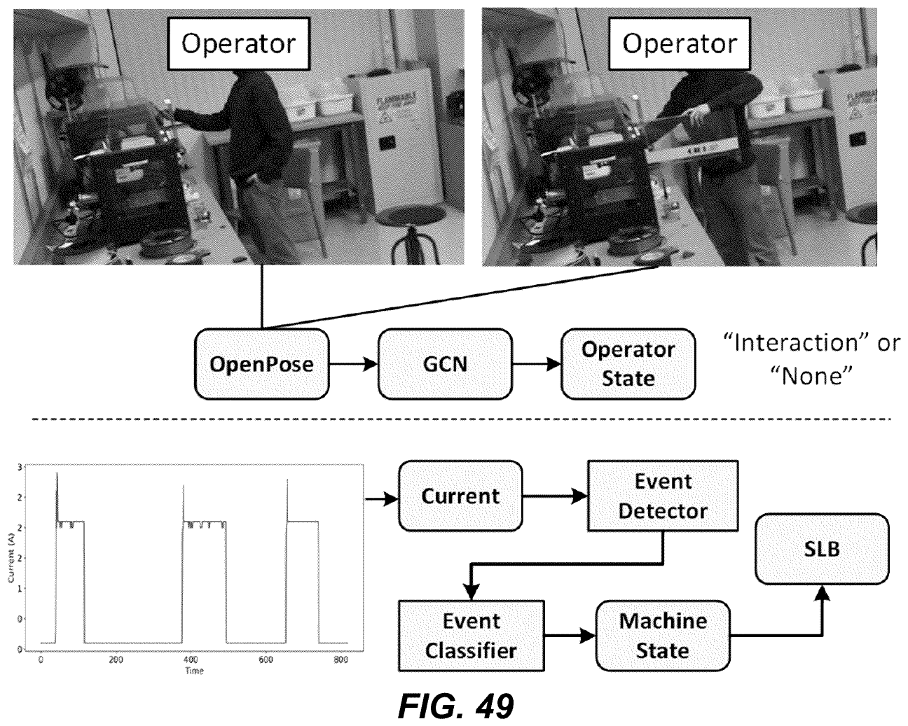

The implementation details are shown in FIG. 49. The worker action is defined as binary, namely interaction and non-interaction. The interaction is defined as when workers push the power button to turn on/off the 3D printer, which corresponds to a change in the machine's power consumption as an effect. An ML service composed of a cascaded OpenPose and graph convolution network (GCN) is implemented to recognize worker action as the task model. To detect a machine's power change, a machine state recognition algorithm composed of an event detector and classifier is implemented as the ESD. The ITM uses a lookup table and statistical Gaussian model to infer the interaction time. This entire self-labeling application runs on the proposed AdaptIoT system.

To demonstrate effectiveness, we manually collected and labeled a dataset of 400 samples as the validation and test sets.

TABLE 10
MODEL ACCURACY (%) TRAINED
ON THE EXPERIMENT DATASET

| Method | Accuracy |
|---|---|
| PseudoLabel | 90.05 |
| | (±2.72) |
| SimMatch | 96.18 |
| | (±1.48) |
| SoftMatch | 98.22 |
| | (±0.68) |
| FreeMatch | 97.90 |
| | (±0.72) |
| Pretrain only | 95.21 |
| | (±2.72) |
| SLB (w/data | 98.24 |
| aug.) | (±0.57) |
| SLB (w/o | 98.33 |
| data aug.) | (±0.22) |

Through the experiment, a self-labeled dataset composed of 200 samples is automatically collected and labeled using the AdaptIoT system over three weeks of 3D printer usages. Table 10 summarizes the accuracy compared with several semi-supervised approaches. The results show the mean and standard deviation derived over the training with 10 random seeds. By default, all other semi-supervised approaches apply the temporal random shift as the data augmentation. It can be observed that the self-labeling method consistently outperforms other semi-supervised methods with a smaller standard deviation, indicating a more stabilized training, which demonstrates the applicability of the proposed AdaptIoT system for the self-labeling applications. According to the theory, the self-labeling and semi-supervised methods show comparable performance when there is no observable data distribution shift as in the situation of this experiment. The merit of self-labeling over traditional semi-supervised methods mainly manifests in the scenario of data distribution shifts, which has been demonstrated by previous studies and is not the scope of this study.

An interesting observation is found from the experiment results that the temporal random shift as the data augmentation adversely affect the self-labeling accuracy. It proposes a qualitative explanation of the impact of the uncertain interaction time on the self-labeling and model retraining performance. They use the concept of motion smoothness to explain that even though the ITM may infer the interaction time at a deviated timestamp, the natural motion smoothness alleviates the adverse effect of deviated interaction time. Hypothetically, the inaccuracy caused by interaction time inference is equivalent to the temporal random shift. The adverse effect of adding the temporal random shift to the self-labeling shown in Table 10 partially reveals this fact but requires deeper research in the future.

An IoT system, AdaptIoT, is designed and demonstrated to support the interactive causality-enabled self-labeling workflow for developing adaptive machine learning applications in cyber manufacturing. The AdaptIoT is designed as a web-based and microservice platform for both manufacturing IoT digitization and intelligentization with an end-to-end data streaming component, a machine learning integration component, and a self-labeling service. AdaptIoT ensures high throughput and low latency data acquisition and seamless integration and deployment of ML applications. The self-labeling service automates the entire self-labeling workflow to allow real-time and parallel task model adaptation. A university laboratory as a makespace is retrofit with the AdaptIoT system for future adaptive learning cyber manufacturing application development. Overall, more adaptive ML applications in cyber manufacturing are envisioned to be developed in the future based on the proposed AdaptIoT system.

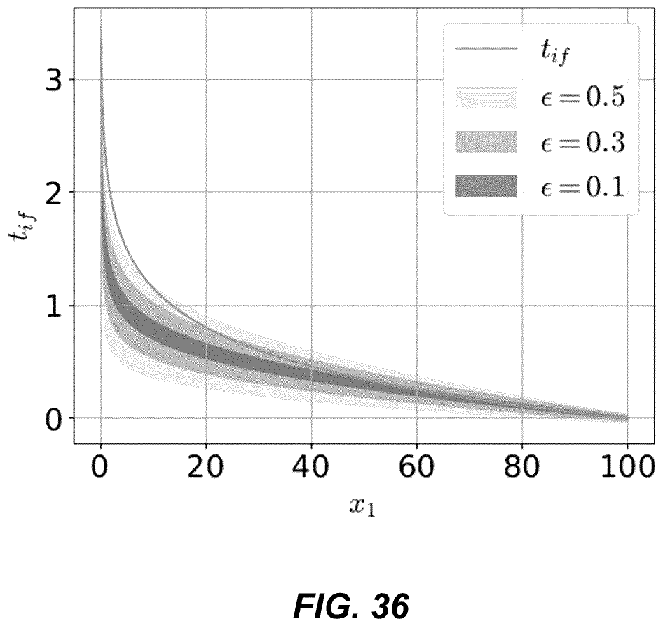

Although specific case studies are discussed above with respect to FIGS. 20-49, a variety of case studies as appropriate to the requirements of a specific application may be utilized in accordance with present implementations. While the above description contains many specific implementations, these particular implementations should not be construed as limitations with respect to the scope herein, but rather as an example a particular implementation thereof. It is therefore to be understood that the present implementations may be implemented otherwise than specifically described above, and without departing from the scope of spirit herein. The implementations described above should therefore be considered in all respects as illustrative and not restrictive.

Exemplary implementations of systems and methods for automated data annotation, self-labeling, and adaptive machine learning are described above in detail. The systems and methods of this disclosure are not limited to only the specific implementations described herein, but rather, the components and/or steps of their implementation may be utilized independently and separately from other components and/or steps described herein.

Although specific features of various implementations may be shown in some drawings and not in others, this is for convenience only. In accordance with the principles of the systems and methods described herein, any feature of a drawing may be referenced or claimed in combination with any feature of any other drawing.

Some implementations involve the use of one or more electronic or computing devices. Such devices typically include a processor, processing device, or controller, such as a general purpose central processing unit (CPU), a graphics processing unit (GPU), a microcontroller, a reduced instruction set computer (RISC) processor, an application specific integrated circuit (ASIC), a programmable logic circuit (PLC), a programmable logic unit (PLU), a field programmable gate array (FPGA), a digital signal processing (DSP) device, and/or any other circuit or processing device capable of executing the functions described herein. The methods described herein may be encoded as executable instructions embodied in a computer readable medium, including, without limitation, a storage device and/or a memory device. Such instructions, when executed by a processing device, cause the processing device to perform at least a portion of the methods described herein. The above examples are exemplary only, and thus are not intended to limit in any way the definition and/or meaning of the term processor and processing device.

1. A system for automatically self-labeling a digital dataset, comprising:
a first sensor configured to generate a first digital data stream;
a second sensor configured to collect information for generating a second digital data stream different from the first digital data stream;
a causal model manager (CMM) configured to determine (a) a first causal event from a first data segment of the first digital data stream, and (b) a causal relation between the first causal event and a second data segment selected from the second digital data stream;
an interactive time model (ITM) unit configured to determine a time lag between the first and second data segments; and
a self-labeling subsystem configured to (a) derive a label from the second data segment, (b) associate the first data segment with the derived label, (c) form a self-labeled data pair from the associated first data segment and the derived label, and (d) automatically annotate the self-labeled data pair with an interaction time value based on the determined time lag.

2. The system of claim 1, wherein the first and second digital data streams each include a series of data samples indexed by timestamps.

3. The system of claim 1, wherein the second sensor includes an effect recognizer configured to determine an effect state of the second data segment.

4. The system of claim 1, wherein the ITM is further configured to infer the interaction time based on at least one of the first and second data segments.

5. The system of claim 4, wherein the CMM includes a mapping unit configured to map the first data segment to the second data segment based on the inferred interaction time.

6. The system of claim 5, wherein the CMM is further configured to select the first data segment for the causal relation by executing a traceback along the first digital data stream, from an effect time of occurrence for the second data segment, by at least one iteration step corresponding to the inferred interaction time.

7. The system of claim 1, wherein the self-labeling subsystem is further configured to generate an accumulated self-labeled dataset from a plurality of annotated self-labeled data pairs.

8. The system of claim 7, further comprising a causal interactive task modeling unit.

9. The system of claim 8, wherein the causal interactive task modeling unit includes at least one of a multi-layer perceptron (MLP), a graph convolutional network (GCN), and a multiscale vision transformer (MViT).

10. The system of claim 8, wherein the causal interactive task modeling unit is configured to ingest the first digital data streams and generate a third digital data stream from the first digital data stream using the plurality of annotated self-labeled data pairs.

11. The system of claim 10, wherein third digital data stream includes at least one predicted effect state for a data segment of the second digital data stream.

12. The system of claim 8, wherein the self-labeling subsystem is further configured to train the causal interactive task modeling unit using the accumulated self-labeled data set.

13. The system of claim 1, wherein the CMM includes a structured causality knowledge database, a search engine, a causal validation engine, and a causal model generator.

14. The system of claim 13, wherein the causal model generator is configured to derive a causal state transition model from one or more user queries.

15. A method for automatic data annotation and self-learning for adaptive machine learning (ML) applications, the method comprising steps of:
formulating an ML problem and a preliminary dataset having a plurality of data attributes;
searching a knowledge base for potential causal events related to the formulated ML problem;
identifying, from the preliminary dataset, causal event data from data attributes of the preliminary dataset that correspond with potential causal events from the step of searching;
validating the identified causal event data using a statistical causal model;
selecting, from the validated causal event data, a set of validated causal events exhibiting highest levels of confidence; and
marking the selected high-confidence causal events to enable an effect recognizer to derive an effect label for each selected high-confidence causal event.

16. The method of claim 15, further comprising a step of generating a state transition model based on a cause state of a first selected high-confidence causal event and an effect state of a first effect label associated with the first selected high-confidence causal event.

17. The method of claim 16, further comprising a step of determining an interaction time based on a temporal difference between an occurrence of the cause state and an occurrence of the effect state.

18. The method of claim 17, further comprising a step of training an interactive time model (ITM) using the interaction time and the state transition model.

19. The method of claim 17, further comprising the steps of (a) accumulating a self-labeled dataset based on the marked the selected high-confidence causal events and the interaction time, and (b) training a causal interactive task model for the ML problem using the self-labeled dataset.

20. An apparatus for automatically self-labeling a digital dataset, comprising:
a processor configured to receive a first data stream and a second data stream different from the first data stream; and
a memory device in operable communication with the processor and configured to store computer-executable instructions therein, which, when executed by the processor, cause the apparatus to:
generate, using the first and second data streams, (a) a causal interactive task model, and (b) an interaction time model (ITM);
determine (a) a first causal event from a first data segment of the first data stream, and (b) a causal relation between the first causal event and a second data segment selected from the second data stream;
recognize a first effect event for the second data segment based on the determined causal relation and an interaction time, inferred by the ITM, between the first cause event and the first effect event;
self-label a dataset from an accumulated plurality of associated cause and effect events; and
automatically update the causal interactive task model using the self-labeled dataset.
